(19) United States
(12) Patent Application Publication
(10) Pub. No.: US 2024/0297337 A1
(43) Pub. Date: Sep. 5, 2024

(54) LITHIUM-ION BATTERIES COMPRISING HIGH LITHIUM-DENSITY SUPPLEMENTAL CATHODE ACTIVE MATERIAL

(71) Applicant: Sila Nanotechnologies, Inc., Alameda, CA (US)

(72) Inventors: Geoffrey Lee Usiak MCCONOHY, Mountain View, CA (US); Thomas Antony KODENKANDATH, Highlands Ranch, CO (US); Min Zheng HAEBERLE, Redwood City, CA (US); Gleb Nikolayevich YUSHIN, Atlanta, GA (US)

(21) Appl. No.: 18/593,656

(22) Filed: Mar. 1, 2024

Related U.S. Application Data
(60) Provisional application No. 63/488,408, filed on Mar. 3, 2023.
(60) Provisional application No. 63/508,383, filed on Jun. 15, 2023.

(51) Int. Cl. H01M 10/0525; H01M 4/02; H01M 4/38; H01M 4/505; H01M 4/525; H01M 4/583; H01M 4/587; H01M 10/0568; H01M 10/0569

(52) U.S. Cl. CPC H01M 10/0525; H01M 4/386; H01M 4/505; H01M 4/525; H01M 4/583; H01M 4/587; H01M 10/0568; H01M 10/0569; H01M 2004/021; H01M 2004/027; H01M 2004/028; H01M 2300/0034; H01M 2300/0042

(57) ABSTRACT

A lithium-ion battery includes an anode current collector, a cathode current collector, an anode disposed on and/or in the anode current collector, and a cathode disposed on and/or in the cathode current collector, and an electrolyte ionically coupling the anode and the cathode. In some embodiments, the anode includes silicon and carbon, and the cathode includes (1) a primary cathode active material and (2) a supplemental cathode active material. In some embodiments, a mass fraction of the silicon in the anode is in a range of about 10 wt. % to about 60 wt. %.

### CROSS-REFERENCE TO RELATED APPLICATIONS

The present Application for Patent claims the benefit of U.S. Provisional Application No. 63/488,408, entitled “LITHIUM-ION BATTERIES COMPRISING HIGH LITHIUM-DENSITY SUPPLEMENTAL CATHODE ACTIVE MATERIAL,” filed Mar. 3, 2023, and U.S. Provisional Application No. 63/508,383, entitled “LITHIUM-ION BATTERIES COMPRISING HIGH LITHIUM-DENSITY SUPPLEMENTAL CATHODE ACTIVE MATERIAL,” filed Jun. 15, 2023, each of which is assigned to the assignee hereof, and expressly incorporated herein by reference in its entirety.

### BACKGROUND

### Field

Aspects of the present disclosure relate generally to energy storage devices, and more particularly to battery technology and the like.

### Background

Owing in part to their relatively high energy densities, relatively high specific energy, light weight, and potential for long lifetimes, advanced rechargeable batteries are desirable for a wide range of consumer electronics, electric vehicles, grid storage and other important applications.

However, despite the increasing commercial prevalence of batteries, further development of these batteries is needed, particularly for applications in low- or zero-emission, hybrid-electric or fully-electric vehicles, consumer electronics, wearable devices, energy-efficient cargo ships and locomotives, drones, aerospace applications, and power grids. In particular, further improvements are desired for various rechargeable batteries, such as Li and Li-ion batteries, Na and Na-ion batteries, and rechargeable K and K-ion batteries, and dual-ion batteries, to name a few.

In certain types of Li metal and Li-ion rechargeable batteries, charge storing anodes may comprise silicon (Si)-comprising anode particles with gravimetric capacities in the range from about 800 mAh/g to about 3000 mAh/g (per mass of Si-comprising anode particles in a Li-free state). A subset of such anodes includes anodes with the electrode layer exhibiting capacity in the range from about 400 mAh/g to about 2800 mAh/g (per mass of the electrode layer, not counting the mass of the current collector, in a Li-free state). Such a class of charge-storing anodes offers great potential for increasing gravimetric and volumetric energy of rechargeable batteries.

In certain types of rechargeable batteries, charge storing anode active materials may be produced as high-capacity (nano)composite powders (e.g., at least partially comprised of active material nanomaterials or nanostructures that may be embedded on and/or in a porous structure, such as a C-comprising matrix material), which exhibit moderately high volume changes (e.g., about 8-180 vol. %) during the first charge-discharge cycle and moderate volume changes (e.g., about 5-50 vol. %) during the subsequent charge-discharge cycles, as measured using thickness measurements of the battery. A subset of such charge-storing anode particles includes anode particles with an average size (e.g., diameter or thickness) in the range of about 0.2 to about 40 microns (micrometers, or μm), as measured using laser particle size distribution analysis (LPSA), laser image analysis, electron microscopy, optical microscopy or other suitable techniques. Such a class of charge-storing particles offers great promises for scalable manufacturing and achieving high cell-level energy density and other performance characteristics.

Examples of electrode materials that exhibit moderately high volume changes (e.g., about 8-180 vol. %) during the first charge-discharge cycle and moderate volume changes (e.g., about 5-50 vol. %) during the subsequent charge-discharge cycles include (nano)composites comprising so-called conversion-type (which includes both so-called chemical transformation and so-called “true conversion” subclasses) and so-called alloying-type active electrode materials. In the case of metal-ion batteries (such as Li-ion batteries), examples of such conversion-type active electrode materials include, but are not limited to, metal fluorides (such as lithium fluoride, iron fluoride, copper fluoride, bismuth fluoride, their mixtures and alloys, etc.), metal chlorides, metal iodides, metal bromides, metal chalcogenides (such as sulfides, including lithium sulfide and other metal sulfides), sulfur, selenium, metal oxides (including but not limited to lithium oxide and silicon oxide), metal nitrides, metal phosphides (including lithium phosphide), metal hydrides, and others. In the case of metal-ion batteries (such as Li-ion batteries), examples of such alloying-type electrode materials include, but are not limited to, silicon, germanium, antimony, aluminum, magnesium, zinc, gallium, arsenic, phosphorus, silver, cadmium, indium, tin, lead, bismuth, their alloys, and others. These materials typically offer higher gravimetric and volumetric capacity than so-called intercalation-type electrodes commonly used in commercial metal-ion (e.g., Li-ion) batteries. Alloying-type electrode materials are particularly advantageous for use in certain high-capacity anodes for Li-ion batteries. Silicon-based alloying-type anodes may be particularly attractive for such applications.

In some designs, active electrode materials for use in electrochemical energy storage devices, such as batteries or electrochemical capacitors or hybrid devices, may be carbon-containing composite particles. A sub-class of such composite particles may include composite particles where conversion-type, alloying-type, intercalation-type or pseudocapacitive materials are confined within or infiltrated within carbon- or carbon-containing matrix material. The large volume changes, relatively high specific surface area, the presence of electronegative elements (such as oxygen or nitrogen), the presence of hydrogen, slow diffusion within portions of the anode and other factors, may result in larger amounts of electrochemically active Li loss in some of the high-capacity anodes (up to 10-30% for some silicon-comprising anodes, as measured from coulombic efficiency measurements in lithium-metal half cells) during the first cycle, relative to just 3-7% in many common pure graphite-based anodes. This large lithium loss may contribute to undesirably lower energy densities for some batteries comprising, for example, silicon-comprising anodes. As used herein, “lost” lithium refers to Li that has undergone a transition from an electrochemically-active state to an electrochemically-inactive state.

To increase the capacity of the lithium-ion battery cell, additives (also known as lithium supplements) may be utilized to increase the amount of electrochemically active lithium in the battery (also known as lithium inventory), thereby increasing the cell energy density. Electrochemically active lithium is defined as lithium which may be transported to different electrodes of the battery via externally applied electrical current.

In some cases, electrochemically active lithium may be added to the cell by mixing or electrochemically alloying or adding (by other means) lithium metal directly onto the anode of the battery, where the lithium may react with the anode and form lithiated material. This process is known as a pre-lithiation of the anode. However, this approach requires a complicated setup, including production and handling of metallic lithium in powdered form, which is highly unstable to water in ambient conditions. Due to the low potential of the lithium insertion reaction into silicon-comprising or carbon-comprising anodes (as measured via an open circuit potential measurement at a given lithium concentration in an electrochemical cell with lithium metal as a reference electrode), there exists very few materials which allow for spontaneous transfer of lithium atoms from the supplemental material to the anode. Because of the difficulties of adding lithium chemically to the anode, alternative approaches are needed to obtain the benefits of added lithium inventory.

In other cases, extra lithium (i.e., electrochemically-active lithium) may be added to the cathode, where the lithium is electrochemically moved from the cathode to the anode on the first charge, thereby replacing at least some of the electrochemically-active lithium which is lost to undesired chemical reactions on the anode on the first charge. Lithium which is added to the cathode is defined as a cathode lithium supplement, or supplemental cathode active material. Determining the exact amount of added lithium to optimize energy density is a complicated calculation involving many properties of the cathode and anode. In many cases, the addition of some sources of lithium to the cathode is counter-intuitive and may result in limited performance improvements and increased costs. Furthermore, some lithium supplements may result in inferior performance and are preferably avoided in many cell designs.

Accordingly, there remains a need for improved batteries, components, and other related materials and manufacturing processes.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a Li-ion battery includes an anode current collector; a cathode current collector; an anode disposed on and/or in the anode current collector, the anode comprising silicon and carbon; a cathode disposed on and/or in the cathode current collector, the cathode comprising (1) a primary cathode active material and (2) a supplemental cathode active material; and an electrolyte ionically coupling the anode and the cathode, wherein: a mass fraction of the silicon in the anode is in a range of about 10 wt. % to about 60 wt. %; a mass ratio of the primary cathode active material to the supplemental cathode active material is in a range of about 15:1 to about 50:1; a first-cycle coulombic efficiency of the primary cathode active material is at least about 85%; a first-charge specific capacity of the supplemental cathode active material is at least about 350 mAh/g; and a first-cycle coulombic efficiency of the anode is less than the first-cycle coulombic efficiency of the primary cathode active material.

In some aspects, the first-charge specific capacity of the supplemental cathode active material is at least about 450 mAh/g.

In some aspects, the first-charge specific capacity of the supplemental cathode active material is at least about 750 mAh/g.

In some aspects, the supplemental cathode active material comprises Li and one or more of the following: Fe, Ni, and V.

In some aspects, the supplemental cathode active material comprises a lithium nickel oxide represented by Li₂Ni₁₋ₓMₓO_{2-y}F_{y}; x is between 0 and 0.5; y is between 0 and 0.5; and M represents an element or a mixture of two or more elements, the element or at least one of the two or more elements being selected from the following: copper (Cu), iron (Fe), magnesium (Mg), manganese (Mn), zinc (Zn), and cobalt (Co).

In some aspects, the supplemental cathode active material comprises one or more of the following elements: oxygen (O), nitrogen (N), sulfur (S), and carbon (C).

In some aspects, a supplemental cathode active material particle comprises the supplemental cathode active material.

In some aspects, the protective surface coating comprises one or more of the following compositions: (i) metal oxide, (ii) semimetal oxide, (iii) oxynitride, (iv) carbon, and (v) polymer.

In some aspects, the primary cathode active material is selected from: lithium cobalt oxide (LCO), lithium iron phosphate (LFP), lithium manganese iron phosphate (LMFP), lithium manganese oxide (LMO), lithium nickel manganese oxide (LMNO), lithium nickel cobalt manganese aluminum oxide (NCMA), lithium nickel cobalt manganese oxide (NCM), and lithium nickel aluminum oxide (NCA).

In some aspects, the primary cathode active material comprises the LMNO in a spinel form.

In some aspects, a first-cycle coulombic efficiency of the supplemental cathode active material is at most about 30%.

In some aspects, the first-cycle coulombic efficiency of the primary cathode active material is at least about 90%.

In some aspects, the first-cycle coulombic efficiency of the primary cathode active material is at least about 95%.

In some aspects, the mass fraction of the silicon in the anode is in a range of about 25 wt. % to about 50 wt. %.

In some aspects, the anode comprises Si—C nanocomposite particles.

In some aspects, the Si—C nanocomposite particles contribute from about 20% to about 100% of a total capacity of the anode.

In some aspects, the anode is substantially free of oxidized silicon.

In some aspects, an areal capacity loading of the cathode ranges from about 2 mAh/cm² to about 12 mAh/cm².

In some aspects, the anode comprises one or more of the following: natural graphite, synthetic graphite, soft carbon, and hard carbon.

In some aspects, the first-cycle coulombic efficiency of the anode is at least about 80%.

In some aspects, the first-cycle coulombic efficiency of the anode is at least about 85%.

In some aspects, the electrolyte comprises a salt composition and an electrolyte solvent composition, the salt composition comprising a primary salt and the electrolyte solvent composition comprising fluoroethylene carbonate (FEC) and vinylene carbonate (VC), the primary salt being at least about 50 mol. % of the salt composition; and the primary salt is selected from: LiPF₆, lithium tetrafluoroborate (LiBF₄), lithium bis(fluorosulfonyl)imide (LiFSI), lithium bis(trifluoromethanesulfonyl)imide (LiTFSI), and lithium fluorosulfate (LiSO₃F).

In some aspects, the salt composition additionally comprises a secondary salt, the secondary salt being selected from: lithium bis(fluorosulfonyl)imide (LiFSI), lithium tetrafluoroborate (LiBF₄), lithium difluoro(oxalato)borate (LiDFOB), lithium bis(oxalato)borate (LiBOB), lithium difluorophosphate (LFO), lithium fluorosulfate (LiSO₃F), and lithium bis(trifluoromethanesulfonyl)imide (LiTFSI).

In some aspects, the electrolyte solvent composition additionally comprises (1) at least one ester compound and/or (2) at least one linear carbonate compound; the at least one ester compound is selected from propyl propionate (PP), methyl butyrate (MB), ethyl propionate (EP), ethyl isobutyrate (EI), ethyl isovalerate (EIV), methyl acetate (MA), ethyl trimethylacetate (ET), ethyl acetate (EA), and ethyl butyrate (EB); and the at least one linear carbonate compound is selected from dimethyl carbonate (DMC), ethyl methyl carbonate (EMC), and diethyl carbonate (DEC).

In some aspects, the electrolyte solvent composition additionally comprises at least one cyclic carbonate compound; and the at least one cyclic carbonate compound is selected from ethylene carbonate (EC) and propylene carbonate (PC).

In some aspects, the electrolyte additionally comprises one or more additives selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, 1-(propan-2-yl)-1H-imidazole-4,5-dicarbonitrile, pyridine-2,6-dicarbonitrile, ethylene glycol bis(propionitrile) ether (EGBE), 3-(triethoxysilyl) propionitrile, succinonitrile (SN), benzonitrile, 4-(trifluoromethyl) benzonitrile, 1,2,2,3-propanetetracarbonitrile, triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, 1,3,2-Dioxathiolane 2,2-dioxide (DTD), and methylene methanedisulfonate (MMDS).

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of embodiments of the disclosure and are provided solely for illustration of the embodiments and not limitation thereof. Unless otherwise stated or implied by context, different hatchings, shadings, and/or fill patterns in the drawings are meant only to draw contrast between different components, elements, features, etc., and are not meant to convey the use of particular materials, colors, or other properties that may be defined outside of the present disclosure for the specific pattern employed.

FIG. 1 illustrates an example Li-ion battery in which the components, materials, processes, and other techniques described herein may be implemented.

FIG. 2 is a flow diagram of a process of making a Li-ion rechargeable battery cell in accordance with certain embodiments.

FIG. 3 is a flow diagram of a process of making anode (or cathode) particles in accordance with certain embodiments including carrying out an activation process on carbon particles.

FIG. 4 illustrates a schematic diagram of a lithium-ion battery in the pre-formation state, where electrochemically active lithium is contained in the cathode.

FIG. 5 illustrates a schematic diagram of a lithium-ion battery after the first charge is performed (which constitutes electrochemically moving lithium ions from the cathode to the anode), highlighting the loss of some lithium atoms to the solid electrolyte interphase (SEI) formed on the anode.

FIG. 6 illustrates a schematic diagram of a lithium-ion battery after so-called formation has been completed (in other words when one, two or three complete charge-discharge cycles has been completed), highlighting un-occupied lattice sites formed in the cathode.

FIG. 7 illustrates a schematic diagram of a lithium-ion battery with additional cathode lithium supplement in the pre-formation state, where electrochemically active lithium is contained in the cathode primary active material and cathode supplemental active material.

FIG. 8 illustrates a schematic diagram of a lithium-ion battery after the first charge is performed (which constitutes electrochemically moving lithium ions from the cathode to the anode), highlighting the loss of some lithium atoms to the solid electrolyte interphase (SEI). The total number of lithium atoms moved is higher in this figure due to the addition of cathode supplemental active material.

FIG. 9 illustrates a schematic diagram of a lithium-ion battery after formation has been completed (in other words when one, two or three complete charge-discharge cycle(s) has been completed), highlighting complete occupancy of cathode sites due to the addition of the lithium supplement.

FIG. 10 presents Table 1 of illustrative example primary cathode active materials commonly used in lithium-ion batteries, and their relevant parameters.

FIG. 11 presents Table 2 of illustrative example supplemental cathode active materials (additives) and their relevant properties.

FIG. 12 shows modeling data illustrating the dependence of a volumetric energy density on cathode supplemental active material gravimetric capacity for a lithium-ion battery with an example LFP cathode and an example anode (in the example shown, a blended anode comprising about 80 wt. % illustrative Si—C nanocomposite active material and 20 wt. % illustrative graphite active material), where the mass fraction of cathode supplemental material has been optimized for each value of supplement gravimetric capacity).

FIG. 13A shows modeling data illustrating the dependence of volumetric energy density on capacity of the cathode supplement material (expressed as weight (mass) fraction of L₂NO, a cathode supplement (additive) material, in the cathode active material), for several values of first-cycle efficiency of cathode primary active material first cycle efficiency, calculated for a lithium-ion battery with fictitious illustrative cathode and an illustrative anode (in the example shown, a blended anode comprising about 80 wt. % illustrative Si—C nanocomposite active material and about 20 wt. % illustrative graphite active material). Volumetric energy density has been normalized to the case with 0 wt. % supplement. The modeling data show that improvements in VED (relative to the case of 0 wt. % supplemental cathode active material) may be realized at relatively low weight (mass) fractions (e.g., between about 2 wt. % and about 5 wt. % or between about 2 wt. % and 6 wt. %) of supplemental cathode active material in the cathode active materials (sum of the supplemental cathode active material and primary cathode active material). Accordingly, in some implementations, a mass ratio of the primary cathode active material to the supplemental cathode active material may be in a range of about 20:1 to about 50:1. In some implementations, a mass ratio of the primary cathode active material to the supplemental cathode active material may be in a range of about 15:1 to about 50:1.

FIG. 13B shows experimental results of the dependence of the volumetric energy density (VED) measured at cycle 3 on a mass fraction of L₂NO, a cathode supplement material, in the cathode active materials (sum of L₂NO and LCO, a cathode primary active material). In the results shown, the VED is calculated based on a volume of the cathode and anode electrodes only to compensate for variable mass loading of the cathode in these experiments, which would skew the results of a unit stack VED calculation in favor of thicker electrodes. The experimental results of FIG. 13B provides experimental support for the modeling results presented in FIG. 13A, namely that improvements in VED (relative to the case of 0 wt. % supplemental cathode active material) may be realized at relatively low mass fractions (e.g., between about 2 wt. % and about 5 wt. % or between about 2 wt. % and 6 wt. %).

FIG. 14 shows modeling data illustrating the dependence of volumetric energy density of an illustrative lithium-ion battery on anode composition (expressed as a fraction of the anode capacity contributed by the Si—C composite (Si—C nanocomposite particles) in a mixture of graphite and illustrative Si—C nanocomposite particles, in this illustrative example). Modeling results are for illustrative lithium iron phosphate (LFP) cathodes. Four graphical plots are shown: two graphical plots with an optimized quantity of L₂NO supplemental cathode active material in the cathode, and two graphical plots with no supplemental cathode active material.

FIG. 15 shows modeling data illustrating the dependence of volumetric energy density of an illustrative lithium-ion battery on anode composition (expressed as a fraction of the anode capacity contributed by the Si—C composite (Si—C nanocomposite particles) in a mixture of graphite and illustrative Si—C nanocomposite particles, in this illustrative example). Modeling results are for illustrative lithium cobalt oxide (LCO) cathodes. Two graphical plots are shown: a first graphical plot with an optimized quantity of L₂NO supplemental cathode active material in the cathode, and a second graphical plot with no supplemental cathode active material. Two sets of data points are shown: a first set of data points (black squares) for experimentally measured volumetric energy density values of lithium-ion battery single-layer pouch cells comprising an optimal quantity (in the example shown, the cathode active material included L₂NO at a weight (mass) fraction of about 4.8 wt. % L₂NO) and a second set of data points (black circles) for experimentally measured volumetric energy density values of lithium-ion battery single-layer pouch cells comprising no cathode supplement. For both modeling and experimental results, there is a significant improvement (increase) in VED values as a result of the addition of L₂NO supplement. In the example shown, the VED increases as the fraction of the anode capacity contributed by the Si—C nanocomposite particles increases. In some implementations, the fraction of a total capacity of the anode contributed by the Si—C nanocomposite particles is preferably in a range of about 20% to about 100% (a value of 100% would correspond to an anode in which the active material is Si—C nanocomposite only, with no other active material such as graphite). In other implementations, the fraction of a total capacity of the anode contributed by the Si—C nanocomposite particles is preferably in a range of about 40% to about 100%. In yet other implementations, the fraction of a total capacity of the anode contributed by the Si—C nanocomposite particles is preferably in a range of about 60% to about 100%. However, in some embodiments, it may be preferable for the contribution of the Si—C nanocomposite particles to the total anode capacity to be quite high, but less than 100% (e.g., about 90% or less). In some implementations, the fraction of a total capacity of the anode contributed by the Si—C nanocomposite particles is preferably in a range of about 40% to about 90%. In other implementations, the fraction of a total capacity of the anode contributed by the Si—C nanocomposite particles is preferably in a range of about 40% to about 90%. In yet other implementations, the fraction of a total capacity of the anode contributed by the Si—C nanocomposite particles is preferably in a range of about 60% to about 90%.

FIG. 16A shows experimental results of the dependence of the volumetric energy density on cycle number for (1) single-layer pouch cells with LCO and about 4.8 wt. % (as fraction of the cathode actives) additive lithium nickel oxide (L₂NO) as the cathode, and 100 wt. % (as fraction of anode actives) of Si—C nanocomposite as the anode, and (2) single-layer pouch cells with LCO (no additive lithium nickel oxide (L₂NO)) as the cathode, and 100 wt. % (as fraction of anode actives) of Si—C nanocomposite as the anode. Results highlight the unexpected improvement in cycle life and volumetric energy density for cells containing L₂NO cathode supplement (additive).

FIG. 16B shows a graphical plot of the cycle life, expressed as the number of cycles to reach 80% of cycling-start gravimetric charge capacity (N80), of lithium-ion battery test cells in which the cathodes are blended cathodes comprising LCO, a primary cathode active material, and L₂NO, a supplemental cathode active material. The graphical plot shows a dependence of N80 on the mass fractions of L₂NO in respective Li-ion battery test cells. The mass fraction is expressed as the mass of the L₂NO divided by the mass of the cathode active materials (sum of the LCO and the L₂NO). In the examples shown, L₂NO mass fractions in a range of about 0 to 10 wt. % are considered. In this range, there is a trend toward an increase in N80 for increasing L₂NO mass fractions. N80 values in excess of 1300 cycles have been observed for L₂NO mass fractions of 10 wt. %, in contrast to N80 values in a range of 700 to 800 cycles for Li-ion battery test cells with no L₂NO additive.

FIG. 17 shows experimental results of the dependence of the internal resistance on cycle number for (1) single-layer pouch cells with LCO and about 4.8 wt. % (as fraction of the cathode actives, i.e., sum of LCO and L₂NO) additive lithium nickel oxide (L₂NO) as the cathode, and 100 wt. % (as fraction of anode actives) of Si—C nanocomposite as the anode, and (2) single-layer pouch cells with LCO (no additive lithium nickel oxide (L₂NO)) as the cathode, and 100 wt. % (as fraction of anode actives) of Si—C nanocomposite as the anode. Results highlight the unexpected improvement in internal resistance as a function of cycle number, with L₂NO-containing cells having a lower resistance (higher performance).

FIG. 18 shows modeling results illustrating the dependence of fractional change in volumetric energy density of an illustrative lithium-ion battery comprising a graphite anode and an LFP-type cathode on cathode composition (expressed as a weight (mass) fraction of L₂NO additive in the cathode active material), for several values of FCE of the graphite anode. The fractional change in VED is expressed relative to the case for cathodes with 0 wt. % L₂NO additive. The modeling results highlight the relatively lower overall performance (VED change relative to improvements for lithium-ion batteries that use graphite anodes in conjunction with the lithium supplement.

FIG. 19 shows Table 3 summarizing the respective properties of anode materials used in the calculations herein.

FIG. 20A shows Table 4 summarizing the approximate compositions of the L₂NO variants (doped and undoped) that were synthesized according to the processes described herein and the amounts of starting materials for the respective L₂NO variants.

FIGS. 20B and 20C show x-ray diffraction (XRD) plots of respective L₂NO materials. FIG. 20B shows the XRD plots of (1) L₂NO materials soon after synthesis, for L₂NO materials synthesized as detailed herein, and (2) L₂NO materials soon after receipt, for commercially available L₂NO materials. FIG. 20C shows the XRD plots of the respective L₂NO materials after three months of storage. For ease of viewing, the plots are vertically displaced relative to each other.

FIG. 21 shows half-cell cycling data plots (2102, 2104, 2106, 2108, and 2110) of respective L₂NO materials. Each plot shows the dependence of the voltage (measured in volts relative to Li metal (Li/Li⁺)) on the charge capacity (expressed in mAh/g of cathode active material). Plot 2102 is a half-cell cycling plot of a sample of commercially available L₂NO (Li₂NiO₂) material. Plots 2104, 2106, 2108, and 2110 are half-cell cycling plots of L₂NO materials synthesized in this work as detailed herein. Plot 2104 is a half-cell cycling plot of a sample of Li₂NiO₂ material, with no dopants. Plot 2106 is a half-cell cycling plot of a sample of Li₂NiO₂ material that has been doped with CuO. Plot 2108 is a half-cell cycling plot of a sample of Li₂NiO₂ material that has been doped with LiF. Plot 2110 is a half-cell cycling plot of a sample of Li₂NiO₂ material that has been doped with CuF₂.

FIG. 22 shows Table 5 summarizing the experimentally measured properties of Li-metal half cells in which the cathode comprises: (1) commercially available L₂NO (Li₂NiO₂) material, (2) Li₂NiO₂ material, with no dopants, (3) Li₂NiO₂ material that has been doped with LiF, (4) Li₂NiO₂ material that has been doped with CuO, and (5) Li₂NiO₂ material that has been doped with CuF₂.

FIG. 23 shows Table 6 summarizing selected cation and anion dopants that may be employed to dope Li₂NiO₂ material, and the selected compounds from which such dopants may be obtained.

### DETAILED DESCRIPTION

Aspects of the present invention are disclosed in the following description and related drawings directed to specific embodiments of the invention. The term “embodiments of the invention” does not require that all embodiments of the invention include the discussed feature, advantage, process, or mode of operation, and alternate embodiments may be devised without departing from the scope of the invention. Additionally, well-known elements of the invention may not be described in detail or may be omitted so as not to obscure other, more relevant details.

Aspects of the present disclosure provide for processes of making advanced carbon-containing composite particles for use in electrodes (e.g., anode electrodes or cathode electrodes) of Li-ion or Na-ion or K-ion rechargeable batteries, among other types of batteries, electrochemical capacitors and hybrid electrochemical energy storage devices.

Any numerical range described herein with respect to any embodiment of the present invention is intended not only to define the upper and lower bounds of the associated numerical range, but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a temperature range from about −120° C. to about −60° C. encompasses (in ° C.) a set of temperature ranges from about −120° C. to about −119° C., from about −119° C. to about −118° C., . . . from about −61° C. to about −60° C., as if the intervening numbers (in ° C.) between −120° C. and −60° C. in incremental ranges were expressly disclosed. In yet another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range. In yet another example, a numerical range with upper and lower bounds defined at different levels of precision shall be interpreted in increments corresponding to the bound with the higher level of precision. For example, a numerical percentage range from 30.92% to 47.4% (i.e., levels of precision in units or increments of hundredths and tenths, respectively) encompasses (in %) a set of [30.92, 30.93, 30.94, . . . , 47.39, 47.40], as if 47.4% (tenths) was recited as 47.40% (hundredths) and as if the intervening numbers between 30.92 and 47.40 in units or increments of hundredths were expressly disclosed.

It will be appreciated that the level of precision of any particular measurement, threshold or other inexact parameter may vary based on various factors such as measurement instrumentation, environmental conditions, and so on. Below, reference to such measurements or thresholds may thereby be interpreted as a respective value assuming a pseudo-exact level of precision (e.g., a threshold of 80% comprises 80.0000 . . . %). Alternatively, reference to such measurements or thresholds may be described via a qualifier that captures pseudo-exact value(s) plus a range that extends above and/or below the pseudo-exact value(s). For example, the above-noted threshold of 80% may be interpreted as “about”, “approximately”, “around”, “≈” or “˜” 80%, which encompasses “exactly” 80% (e.g., 80.0000 . . . %) plus some range around 80%. In some designs, the range encompassed around a measurement or threshold via the “about”, “approximately”, “around” or “˜” qualifier may encompass the level of precision for which the respective measurement or threshold is capable of being measured by the most accurate commercially available instrumentation as of the priority date of the subject application.

In the following description, various material properties are described so as to characterize materials (e.g., molecules, particles, powders, slurries, electrodes, separators, electrolytes, battery cells, etc.) in various states. Note that one of ordinary skill in the art is generally capable of selecting (and is herein assumed to select) the most appropriate measurement technique for any particular measurement. Moreover, in some cases, the most appropriate measurement technique may include a combination of techniques. While the following Table characterizes various measurement type options for particular material types and particular material properties, certain embodiments of the disclosure may be more specifically characterized in context with a specific measurement technique and/or specific commercially available instrumentation, if warranted. Note that while the Table below characterizes measurements with respect to active material particles, similar measurements may also be made with respect to other particle types such as precursor particles (e.g., carbon particles, etc.). Hence, unless otherwise indicated, the following Table provides examples of how such material properties may be readily measured by one of ordinary skill in the art using commercially available instrumentation:

Table of Techniques and Instrumentation for Material Property Measurements

| | | Measurement | |
|---|---|---|---|
| Material Type | Property Type | Instrumentation | Measurement Technique |
| Active | Coulombic | Potentiostat | Charge (current) is passed to an |
| Material | Efficiency | | electrode containing the active |
| | | | material of interest until a given |
| | | | voltage limit is reached. Then, |
| | | | the current is reversed until a |
| | | | second voltage limit is reached. |
| | | | The ratio of the charge passed |
| | | | determines the coulombic |
| | | | efficiency. |
| Active | Partial Vapor | Manometer | The partial vapor pressure of an |
| Material | Pressure (e.g., | | active material in a mixture |
| | Torr.) at a | | (e.g., composite particle) at a |
| | Temperature | | particular temperature is given |
| | (e.g., K) | | by the known vapor pressure of |
| | | | the active material multiplied by |
| | | | its mole fraction in the mixture. |
| Active | Volume | Gas pycnometer | Gas pycnometer measures the |
| Material | | | skeletal volume of a material by |
| Particle | | | gas displacement using the |
| | | | volume-pressure relationship of |
| | | | Boyle's Law. A sample of |
| | | | known mass is placed into the |
| | | | sample chamber and maintained |
| | | | at a constant temperature. An |
| | | | inert gas, typically helium, is |
| | | | used as the displacement |
| | | | medium. |
| | | | Note: A vol. % change may be |
| | | | calculated from two volume |
| | | | measurements of the active |
| | | | material particle. |
| Active | Open Internal | nitrogen | nitrogen sorption/desorption |
| Material | Pore Volume | sorption/desorption | isotherm technique |
| Particle | (e.g., cc/g or | isotherm | |
| | cm³/g) | | |
| Active | Volume- | PSA, scanning | PSA using laser scattering, |
| Material | Average Pore | electron microscope | electron microscopy (SEM, |
| Particle | Size (e.g., nm) | (SEM), transmission | TEM, STEM), laser microscopy |
| | | electron microscope | (for larger particles), optical |
| | | (TEM), scanning | microscopy (for larger |
| | | transmission | particles), neutron scattering, X- |
| | | microscope (STEM), | ray microscopy imaging |
| | | laser microscope, | |
| | | Synchrotron X-ray, | |
| | | X-ray microscope | |
| Active | Closed | Gas pycnometer | Closed porosity may be |
| Material | Internal Pore | | measured by analyzing true |
| Particle | Volume (e.g., | | density values measured by |
| | cc/g or cm³/g) | | using an argon gas pycnometer |
| | | | and comparing to the theoretical |
| | | | density of the individual |
| | | | material components present in |
| | | | Si-comprising particles |
| Active | Closed | Gas pycnometer | With a pycnometer, the amount |
| Material | Internal | | of a certain medium (liquid or |
| Particle | Volume- | | Helium or other analytical |
| | Average Size | | gases) displaced by a solid can |
| | (e.g., nm) | | be determined. |
| Active | Size | TEM, STEM, SEM, | Laser particle size distribution |
| Material | (e.g., nm, μm, | X-Ray, PSA, etc. | analysis (LPSA), laser image |
| Particle | etc.) | | analysis, electron microscopy, |
| | | | optical microscopy or other |
| | | | suitable techniques |
| | | | transmission electron |
| | | | microscopy (TEM), scanning |
| | | | transmission electron |
| | | | microscopy (STEM), scanning |
| | | | electron microscopy (SEM)), X- |
| | | | ray microscopy, X-ray |
| | | | diffraction, neutron scattering |
| | | | and other suitable techniques |
| Active | Composition | Balance | Note #1: A wt. % change may |
| Material | (e.g., mass | | be calculated by comparing the |
| Particle | fraction or wt. | | mass fraction of a material in |
| | %, mg, | | the particle relative to the total |
| | number of | | particle mass. |
| | atoms, etc.) | | Note #2: The capacity |
| | | | attributable to particular active |
| | | | material(s) in the particle may |
| | | | be derived from the |
| | | | composition, based on the |
| | | | known theoretical capacit(ies) |
| | | | of each active material. |
| | | | Note #3: The composition of the |
| | | | particle may be characterized in |
| | | | terms of weight (e.g., mg). The |
| | | | composition of may |
| | | | alternatively be characterized by |
| | | | a number of atoms of a |
| | | | particular element (e.g., Si, C, |
| | | | etc.). In case of atoms, the |
| | | | number of atoms may be |
| | | | estimated from the weight of |
| | | | that atom in the particle (e.g., |
| | | | based on gas chromatography) |
| Active | Specific | Potentiostat | An electrode containing an |
| Material | Capacity | | active anode or cathode material |
| Particle, | | | of interest is charged or |
| Battery Half- | | | discharged (by passing electrical |
| Cell | | | current to the electrode) within |
| | | | certain potential limits using an |
| | | | electrochemical cell with |
| | | | suitable reference electrode, |
| | | | typically lithium metal. The |
| | | | total charge passed divided by |
| | | | the active material mass gives |
| | | | this quantity. The active mass is |
| | | | computed by multiplying the |
| | | | total mass of the electrode by |
| | | | the active material mass |
| | | | fraction. Both reversible and |
| | | | irreversible capacity during |
| | | | charge or discharge may be |
| | | | calculated in this way. |
| Active | BET SSA | BET instrument | A sample is placed into a sealed |
| Material | (e.g., m²/g) | | chamber, where nitrogen is |
| Particle | | | introduced. The change in |
| | | | pressure of the nitrogen is used |
| | | | to calculate the surface area of |
| | | | the sample. |
| Active | Aspect Ratio | SEM, TEM | The dimensions and shape of |
| Material | | | the particles are measured in |
| Particle | | | SEM or TEM. |
| Active | True Density | Argon Gas | True density values may be |
| Material | of Particle | Pycnometer | measured by using an argon gas |
| Particle | (e.g., g/cc or | | pycnometer and comparing to |
| | g/cm³) | | the theoretical density of the |
| | | | individual material components |
| | | | present in the particle. |
| Active | Particle Size | Dynamic light | laser particle size distribution |
| Material | Distribution | scattering particle | analysis (LPSA) on well- |
| Particle | (e.g., nm or | size analyzer, | dispersed particle suspensions in |
| Population | μm) | scanning electron | one example or by image |
| | | microscope | analysis of electron microscopy |
| | | | images, or by other suitable |
| | | | techniques. While there are |
| | | | diverse processes of measuring |
| | | | PSDs, laser particle size |
| | | | distribution analysis (LPSA) is |
| | | | quite efficient for some |
| | | | applications. Note that other |
| | | | types of particle size |
| | | | distribution (e.g., by SEM |
| | | | image analysis) could also be |
| | | | utilized (and may even lead to |
| | | | more precise measurements, in |
| | | | some experiments). Using |
| | | | LPSA, particle size parameters |
| | | | of a population's PSD may be |
| | | | measured, such as: a tenth- |
| | | | percentile volume-weighted |
| | | | particle size parameter (e.g., |
| | | | abbreviated as D₁₀), a fiftieth- |
| | | | percentile volume-weighted |
| | | | particle size parameter (e.g., |
| | | | abbreviated as D₅₀), a ninetieth- |
| | | | percentile volume-weighted |
| | | | particle size parameter (e.g., |
| | | | abbreviated as D₉₀), and a |
| | | | ninety-ninth-percentile volume- |
| | | | weighted particle size parameter |
| | | | (e.g., abbreviated as D₉₉). |
| Active | Width (e.g., | PSA | Parameters relating to |
| Material | nm) | | characteristic widths of the PSD |
| Particle | | | may be derived from these |
| Population | | | particle size parameters, such as |
| | | | D₅₀ − D₁₀ (sometimes referred to |
| | | | herein as a left width), D₉₀ − D₅₀ |
| | | | (sometimes referred to herein as |
| | | | a right width), and D₉₀ − D₁₀ |
| | | | (sometimes referred to herein as |
| | | | a full width). |
| Active | Cumulative | Computed via LPSA | A cumulative volume fraction, |
| Material | Volume | data | defined as a cumulative volume |
| Particle | Fraction | | of the composite particles with |
| Population | | | particle sizes of a threshold |
| | | | particle size or less, divided by a |
| | | | total volume of all of the |
| | | | composite particles, may be |
| | | | estimated by LPSA. |
| Active | Composition | Balance | The mass of active materials |
| Material | (e.g., wt. %) | | added to the electrode divided |
| Particle | | | by the total mass of the |
| Population | | | electrode. |
| Active | BET SSA | BET Isotherm | obtained from the data of |
| Material | (e.g., m2/g) | | nitrogen sorption-desorption at |
| Particle | | | cryogenic temperatures, such as |
| Population | | | about 77 K |
| Electrolyte | Salt | balance, volumetric | Total volume of the solution is |
| | Concentration | pipette | computed either via the sum of |
| | (e.g., M or | | the volume of the constituents |
| | mol. %) | | (measured by volumetric |
| | | | pipette), or by the mass of the |
| | | | constituents divided by the |
| | | | density. The molar mass of the |
| | | | salt is then used to calculate the |
| | | | total number of moles of salt in |
| | | | the solution. The moles of salt is |
| | | | then divided by the total volume |
| | | | to obtain the solvent |
| | | | concentration in M (mol/L). |
| Electrolyte | Solvent | balance, volumetric | Total volume of the solution is |
| | Concentration | pipette | computed either via the sum of |
| | (e.g., M or | | the volume of the constituents |
| | mol. %) | | (measured by volumetric |
| | | | pipette), or by the mass of the |
| | | | constituents divided by the |
| | | | density. The molar volume of |
| | | | each solvent is then used to |
| | | | calculate the total number of |
| | | | moles of solvent in the solution. |
| | | | The moles of solvent is then |
| | | | divided by the total volume to |
| | | | obtain the solvent concentration |
| | | | in M (mol/L). |
| Electrode | Composition | Balance | The mass fraction of a material |
| | (e.g., mass | | (e.g., active material, active |
| | fraction or wt. | | material particle, binder, etc.) in |
| | %) | | the electrode is calculated based |
| | | | on a measured or estimated |
| | | | mass of the material and a |
| | | | measured or estimated mass of |
| | | | the electrode, excluding the |
| | | | electrode current collector. |
| | | | Note: The mass of individual |
| | | | components (e.g., composite |
| | | | active material particles, |
| | | | graphite particles, binder, |
| | | | function additive(s), etc.) of the |
| | | | battery electrode composition |
| | | | may be measured before being |
| | | | mixed into a slurry to estimate |
| | | | their mass in a casted electrode. |
| | | | The mass of materials deposited |
| | | | onto the casted electrode may be |
| | | | measured by comparing the |
| | | | weight of the casted electrode |
| | | | before/after the material |
| | | | deposition. |
| Electrode | Areal Binder | balance | A mass fraction of the binder in |
| | Loading (e.g., | | the battery electrode, divided by |
| | mg/m²) | | a product of (1) a mass fraction |
| | | | of the active material (e.g., Si—C |
| | | | nanocomposite, etc.) particles in |
| | | | the battery electrode, and (2) a |
| | | | Brunauer-Emmett-Teller (BET) |
| | | | specific surface area of the |
| | | | population |
| Electrode | Capacity | Calculated | Measure mass (wt.) of active |
| | Attributable to | | material in electrode, and |
| | Active | | calculate electrode capacity |
| | Material | | based on known theoretical |
| | (active | | capacity of the active material. |
| | material | | For example, the average wt. % |
| | capacity | | of active material in each active |
| | fraction) | | material particle may be |
| | | | measured, and used to calculate |
| | | | the mass of the active material |
| | | | based on the mass of the active |
| | | | material particles before being |
| | | | mixed in slurry. This process |
| | | | may be repeated if the electrode |
| | | | includes two or more active |
| | | | materials to calculate the |
| | | | relative capacity attribution for |
| | | | each active material in the |
| | | | electrode. |
| Electrode | Capacity | Potentiostat and | Determine average specific |
| | Attributable to | balance | capacity (g/mAh) of active |
| | Active | | material particles. For example, |
| | Material | | the average specific capacity |
| | Particles | | may be estimated from the |
| | (active | | average wt. % of active |
| | material | | material(s) in each particle and |
| | particle | | its associated known theoretical |
| | capacity | | capacit(ies). Then, measure |
| | fraction) | | mass (wt.) of active material |
| | | | particles in electrode before |
| | | | being mixed in slurry, which |
| | | | may be used to calculate the |
| | | | capacity attributable to that |
| | | | active material. This process |
| | | | may be repeated if the electrode |
| | | | includes two or more active |
| | | | material particle types to |
| | | | calculate the relative capacity |
| | | | attribution for each active |
| | | | material particle type in the |
| | | | electrode. |
| Electrode | Mass of | balance | The average wt. % of active |
| | Active | | material in each active material |
| | Material in | | particle may be measured, and |
| | Electrode | | used to calculate the mass of the |
| | | | active material based on the |
| | | | mass of the active material |
| | | | particles before being mixed in |
| | | | slurry. |
| Electrode | Mass of | balance | Measure the active material |
| | Active | | particle before the active |
| | Material | | material particle type is mixed |
| | Particle in | | in slurry. |
| | Electrode | | |
| Electrode | Areal | Potentiostat and | Areal capacity loading is weight |
| | Capacity | balance | of the coated active material per |
| | Loading (e.g., | | unit area (g/cm²) multiplied by |
| | mAh/cm²) | | the gravimetric capacity of the |
| | | | active material (not the |
| | | | electrode, but the active material |
| | | | itself with zero binder and zero |
| | | | electrolyte; mAh/g). |
| Electrode | Coulombic | Potentiostat | The change in charge inserted (or |
| | Efficiency | | extracted) to an electrode |
| | | | divided by the charge extracted |
| | | | (or inserted) from the electrode |
| | | | during a complete |
| | | | electrochemical cycle within |
| | | | given voltage limits. Because the |
| | | | direction of charge flow is |
| | | | opposite for cathodes and |
| | | | anodes, the definition is |
| | | | dependent on the electrode. |
| | | | Coulombic Efficiency is |
| | | | measured for both materials by |
| | | | constructing a so-called half- |
| | | | cell, which is an electrochemical |
| | | | cell consisting of a cathode or |
| | | | anode material of interest as the |
| | | | working electrode and a lithium |
| | | | metal foil which functions as |
| | | | both the counter and reference |
| | | | electrode. Then, charge is either |
| | | | inserted or removed from the |
| | | | material of interest until the cell |
| | | | voltage reaches an appropriate |
| | | | limit. Then, the process is |
| | | | reversed until a second voltage |
| | | | limit is reached, and the charge |
| | | | passed in both steps is used to |
| | | | calculate the Coulombic |
| | | | Efficiency, as described above. |
| Battery Cell | Rate | Potentiostat | This is the time it takes to |
| | Performance | | charge or discharge a battery |
| | | | between a given state of charge. |
| | | | It is measured by charging or |
| | | | discharging a battery and |
| | | | measuring the time until a |
| | | | specified amount of charge is |
| | | | passed, or until the battery |
| | | | operating voltage reaches a |
| | | | specified value. |
| Battery Cell | Cell | Potentiostat | A battery consisting of a |
| | Discharge | | relevant anode and cathode is |
| | Voltage (e.g., | | charged and discharged within |
| | V) | | certain voltage limits and the |
| | | | charge-weighted cell voltage |
| | | | during discharge is computed. |
| Battery Cell | Operating | Potentiostat and | Average temperature of battery |
| | Temperature | thermocouples | cell as measured at the |
| | | | positive/negative terminal/cell |
| | | | shaft/etc. while |
| | | | charging/discharging, or at a |
| | | | certain voltage level, or while a |
| | | | load is applied, etc. |
| Battery Half- | Anode | Potentiostat | An electrode containing an |
| Cell | Discharge (de- | | active anode material (or |
| | lithiation) | | mixture of active materials) of |
| | Potential | | interest is charged and |
| | (e.g., V) | | discharged (by passing electrical |
| | | | current to the electrode) within |
| | | | certain potential limits using an |
| | | | electrochemical cell with |
| | | | suitable reference electrode, |
| | | | typically lithium metal. The |
| | | | charge-averaged cell potential |
| | | | upon discharge (corresponding |
| | | | to de-lithiation of the anode) is |
| | | | computed. |
| Battery Half- | Cathode | Potentiostat | An electrode containing an |
| Cell | Discharge | | active cathode material (or |
| | (lithiation) | | mixture of active materials) of |
| | Potential | | interest is charged and |
| | (e.g., V) | | discharged (by passing electrical |
| | | | current to the electrode) within |
| | | | certain potential limits using an |
| | | | electrochemical cell with |
| | | | suitable reference electrode, |
| | | | typically lithium metal. The |
| | | | charge-averaged cell potential |
| | | | upon discharge (corresponding |
| | | | to lithiation of the cathode) is |
| | | | computed. |
| Battery Cell | Volumetric | Potentiostat | the VED is calculated by first |
| | Energy | | calculating the energy per unit |
| | Density | | area of the battery, and then |
| | (VED) | | dividing the energy per unit area |
| | | | by the sum of the illustrative |
| | | | anode, cathode, separator, and |
| | | | current collector thicknesses |
| Battery Cell | Internal | Potentiostat | The internal resistance (also |
| | Resistance | | known as impedance in many |
| | (impedance) | | contexts) is measured by |
| | | | applying small pulses of current |
| | | | to the battery cell and recording |
| | | | the instantaneous change in cell |
| | | | voltage. |
| Any Liquid | Surface | Surface Tensiometer | Surface Tension in mN/m may |
| | Tension | (e.g., Bubble | be measured at room |
| | | Pressure | temperature |
| | | Tensiometer) | |
| Any Liquid | Viscosity (cP) | Viscometer (e.g., | Viscosity of a liquid may be |
| | | Brookfield | measured at room temperature |
| | | Viscometer) | |

While the description below may describe certain examples in the context of Li metal and Li-ion batteries (for brevity and convenience, and because of the current popularity of Li technology), it will be appreciated that various aspects may be applicable to other rechargeable and primary batteries (such as Na and Na-ion, Mg and Mg-ion, K and K-ion, Ca and Ca-ion, and other metal and metal-ion batteries, dual ion batteries, alkaline or alkaline-ion batteries, flow batteries, etc.) as well as electrochemical capacitors and hybrid energy storage devices.

While the description below may describe certain examples with reference to battery electrode compositions, the state of the battery electrode compositions may be in different forms at different stages of manufacture. Generally, the battery electrode composition refers to a plurality of active material particles, such as composite active material particles (e.g., Si—C nanocomposite particles), graphite particles, and so on. Before being mixed into a slurry, the active material particles of the battery electrode composition may be in the form of a dry powder. After being mixed into the slurry, the active material particles of the battery electrode composition may be suspended in a slurry suspension (e.g., along with other electrode components such as a binder, conductive additives, etc.). After the slurry is casted onto a current collector to form an electrode, the slurry is dried (solvent evaporation) and the active material particles of the battery electrode composition are bound together via a binder. After being sealed in a battery cell with other components such as electrolyte, the active material particles may store/release Li-ions during battery operation.

While the description below may describe certain examples in the context of composites comprising specific (e.g., alloying-type or conversion-type) active anode materials (such as Si, among others) or specific (e.g., intercalation-type or conversion-type) active cathode materials, it will be appreciated that various aspects may be applicable to many other types and chemistries of conversion-type anode and cathode active materials, intercalation-type anode and cathode active materials, pseudocapacitive anode and cathode active materials, and materials that may exhibit mixed electrochemical energy storage mechanisms.

While the description below may also describe certain examples of the material formulations in a Li-free state (for example, as in silicon-comprising nanocomposite anodes or metal fluoride cathodes or sulfur cathodes, etc.), it will be appreciated that various aspects may be applicable to Li-comprising electrodes and active materials (for example, partially or fully lithiated Si-comprising anodes or partially or fully lithiated Si-comprising anode particles, partially or fully lithiated metal fluoride comprising cathodes (such as a mixture of LiF and metals such as Cu, Fe, Ni, Bi, Zr, Ti, Mg, Nb, and various other metals and metal alloys and mixtures of such and other metals, etc.) or partially or fully lithiated metal halide comprising cathode particles, partially or fully lithiated chalcogenides (such as Li₂S, Li₂S/metal mixtures, Li₂Se, Li₂Se/metal mixtures, Li₂S—Li₂Se mixtures, various other compositions comprising lithiated chalcogenides etc.), partially or fully lithiated metal oxides (such as Li₂O, Li₂O/metal mixtures, etc.), partially or fully lithiated carbons, among others). In some designs, various material properties (e.g., at particle level, at inter-particle level, at electrode level, etc.) may change based on whether active material particle(s) are in a Li-free state, a partially lithiated state, or a fully lithiated state. Such Li-dependent material properties may include particle pore volume, electrode pore volume, and so on. Below, unless stated or implied otherwise, reference to such Li-dependent material properties (e.g., at particle level, at inter-particle level, at electrode level, etc.) may be assumed to be provided as if the active material particles are in the Li-free state. Further, some examples below are characterized at the electrode level (e.g., as opposed to particle level or interparticle level or cell level, etc.). Below, unless stated or implied otherwise, reference to such electrode level properties (e.g., electrode porosity or areal capacity loading or gravimetric/volumetric capacity, etc.) may be assumed to refer to the electrode components (e.g., active material particles, binder, conductive additives, etc.), excluding the current collector.

While the description below may describe certain examples in the context of Si—C composite (e.g. nanocomposite) anode active materials (e.g., nanocomposite particles which comprise silicon (Si) and carbon (C) and may comprise other elements, such as nitrogen (N), phosphorus (P), boron (B), oxygen (O), hydrogen (H), sulfur (S), fluorine (F), to name a few and where a total mass of the Si and the C atoms may contribute from about 75 wt. % to about 100 wt. % of the total mass of the composite particles), it will be appreciated that various aspects may be applicable to other types of high-capacity silicon-comprising anode active materials (including but not limited to, for example, various silicon-comprising or silicon oxide-comprising or silicon nitride-comprising or silicon oxy-nitride comprising or silicon phosphide-comprising particles or particles comprising a mixture or alloy or other combinations of such active materials, various other types of Si-comprising composites including, but not limited to core-shell or hierarchical or nanocomposite particles, etc.).

While the description below may describe certain examples in the context of some specific alloying-type and conversion-type chemistries of anode and cathode active materials for Li-ion batteries (such as silicon-comprising anodes or metal fluoride-comprising or lithium sulfide-comprising cathodes), it will be appreciated that various aspects may be applicable to other chemistries for Li-ion batteries (other conversion-type and alloying-type electrodes as well as various intercalation-type anodes and cathodes) as well as to other battery chemistries. In the case of metal-ion batteries (such as Li-ion batteries), examples of other suitable conversion-type electrodes include, but are not limited to, metal fluorides, metal chlorides, metal iodides, metal bromides, sulfur, metal sulfides (including, but not limited to lithium sulfide), selenium, metal selenide (including, but not limited to lithium sulfide), metal oxides, metal nitrides, metal phosphides, metal hydrides, their various mixtures, composites (including nanocomposites) and alloys and others.

During battery (such as a Li-ion battery) operation, conversion materials change (convert) from one crystal structure to another (hence the name “conversion”-type), where a material structure and composition may chemically and structurally change to one or multiple structures. This process is also accompanied by breaking chemical bonds and forming new ones. During battery (e.g., Li-ion battery) operation, Li ions are inserted into alloying-type materials forming lithium alloys (hence the name “alloying”-type). Sometimes, “alloying”-type electrode materials are considered to be a subclass of “conversion”-type electrode materials.

One aspect is directed to the battery or battery cell compositions with Si-comprising anodes, where higher energy density, higher power density, better cycle life, lower resistance and other improved critical battery parameters may be attained.

Silicon (Si) is an example of an alloy-type active material. In some designs, Si may be a part of the composite active material particles. In some designs, Si-comprising active material particles may also comprise carbon (C). In some embodiments, a total atomic fraction of the Si and the C in Si-comprising active anode material particles may contribute from about 75 at. % to about 100 at. % of the overall Si-comprising (e.g., composite or nanocomposite) particles. Such composite particles are sometimes referred to herein as Si—C composites (or nanocomposites). In some embodiments, such composite particles comprise nano-sized or nanostructured elements (e.g., nano-sized or nanostructured Si, nano-sized or nanostructured C), which may be referred to as nanocomposite particles. In some implementations, the Si or Si-comprising material present in such nanocomposites may be in the form of nanoparticles. In some implementations, the mass-average size of Si or Si-comprising material nanoparticles may range from about 1 nm to about 200 nm (in some designs, from about 1 nm to about 10 nm; in other designs, from about 10 nm to about 30 nm; in yet other designs, from about 30 nm to about 100 nm; in yet other designs, from about 100 nm to about 200 nm), as measured using image analysis of electron microscopy (e.g., transmission electron microscopy (TEM), scanning transmission electron microscopy (STEM), scanning electron microscopy (SEM)), X-ray microscopy, X-ray diffraction, neutron scattering and other suitable techniques.

An aspect is directed to a battery with a battery anode composition comprising a population of Si-comprising particles (e.g., nanocomposite particles, among others), in which each of the particles comprises Si and C (e.g., in some designs, some or all of the C part of each particle is in a form that is not electrochemically active), and the Si-comprising particles have certain characteristics. In some embodiments, a mass fraction of the silicon in the Si-comprising particles is in a range of about 3 wt. % to about 80 wt. % (in some designs, from about 3 wt. % to about 20 wt. %; in other designs, from about 20 wt. % to about 35 wt. %; in yet other designs, from about 35 wt. % to about 50 wt. %; in yet other designs, from about 50 wt. % to about 80 wt. %; in yet other designs, from about 50 wt. % to about 60 wt. %; in yet other designs, from about 60 to about 70 wt. %; in yet other designs, from about 70 wt. % to about 80 wt. %; in yet other designs, from about 20 wt. % to about 80 wt. %; in yet other designs, from about 35 wt. % to about 60 wt. %). In some embodiments, a Brunauer-Emmett-Teller (BET) specific surface area (SSA) of the Si-comprising particles (e.g., nanocomposite particles, among others) is in a range of about 0.5 m²/g to about 170 m²/g (in some designs, from about 0.5 to about 3 m²/g; in other designs, from about 3 m²/g to about 12 m²/g; in yet other designs, from about 12 m²/g to about 18 m²/g; in yet other designs, from about 18 m²/g to about 30 m²/g; in other designs, from about 30 m²/g to about 50 m²/g; in yet other designs, from about 50 m²/g to about 170 m²/g). In some embodiments, about 90% or more of the Si-comprising particles (e.g., nanocomposite particles, among others) in the population are characterized by aspect ratios of about 2.3 or less, or aspect ratios of about 2.1 or less. In some embodiments, about 50% or more of the composite particles in the population are characterized by aspect ratios of about 1.25 or more, or aspect ratios of about 1.35 or more.

An aspect is directed to a battery with a battery anode composition comprising a population of nanocomposite particles, in which each of the nanocomposite particles comprises Si and C (so that the total mass of Si and C atoms contributes about 75 to about 100 wt. % of the nanocomposite particle mass), and the nanocomposite particles have certain characteristics. In some embodiments, a mass fraction of the silicon in the nanocomposite particles is in a range of about 3 wt. % to about 80 wt. % (in some designs, from about 3 wt. % to about 20 wt. %; in other designs, from about 20 wt. % to about 35 wt. %; in yet other designs, from about 35 wt. % to about 50 wt. %; in yet other designs, from about 50 wt. % to about 80 wt. %; in yet other designs, from about 50 wt. % to about 60 wt. %; in yet other designs, from about 60 to about 70 wt. %; in yet other designs, from about 70 wt. % to about 80 wt. %; in yet other designs, from about 20 wt. % to about 80 wt. %; in yet other designs, from about 35 wt. % to about 60 wt.). In some embodiments, a Brunauer-Emmett-Teller (BET) specific surface area (SSA) of the composite particles is in a range of about 1 m²/g to about 200 m²/g (in some designs, from about 1 to about 3 m²/g; in other designs, from about 3 m²/g to about 12 m²/g; in yet other designs, from about 12 m²/g to about 18 m²/g; in yet other designs, from about 18 m²/g to about 30 m²/g; in yet other designs, from about 30 m²/g to about 50 m²/g; in yet other designs, from about 50 m²/g to about 200 m²/g; in yet other designs, from about 1 m²/g to about 50 m²/g).

An aspect is directed to a battery with an anode comprising silicon. In some implementations, the silicon is present in the anode at a mass fraction of at least 10 wt. %. Depending on the specific implementation, the Si mass fraction in the anode may be a range of about 10 wt. % to about 60 wt. %, or in a range of about 35 wt. % to about 60 wt. %, or in a range of about 35 wt. % to about 50 wt. %, or in a range of about 10 wt. % to about 25 wt. %, or in a range of about 25 wt. % to about 50 wt. %, or in a range of about 50 wt. % to about 60 wt. %. In some other implementations, the Si mass fraction in the anode may be greater than about 60 wt. %. Herein, the mass fraction of Si in the anode is calculated based on a measured or estimated mass of the Si and a measured or estimated mass of the anode, excluding the anode current collector.

An aspect is directed to a battery with a battery anode composition comprising a population of Si-comprising particles (e.g., nanocomposite particles, among others). The particle size distribution (PSD) that characterizes a particle population may be determined by laser particle size distribution analysis (LPSA) on well-dispersed particle suspensions in one example or by image analysis of electron microscopy images, or by other suitable techniques. While there are diverse processes of measuring PSDs, laser particle size distribution analysis (LPSA) is quite efficient for some applications. Note that other types of particle size distribution (e.g., by SEM image analysis) could also be utilized (and may even lead to more precise measurements, in some experiments). Using LPSA, particle size parameters of a population's PSD may be measured, such as: a tenth-percentile volume-weighted particle size parameter (e.g., abbreviated as D₁₀), a fiftieth-percentile volume-weighted particle size parameter (e.g., abbreviated as D₅₀), a ninetieth-percentile volume-weighted particle size parameter (e.g., abbreviated as D₉₀), and a ninety-ninth-percentile volume-weighted particle size parameter (e.g., abbreviated as D₉₉). Additionally, parameters relating to characteristic widths of the PSD may be derived from these particle size parameters, such as D₅₀-D₁₀ (sometimes referred to herein as a left width), D₉₀-D₅₀ (sometimes referred to herein as a right width), and D₉₀-D₁₀ (sometimes referred to herein as a full width). A cumulative volume fraction, defined as a cumulative volume of the composite particles with particle sizes of a threshold particle size or less, divided by a total volume of all of the composite particles, may be estimated by LPSA. In some embodiments, a fiftieth-percentile volume-weighted particle size parameter (D₅₀) of the PSD of Si-comprising particles may advantageously be in a range of about 0.5 to about 25.0 μm, or in a range of about 0.5 to about 4.0 μm, or in a range of about 4.0 to about 6.0 μm, or in a range of about 6.0 to about 8.0 μm or in a range of about 8.0 to about 16.0 μm or in a range of about 16.0 to about 25.0 μm. In some embodiments, a fiftieth-percentile volume-weighted particle size parameter (D₅₀) of the PSD is in a range of about 1.0 μm to about 12.0 μm (in some designs, from about 1.0 μm to about 2.0 μm; in other designs, from about 2.0 μm to about 4.0 μm; in yet other designs, from about 4.0 μm to about 6.0 μm; in yet other designs, from about 6.0 μm to about 12.0 μm). A cumulative volume fraction, defined as a cumulative volume of the composite particles with particle sizes of a threshold particle size or less, divided by a total volume of all of the composite particles, may be estimated by LPSA. In some embodiments (e.g., when the D₅₀ is in a range from about 0.5 μm to about 4.0 μm), the cumulative volume fraction, with the threshold particle size at 5 μm, may advantageously be about 99 vol. % or less, or about 95 vol. % or less, or about 90 vol. % or less, or about 85 vol. % or less, or about 80 vol. % or less. In other embodiments (e.g., when the D₅₀ is in a range from about 4.0 μm to about 6.0 μm), the cumulative volume fraction, with the threshold particle size at about 7 μm, may advantageously be about 99 vol. % or less, or about 95 vol. % or less, or about 90 vol. % or less, or about 85 vol. % or less, or about 80 vol. % or less. In other embodiments (e.g., when the D₅₀ is in a range from about 6.0 μm to about 8.0 μm), the cumulative volume fraction, with the threshold particle size at about 10 μm, may advantageously be about 99 vol. % or less, or about 95 vol. % or less, or about 90 vol. % or less, or about 85 vol. % or less, or about 80 vol. % or less. In other embodiments (e.g., when the D₅₀ is in a range from about 8.0 μm to about 16.0 μm), the cumulative volume fraction, with the threshold particle size at about 20 μm, may advantageously be about 99 vol. % or less, or about 95 vol. % or less, or about 90 vol. % or less, or about 85 vol. % or less, or about 80 vol. % or less. In yet other embodiments (e.g., when the D₅₀ is in a range from about 16.0 μm to about 25.0 μm), the cumulative volume fraction, with the threshold particle size at about 30 μm, may advantageously be about 99 vol. % or less, or about 95 vol. % or less, or about 90 vol. % or less, or about 85 vol. % or less, or about 80 vol. % or less. In some other embodiments (e.g., when the D₅₀ is in a range from about 2.0 μm to about 4.0 μm), the cumulative volume fraction, with the threshold particle size at about 4.6 μm, is about 90 vol. % or less, or about 85 vol. % or less, or about 80 vol. % or less. In other embodiments (e.g., when the D₅₀ is in a range from about 4.0 μm to about 6.0 μm), the cumulative volume fraction, with the threshold particle size at about 7 μm, is about 90 vol. % or less, or about 85 vol. % or less, or about 80 vol. % or less. In yet other embodiments (e.g., when the D₅₀ is in a range from about 6.0 μm to about 12.0 μm), the cumulative volume fraction, with the threshold particle size at about 15 μm, is about 90 vol. % or less, or about 85 vol. % or less, or about 80 vol. % or less.

Note that in some designs the presence of excessively large Si-comprising particles (e.g., in the form of nanocomposite particles, among others) may reduce cell performance characteristics (e.g., reduce cell stability, increase its impedance, reduce rate performance, reduce packing density, reduce electrode smoothness or uniformity, reduce electrode mechanical properties, reduce volumetric capacity, increase (e.g., localized) volume expansion, etc.). In some embodiments (e.g., when the D₅₀ is in a range from about 0.5 μm to about 4.0 μm), the cumulative volume fraction, with the threshold particle size at about 10 μm, may advantageously be about 80 vol. % or more, or about 85 vol. % or more, or (in some designs) even about 90 vol. % or more. In some embodiments (e.g., when the D₅₀ is in a range from about 0.5 μm to about 4.0 μm), the cumulative volume fraction, with the threshold particle size at about 12 μm, may advantageously be about 90 vol. % or more, or about 95 vol. % or more, or (in some designs) even about 98 vol. % or more. In other embodiments (e.g., when the D₅₀ is in a range from about 4.0 μm to about 6.0 μm), the cumulative volume fraction, with the threshold particle size at about 15 μm, may advantageously be about 80 vol. % or more, or about 85 vol. % or more, or (in some designs) even about 90 vol. % or more. In other embodiments (e.g., when the D₅₀ is in a range from about 4.0 μm to about 6.0 μm), the cumulative volume fraction, with the threshold particle size at about 25 μm, may advantageously be about 90 vol. % or more, or about 95 vol. % or more, or (in some designs) even about 98 vol. % or more. In other embodiments (e.g., when the D₅₀ is in a range from about 6.0 μm to about 8.0 μm), the cumulative volume fraction, with the threshold particle size at about 18 μm, may advantageously be about 80 vol. % or more, or about 85 vol. % or more, or (in some designs) even about 90 vol. % or more. In other embodiments (e.g., when the D₅₀ is in a range from about 4.0 μm to about 6.0 μm), the cumulative volume fraction, with the threshold particle size at about 35 μm, may advantageously be about 90 vol. % or more, or about 95 vol. % or more, or (in some designs) even about 98 vol. % or more. In other embodiments (e.g., when the D₅₀ is in a range from about 8.0 μm to about 16.0 μm), the cumulative volume fraction, with the threshold particle size at about 40 μm, may advantageously be about 80 vol. % or more, or about 85 vol. % or more, or (in some designs) even about 90 vol. % or more. In other embodiments (e.g., when the D₅₀ is in a range from about 8.0 μm to about 16.0 μm), the cumulative volume fraction, with the threshold particle size at about 50 μm, may advantageously be about 90 vol. % or more, or about 95 vol. % or more, or (in some designs) even about 98 vol. % or more. In some embodiments (e.g., when the D₅₀ is in a range from about 2.0 μm to about 4.0 μm), the cumulative volume fraction, with the threshold particle size at about 10 μm, is about 80 vol. % or more. In some embodiments (e.g., when the D₅₀ is in a range from about 2.0 μm to about 4.0 μm), the cumulative volume fraction, with the threshold particle size at about 12 μm, is about 90 vol. % or more. In other embodiments (e.g., when the D₅₀ is in a range from about 4.0 μm to about 6.0 μm), the cumulative volume fraction, with the threshold particle size at about 15 μm, is about 80 vol. % or more. In other embodiments (e.g., when the D₅₀ is in a range from about 4.0 μm to about 6.0 μm), the cumulative volume fraction, with the threshold particle size at about 22 μm, is about 90 vol. % or more. In other embodiments (e.g., when the D₅₀ is in a range from about 6.0 μm to about 12.0 μm), the cumulative volume fraction, with the threshold particle size at about 28 μm, is about 80 vol. % or more. In yet other embodiments (e.g., when the D₅₀ is in a range from about 6.0 um to about 12.0 μm), the cumulative volume fraction, with the threshold particle size at about 32 μm, is about 90 vol. % or more.

An aspect is directed to a battery with a battery anode composition comprising a population of composite (e.g., nanocomposite) particles, in which each of the composite particles comprises silicon and carbon (so that the total weight of Si and C atoms contributes to about 75-100 wt. % of the nanocomposite particle mass). The population may be characterized by a particle size distribution (PSD) as determined by laser particle size distribution analysis (LPSA) in one example. In some embodiments, a fiftieth-percentile volume-weighted particle size parameter (D₅₀) of the PSD is in a range of about 6.0 μm to about 8.0 μm. In some embodiments, a Brunauer-Emmett-Teller (BET) specific surface area (SSA) of the composite (e.g., Si—C nanocomposite) particles is in a range of about 1 m²/g to about 200 m²/g (in some designs, from about 1 to about 3 m²/g; in other designs, from about 3 m²/g to about 12 m²/g; in yet other designs, from about 12 m²/g to about 18 m²/g; in yet other designs, from about 18 m²/g to about 30 m²/g; in other designs, from about 30 m²/g to about 50 m²/g; in yet other designs, from about 50 m²/g to about 200 m²/g). In some designs, nanocomposite (e.g., Si—C) particles having lower BET SSA may be beneficial for batteries requiring longer calendar lifer and longer cycle life, particularly if these may operate at elevated temperatures (e.g., at about 30-80° C.) for about 1-100% of the time.

Yet another aspect is directed to a battery with a battery anode composition comprising a population of composite (e.g., nanocomposite) particles, in which each of the composite particles comprises silicon and carbon (so that the total mass of Si and C atoms contributes 75 to 100 wt. % of the nanocomposite particle mass). In some embodiments, the battery anode composition may comprise one or more carbon-comprising functional additives (e.g., additives that enhance electrical conductivity or rate performance of mechanical properties of the electrode). In some embodiments, the carbon-comprising functional additive is selected from: carbon nanotubes (e.g., single walled carbon nanotubes (SWCNTs), multi-walled carbon nanotubes (MWCNTs), carbon nanofibers, carbon black, graphite, exfoliated graphite, graphene oxide and graphene. In some embodiments, the battery electrode composition may comprise one or more binders (in some designs, two or more binder components).

An aspect is directed to a battery with a specific battery anode. In some embodiments, the battery anode comprises any of the foregoing battery electrode compositions, disposed on and/or in a current collector. In some embodiments, the battery anode electrode comprises a battery anode composition and a binder. In some embodiments, a coating density of the battery anode is in a range of about 0.8 to about 1.75 g/cm³ (in some designs, from about 0.8 to about 0.9 g/cm³; in other designs, from about 0.9 to about 1.0 g/cm³; in yet other designs, from about 1.0 to about 1.2 g/cm³; in other designs, from about 1.2 to about 1.5 g/cm³; in yet other designs, from about 1.5 to about 1.75 g/cm³). In some embodiments, the battery anode comprises a carbon-comprising functional additive. In some implementations, the carbon-comprising functional additive may be selected from: carbon nanotubes (e.g., SWCNT, MWCNT), carbon nanofibers, carbon black, branched or dendritic carbon, nanoporous carbon, graphite, exfoliated graphite, graphene oxide and graphene.

Yet another aspect is directed to a battery with a specific battery anode. In some embodiments, the battery anode comprises any of the foregoing battery electrode compositions, disposed on and/or in a current collector. In some embodiments, the battery electrode comprises a battery anode composition and a binder. In some embodiments, the battery anode composition comprises a population of jagged composite particles characterized by a particle size distribution (PSD) as determined by laser particle size distribution analysis (LPSA). In some embodiments, a fiftieth-percentile volume-weighted particle size parameter (D₅₀) of the PSD is in a range of about 3.0 to about 8.0 μm, or in a range of about 6.0 to about 8.0 μm. In some embodiments, a mass fraction of the binder in the battery anode is in a range of about 5 wt. % to about 10 wt. %, or in a range of about 7 wt. % to about 10 wt. %.

The battery anode (e.g., an anode comprising Si—C nanocomposite particles) may be characterized by an areal binder loading, defined as a mass fraction of the binder in the battery electrode, divided by a product of (1) a mass fraction of the jagged composite (e.g., nanocomposite) particles in the battery electrode, and (2) a Brunauer-Emmett-Teller (BET) specific surface area of the particle population. In some embodiments, an areal binder loading of the battery anode (e.g., anode comprising Si—C nanocomposite particles) may be in a range of about 2.0 mg/m² to about 15.0 mg/m² (e.g. in some designs, from about 2.0 mg/m² to about 5.0 mg/m²; in other designs, from about 5.0 mg/m² to about 9.0 mg/m²; in yet other designs, from about 9.0 mg/m² to about 13.0 mg/m²).

An aspect is directed to a lithium-ion battery. In some embodiments, the lithium-ion battery comprises an anode current collector, a cathode current collector, any one of the foregoing battery electrodes (anode and cathode) configured as an anode disposed on and/or in the anode current collector, a cathode disposed on and/or in the cathode current collector, and an electrolyte ionically coupling the anode and the cathode.

An aspect is directed to a process of making battery electrodes, comprising stages (A1), (A2), and (A3). Stage (A1) comprises providing any of the suitable battery electrode (anode or cathode) compositions. Stage (A2) comprises making a slurry comprising the battery electrode composition and a binder. Stage (A3) comprises casting the slurry on and/or in a current collector to form the battery electrode, which may optionally include densification (calendering) operation. In some embodiments, a coating density of the battery anode (e.g., an anode comprising nanocomposite Si-comprising particles, such as Si—C nanocomposite particles, among others) is in a range of about 0.8 to about 1.75 g/cm³ (in some designs, from about 0.8 to about 0.9 g/cm³; in other designs, from about 0.9 to about 1.0 g/cm³; in other designs, from about 1.0 to about 1.2 g/cm³; in other designs, from about 1.2 to about 1.75 g/cm³). In some embodiments (e.g., when using anodes with a dominant fraction (e.g., about 50-80 wt. %) or nearly 100% (e.g., about 80-100 wt. %) of Si—C nanocomposite as active anode material), an anode coating density may be within a range of about 0.9 to about 1.3 g/cm³. In some embodiments, an anode coating density may be within a range of about 0.9 to about 1.00 g/cm³. In some embodiments, a coating density of the battery cathode (e.g., a cathode comprising suitable cathode active material particles) may be in a range of about 1.1 to about 4.7 g/cm³ (in some designs, from about 1.1 to about 1.5 g/cm³; in other designs, from about 1.5 to about 2.2 g/cm³; in other designs, from about 2.2 to about 3.25 g/cm³; in other designs, from about 3.25 to about 3.75 g/cm³; in other designs, from about 3.75 to about 4.25 g/cm³; in other designs, from about 4.25 to about 4.70 g/cm³. In some embodiments (e.g., when using olivine-structured intercalation cathodes, such as LFP or LFMP, etc.), a cathode coating density may be within a range of about 2.2 to about 3.25 g/cm³. In some embodiments (e.g., when using layered intercalation cathodes, such as NCM, NCA, NCMA or LCO, etc.), a cathode coating density may be within a range of about 3.25 to about 4.25 g/cm³. In some embodiments, the battery electrodes comprise one or more of suitable carbon-comprising functional additives. In some implementations, the carbon-comprising functional additive may be selected from: carbon nanotubes (SWCNT or MWCNT or both), carbon nanofibers, carbon black, dendritic carbon, branched nano-carbon, nanoporous carbon, microporous carbon, mesoporous carbon, graphite, exfoliated graphite, graphene oxide (including defective graphene oxide) and graphene (including single-walled or multi-walled graphene or both; including defective and curved graphene). In some embodiments, a mass fraction of the binder in the battery anode is in a range of about 3 wt. % to about 10 wt. %. In some embodiments, a mass fraction of the binder in the battery cathode is in a range of about 0.5 wt. % to about 6 wt. % (in some designs, from about 0.5 wt. % to about 3 wt. %; in other designs, from about 3 wt. % to about 6 wt. %). Each of the battery electrodes may be characterized by an areal binder loading, defined as a mass fraction of the binder in the battery electrode, divided by a product of (1) a mass fraction of the active material (e.g., Si—C nanocomposite, etc.) particles in the battery electrode, and (2) a Brunauer-Emmett-Teller (BET) specific surface area of the population. In some embodiments, an areal binder loading of the battery anode (e.g., anode comprising Si—C nanocomposite particles, among others) may be in a range of about 0.20 mg/m² to about 15.0 mg/m² (e.g. in some designs, from about 0.20 mg/m² to about 2.0 mg/m²; in other designs, from about 2.0 mg/m² to about 5.0 mg/m²; in other designs, from about 5.0 mg/m² to about 9.0 mg/m²; in yet other designs, from about 9.0 mg/m² to about 13.0 mg/m²). In some embodiments, an areal binder loading of the battery cathode may be in a range of about 0.001 mg/m² to about 1.0 mg/m² (e.g. in some designs, from about 0.001 mg/m² to about 0.05 mg/m²; in other designs, from about 0.05 mg/m² to about 0.1 mg/m²; in other designs, from about 0.1 mg/m² to about 0.3 mg/m²; in yet other designs, from about 0.3 mg/m² to about 1.0 mg/m²). In some embodiments, the areal capacity loading of the anode may be in a range of about 2 mAh/cm² to about 20 mAh/cm² (in some designs, from about 2 to about 4 mAh/cm²; in other designs, from about 4 to about 7 mAh/cm²; in other designs, from about 7 to about 10 mAh/cm²; in other designs, from about 10 to about 15 mAh/cm²; in yet other designs, from about 15 to about 20 mAh/cm²). In some embodiments, the areal capacity loading of the cathode may be in a range of about 2 mAh/cm² to about 20 mAh/cm² (in some designs, from about 2 to about 4 mAh/cm²; in other designs, from about 4 to about 7 mAh/cm²; in other designs, from about 7 to about 10 mAh/cm²; in other designs, from about 10 to about 15 mAh/cm²; in yet other designs, from about 15 to about 20 mAh/cm²). In some embodiments, the areal capacity loading of the cathode may be in a range of about 2 mAh/cm² to about 12 mAh/cm² (in some designs, from about 2 to about 4 mAh/cm²; in other designs, from about 4 to about 6 mAh/cm²; in other designs, from about 6 to about 8 mAh/cm²; in other designs, from about 8 to about 10 mAh/cm²; in yet other designs, from about 10 to about 12 mAh/cm²). In some designs, the ratio of the area capacity loadings on the anode to that of the cathode (so-called, negative-to-positive or N/P ratio) may be in a range of about 0.95 to about 1.3 (in some designs, from about 0.95 to about 1.00; in other designs, from about 1.00 to about 1.05; in other designs, from about 1.05 to about 1.10; in other designs, from about 1.10 to about 1.15; in other designs, from about 1.15 to about 1.20; in other designs, from about 1.20 to about 1.30).

An aspect is directed to a process of making a lithium-ion battery, comprising stages (B1), (B2), and (B3). Stage (B1) comprises making a battery electrode according to any one of the foregoing processes of making a battery electrode, with the battery electrode being configured as an anode and the current collector being configured as the anode current collector. Stage (B2) comprises making or providing a cathode disposed on and/or in a cathode current collector. Stage (B3) comprises assembling a battery cell from the anode and the cathode (and other components, such as a separator or separator layer, cell packaging, and others, as needed) and filling the pores within the electrodes (if present) and a space between the anode and the cathode (e.g., a porous separator) with an electrolyte ionically coupling the anode and the cathode to form the lithium-ion battery.

An aspect is directed to a process of making a lithium-ion battery, comprising stages (C1), (C2), and (C3). Stage (C1) comprises providing any of the suitable battery electrodes, with the battery electrode being configured as an anode and the current collector being configured as the anode current collector. Stage (C2) comprises making a battery electrode according to any one of the foregoing processes of making a battery electrode, with the battery electrode being configured as a cathode and the current collector being configured as the cathode current collector. Stage (C3) comprises assembling a battery cell from the anode and the cathode (and other components, such as a separator or separator layer, cell packaging, and others, as needed) and filling the pores within the electrodes (if present) and a space between the anode and the cathode with an electrolyte ionically coupling the anode and the cathode to form the lithium-ion battery.

In some aspects, the battery electrode additionally comprises a carbon-comprising functional additive. In some aspects, the carbon-comprising functional additive is selected from: carbon nanotubes, carbon nanofibers, carbon black, branched nanocarbon, dendritic carbon, nanoporous carbon, microporous carbon, mesoporous carbon, graphite, exfoliated graphite, graphene oxide (e.g., defective graphene oxide, curved graphene oxide, single-layered graphene oxide, multi-layered graphene oxide, etc.), and graphene (e.g., defective graphene, curved graphene, single-layered graphene, multi-layered graphene, etc.).

In one or more embodiments of the present disclosure, Si-comprising active material (composite) particles may exhibit true density (e.g., as measured by using an argon gas pycnometer) in the range from about 1.1 g/cc to about 2.8 g/cc (in some designs, from about 1.1 g/cc to about 1.5 g/cc; in other designs, from about 1.5 g/cc to about 1.8 g/cc; in other designs, from about 1.8 g/cc to about 2.1 g/cc; in other designs, from about 2.1 g/cc to about 2.4 g/cc; in yet other designs, from about 2.4 g/cc to about 2.8 g/cc).

In one or more embodiments of the present disclosure, Si-comprising active material (composite) particles may comprise internal pores. In some designs, the open (e.g., to nitrogen gas at 77K) pore volume (e.g., as measured by nitrogen sorption/desorption isotherm measurement technique and including the pores in the range from about 0.4 nm to about 100 nm) may range from about 0.00 cc/g to about 0.50 cc/g (assuming theoretical density of the individual material components present in Si-comprising particles)-in some designs, from about 0.00 cc/g to about 0.10 cc/g; in other designs, from about 0.10 cc/g to about 0.20 cc/g; in other designs, from about 0.20 cc/g to about 0.30 cc/g; in other designs, from about 0.30 cc/g to about 0.40 cc/g; in other designs, from about 0.40 cc/g to about 0.50 cc/g. In some designs, the closed (e.g., to nitrogen gas at 77K) pore volume (e.g., measured by analyzing true density values measured by using an argon gas pycnometer and comparing to the theoretical density of the individual material components present in Si-comprising composite particles) may range from about 0.00 cc/g to about 1.00 cc/g-in some designs, from about 0.00 cc/g to about 0.10 cc/g; in other designs, from about 0.10 cc/g to about 0.20 cc/g; in other designs, from about 0.20 cc/g to about 0.30 cc/g; in other designs, from about 0.30 cc/g to about 0.40 cc/g; in other designs, from about 0.40 cc/g to about 0.50 cc/g; in other designs, from about 0.50 cc/g to about 0.60 cc/g; in other designs, from about 0.60 cc/g to about 0.70 cc/g; in other designs, from about 0.70 cc/g to about 0.80 cc/g; in other designs, from about 0.80 cc/g to about 0.90 cc/g; in other designs, from about 0.90 cc/g to about 1.00 cc/g). In some designs, the volume-average size of the open (e.g., to nitrogen gas at 77K) pores may range from about 0.5 nm to about 100 nm-in some designs, from about 0.5 nm to about 5 nm; in other designs, from about 5 nm to about 20 nm; in other designs, from about 20 nm to about 50 nm; in yet other designs, from about 50 nm to about 100 nm. In some designs, the volume-average size of the closed (e.g., to nitrogen gas at 77K) pores (e.g., measured by image analysis of cross-sectional electron microscopy images such as SEM or TEM or measured by the neutron scattering or other suitable technique) may range from about 0.5 nm to about 200 nm-in some designs, from about 0.5 nm to about 5 nm; in other designs, from about 5 nm to about 20 nm; in other designs, from about 20 nm to about 50 nm; in other designs, from about 50 nm to about 100 nm; in yet other designs, from about 100 nm to about 200 nm.

In one or more embodiments of the present disclosure, Si-comprising active material (composite) particles may exhibit moderate (e.g., about 7-120 vol. %) or high (e.g., about 120-200 vol. %) volume changes during initial lithiation (e.g., down to around 0.01 V vs. Li/Li⁺). In some designs, Si-comprising active material (composite) particles may exhibit volume changes in the range from about 8 vol. % to about 180 vol. % during one or more charge-discharge cycles of the battery cell. In one or more embodiments of the present disclosure, Si-comprising active material (composite) particles may exhibit moderately small (e.g., about 3-7 vol. %) or moderate (e.g., about 7-120 vol. %) volume changes during electrochemical battery cycling from about 0-5% state of charge (SOC) to about 90-100% SOC and back during battery operation. In one or more embodiments of the present disclosure, Si-comprising active material (composite) particles may exhibit reversible capacity for Li storage in the range from about 1400 to about 2800 mAh/g (e.g., about 1400-1600 mAh/g or about 1600-1800 mAh/g or about 1800-2000 mAh/g or about 2000-2400 mAh/g or about 2400-2800 mAh/g), as measured at room temperature in half cells using a suitable charge-discharge protocol (e.g., when lithiated to about 0.01 V vs. Li/Li⁺ using a constant (e.g., C/10) current and a constant voltage (e.g., to C/50 current) steps and de-lithiated to about 1.50 V vs. Li/Li⁺) using a constant current (e.g., C/10) step). In one or more embodiments of the present disclosure, Si-comprising active material (composite) particles may exhibit first cycle lithiation capacity in the range from about 1600 to about 3000 mAh/g (e.g., about 1600-1800 mAh/g or about 1800-2000 mAh/g or about 2000-2200 mAh/g or about 2200-2400 mAh/g or about 2400-2600 mAh/g or about 2600-3000 mAh/g), as measured at room temperature in half cells using a suitable charge-discharge protocol (e.g., when lithiated to about 0.01 V vs. Li/Li⁺ using a constant (e.g., C/10) current and a constant voltage (e.g., to C/50 current) steps and de-lithiated to about 1.50 V vs. Li/Li⁺) using a constant current (e.g., C/10) step). In one or more embodiments of the present disclosure, Si-comprising active material (composite) particles may exhibit first cycle “formation” losses in the range from about 6% to about 15% (e.g., about 6-8% or about 8-10% or about 10-12% or about 12-15%), as measured at room temperature in half cells using a suitable charge-discharge protocol (e.g., when lithiated to about 0.01 V vs. Li/Li⁺ using a constant (e.g., C/10) current and a constant voltage (e.g., to C/50 current) steps and de-lithiated to about 1.50 V vs. Li/Li⁺) using a constant current (e.g., C/10) step).

In one or more embodiments of the present disclosure, a preferred anode for a battery cell may comprise a mixture of Si-comprising active material particles (e.g., nanocomposite Si—C particles, nanocomposite Si particles, among others) and graphite active material particles (or, more broadly, carbon active material particles) as the anode active material, a so-called blended anode. In addition to the anode active material particles, an anode may comprise inactive material (separate from any inactive material that is made part of active material-comprising composite particles), such as binder(s) (e.g., polymer binder) and other functional additives (e.g., surfactants, electrically conductive additives, etc.). In some implementations, the anode active material (inclusive of any inactive material that is made part of active material-comprising composite particles) may be in a range of about 85 wt. % to about 98 wt. % of the total weight of the anode (not counting the weight of the current collector)-in some designs, from about 85 wt. % to about 89 wt. %; in other designs, from about 89 wt. % to about 91 wt. %; in other designs, from about 91 wt. % to about 93 wt. %; in other designs, from about 93 wt. % to about 95 wt. %; in yet other designs, from about 95 wt. % to about 98 wt. %.

In one or more embodiments of the present disclosure, a preferred anode for a battery cell may comprise a mixture of Si—C nanocomposite (e.g., particles) and graphite (e.g., particles) as the anode active material, a so-called blended anode. In addition to the anode active material particles, an anode may comprise inactive material (separate from any inactive material that is made part of active material-comprising composite particles), such as binder(s) (e.g., polymer binder) and other functional additives (e.g., surfactants, electrically conductive additives). In some implementations, the anode active material (inclusive of any inactive material that is made part of active material-comprising composite particles) may be in a range of about 90 wt. % to about 98 wt. % of the anode. For example, the anode active material particles may be about 95.5 wt. % of the anode. In some implementations, blended anodes may comprise Si—C nanocomposites (e.g., particles) ranging from about 7 wt. % to about 75 wt. % of the anode and the graphite (e.g., particles) making up the remainder of the mass (the weight) of the anode active material particles. In some implementations in which the anode active material particles are about 95.5 wt. % of the blended anode, the blended anode (including active material particles and inactive material) may comprise about 7 wt. % of Si—C nanocomposite (e.g., particles) and about 88.5 wt. % of graphite particles. In some implementations in which the anode active material particles are about 95.5 wt. % of the blended anode, the blended anode (including active material particles and inactive material) may comprise about 19 wt. % of Si—C nanocomposite (e.g., particles) and about 76.5 wt. % of graphite particles. In some implementations in which the anode active material particles are about 95.5 wt. % of the blended anode, the blended anode (including active material particles and inactive material) may comprise about 35 wt. % of Si—C nanocomposite (e.g., particles) and about 60.5 wt. % of graphite particles. In some implementations in which the anode active material particles are about 94.5 wt. % of the blended anode, the blended anode (including active material particles and inactive material) may comprise about 50 wt. % of Si—C nanocomposite (e.g., particles) and about 44.5 wt. % of graphite particles. In some implementations in which the anode active material particles are about 92.5 wt. % of the blended anode, the blended anode (including active material particles and inactive material) may comprise about 69.4 wt. % of Si—C nanocomposite (e.g., particles) and about 23.1 wt. % of graphite particles. In some designs, a higher fraction of Si—C composite particles in the blended anode may benefit from a higher fraction of inactive material (separate from any inactive material that is made part of the Si—C composite particles) to attain superior cycle stability and other performance characteristics.

While the descriptions below may also describe certain examples of the blended anode formulations expressed as mass (wt. %) of Si—C nanocomposite (e.g., particles), it will be appreciated that various aspects of this disclosure may be applicable to blended anode formulations expressed as wt. % of Si element in the anode. In some illustrative implementations, a blended anode composition of about 7 wt. % of Si—C nanocomposite (e.g., particles) may correspond, for example, to about 3 wt. % of Si in the blended anode. In some implementations, a blended anode composition of about 19 wt. % of Si—C nanocomposite corresponds to about 8 wt. % of Si in the blended anode. In some implementations, a blended anode composition of about 35 wt. % of Si—C nanocomposite (e.g., particles) corresponds to about 15 wt. % of Si in the blended anode. In some implementations, a blended anode composition of about 50 wt. % of Si—C nanocomposite (e.g., particles) corresponds to about 21 wt. % of Si in the blended anode. In some implementations, a blended anode composition of about 80 wt. % of Si—C nanocomposite (e.g., particles) corresponds to about 34 wt. % of Si in the blended anode. In some implementations, a blended anode composition of about 95 wt. % of Si—C nanocomposite (e.g., particles) corresponds to about 36 wt. % of Si in the blended anode. In respective implementations, blended anodes may be obtained in which the mass (weight) of the silicon is in a range of about 3 wt. % to about 36 wt. % of a total mass of the anode.

While the descriptions below may also describe certain examples of the blended anode formulations expressed as mass (wt. %) of Si—C nanocomposite (e.g., particles), it will be appreciated that various aspects of this disclosure may be applicable to blended anode formulations attributing a fraction (e.g., %) of the total capacity of the blended anode to the capacity of the Si. In some implementations, about 25% of the total capacity of the blended anode is obtained from the Si—C nanocomposite (e.g., particles) in a blended anode composition of about 7 wt. % of Si—C nanocomposite (e.g., particles). In some other implementations, about 50% of the total capacity of the blended anode is obtained from the Si—C nanocomposite (e.g., particles) in a blended anode composition of about 19 wt. % of Si—C nanocomposite (e.g., particles). In some other implementations, about 70% of the total capacity of the blended anode is obtained from the Si—C nanocomposite in a blended anode composition of about 35 wt. % of Si—C nanocomposite (e.g., particles). In some other implementations, about 80% of the total capacity of the blended anode is obtained from the Si—C nanocomposite (e.g., particles) in a blended anode composition of about 50 wt. % of Si—C nanocomposite (e.g., particles).

While the description below may describe certain examples of suitable intercalation-type graphites to be used in combination with Si—C nanocomposite (e.g., particles) in a blend, it will be appreciated that various aspects of this disclosure may be applicable to soft-type synthetic graphite (or soft carbon, broadly), hard-type synthetic graphite (or hard carbon, broadly), synthetic graphite (including soft-type synthetic graphite and hard-type synthetic graphite), and natural graphite (which may, for example, be pitch carbon coated); including but not limited to those which exhibit discharge capacity from about 320 to about 372 mAh/g (e.g., in some designs, from about 320 to about 350 mAh/g; or in other designs, from about 350 to about 362 mAh/g; or in other designs, from about 362 to about 372 mAh/g); including but not limited to those which exhibit low, moderate and high swelling; including but not limited to those which exhibit good and poor compression, including but not limited to those which exhibit Brunauer-Emmett-Teller (BET) specific surface area of about 1 to about 4 m²/g; including but not limited to those which exhibit lithiation efficiency of about 90% and more; including but not limited to those which exhibit average particle sizes from about 8 μm to about 18 μm; including but not limited to those which exhibit true densities ranging from about 1.5 g/cm³ to about 2.3 g/cm³ (e.g., in some designs, from about 1.5 to about 1.8 g/cm³, in other designs, from about 1.8 to about 2.3 g/cm³); including but not limited to those which exhibit poor, moderate, or good cycle life when used in Li-ion battery anodes on their own (e.g., without Si—C composites or other active particles); including but not limited to those which are coated and comprise coatings with coating thickness to appreciably improve compression and springing during cycling, or any combination thereof.

Illustrative examples of suitable intercalation-type cathodes to be used in preferable cells may include, but are not limited to: lithium nickel cobalt aluminum oxides (NCA), lithium nickel cobalt manganese aluminum oxides (NCMA), rechargeable lithium nickel oxides (LNO) (including “doped” rechargeable LNO represented by the formula LiNiₓM_{y}O₂; x is between 0.8 and 1; y is between 0 and 0.2; x+y is between 0.98 and 1.02; and M represents an element or a mixture of two or more elements, the element or at least one of the two or more elements being selected from the following: manganese (Mn), magnesium (Mg), molybdenum (Mo), cobalt (Co), titanium (Ti), tungsten (W), niobium (Nb), cobalt (Co), zirconium (Zr), tantalum (Ta), tin (Sb), and aluminum (Al)), lithium manganese oxides (LMO), lithium nickel manganese cobalt oxides (NCM), lithium cobalt oxide (LCO), lithium cobalt aluminum oxides (LCAO), lithium iron phosphate (LFP), lithium cobalt phosphate (LCP), lithium manganese phosphate (LMP), lithium manganese iron phosphate (LMFP), lithium nickel phosphate (LiNiPO₄), lithium vanadium fluorophosphate (LiVFPO₄), lithium iron fluorosulfate (LiFeSO₄F), various Li excess materials (e.g., lithium-excess (rocksalt) transition metal oxides and oxy-fluorides such as those comprising Mn, Mo, Cr, Ti, and/or Nb, such as, for example, Li_{1.211}Mo_{0.467}Cr_{0.3}O₂, Li_{1.3}Mn_{0.4}Nb_{0.3}O₂, Li_{1.2}Mn_{0.4}Ti_{0.4}O₂, Li_{1.2}Ni_{0.333}Ti_{0.333}Mo_{0.133}O₂ and many others), various high capacity Li-ion based materials with partial substitution of oxygen for fluorine or iodine (e.g., disordered or ordered rocksalt compositions comprising Mn, Mo, Cr, Ti and/or Nb, such as, for example, Li₂Mn_{2/3}Nb_{1/3}O₂F, Li₂Mn_{1/2}Ti_{1/2}O₂F, Li_{1.5}Na_{0.5}MnO_{2.85}I_{0.12}, among others) and many other types of Li-comprising disordered, layered, tavorite, olivine, or spinel type active materials or their mixtures comprising at least oxygen or fluorine or sulfur and at least one transition metal and other lithium transition metal (TM) oxides or phosphates or sulfates (or mixed) cathode active materials that rely on the intercalation of lithium (Li) and changes in the TM oxidation state (including, but not limited to those that may be doped or heavily doped; including, but not limited to those that have gradient in composition or core-shell morphology; including, but not limited to those that may be partially fluorinated or comprise some meaningful fraction of fluorine (e.g., about 0.001-10 at. %) in their composition, etc.), and their various mixtures. It will also be appreciated that various aspects may be applicable to high-voltage lithium transition metal oxide (or phosphate or sulfate or mixed or other) cathodes where TMs and oxygen (O) are covalently bonded and both TM and O take part in electrochemical reduction-oxidation (redox) reactions during charge and discharge (including, but not limited to, those oxides or phosphate or sulfate or mixed cathodes that may comprise at least about 0.25 at. % of Mn, Fe, Ni, Co, Nb, Mg, Cr, Mo, Zr, W, Ta, Ti, Hf, Y, La, Sb, V, Sn, Si, or Ge).

In some of the preferred examples a surface of cathode active materials (e.g., intercalation-type cathode materials, such as LCO, NCM, NCMA, NCA, LMO, LMNO, LFP, LMP, LMFP, etc. or conversion-type active materials comprising S, Li₂S, metal sulfides, metal fluorides, etc.) may be coated with a layer of ceramic material. In some of the preferred examples a surface of cathode active materials may be coated with a layer of a polymeric material. Illustrative examples of a preferred coating material for such cathodes include, but are not limited to, various oxides and oxy-fluorides, such as titanium oxide (e.g., TiO₂), aluminum oxide (e.g., Al₂O₃), tungsten oxide (e.g., WO), molybdenum oxide (e.g., MoO or MoO₂), chromium oxide (e.g., Cr₂O₃), niobium oxide (e.g., NbO or NbO₂) and zirconium oxide (e.g., ZrO₂) and their various mixtures. In some designs, such ceramic materials may additionally comprise lithium (Li)—e.g., as lithium titanium oxide (or oxyfluoride), lithium aluminum oxide (or oxyfluoride), lithium tungsten oxide (or oxyfluoride), lithium chromium oxide (or oxyfluoride), lithium niobium oxide (or oxyfluoride), lithium zirconium oxide (or oxyfluoride) and their various alloys, mixtures and combinations. In other preferred examples, LCO, NCM, NCMA, NCA, LFP, LMFP, LMP, LMO or LMNO may be doped with Al, Ti, Mg, Nb, Zr, Cr, Hf, Ta, W, Mo or La. In some designs, a preferred cathode current collector material is aluminum or aluminum alloy or an aluminum-comprising composite. In some designs, a preferred battery cell includes a polymer or polymer-comprising separator membrane or a polymer-comprising separator layer. In some of the preferred examples, a polymer separator is made of or comprises polyethylene, polypropylene or a mixture thereof. In some of the preferred examples, a surface of a polymer separator (membrane or layer) is coated with a layer of ceramic material, or a polymer separator (membrane or layer) may comprise ceramic material. Examples of a preferred coating material for polymer separators may include, but not limited to titanium oxide (TiO₂), aluminum oxide (Al₂O₃), aluminum hydroxide or oxyhydroxide, zirconium oxide (ZrO₂), magnesium oxide (MgO) or magnesium hydroxide or oxyhydroxide.

In some embodiments, the areal capacity loading of the anode may be in a range of about 2 mAh/cm² to about 20 mAh/cm² (in some designs, from about 2 to about 4 mAh/cm²; in other designs, from about 4 to about 7 mAh/cm²; in other designs, from about 7 to about 10 mAh/cm²; in other designs, from about 10 to about 15 mAh/cm²; in yet other designs, from about 15 to about 20 mAh/cm²). In some embodiments, the areal capacity loading of the cathode may be in a range of about 2 mAh/cm² to about 20 mAh/cm² (in some designs, from about 2 to about 4 mAh/cm²; in other designs, from about 4 to about 7 mAh/cm²; in other designs, from about 7 to about 10 mAh/cm²; in other designs, from about 10 to about 15 mAh/cm²; in yet other designs, from about 15 to about 20 mAh/cm²). In some designs, the ratio of the area capacity loadings on the anode to that of the cathode (so-called, negative-to-positive or N/P ratio) may be in a range of about 0.95 to about 1.30 (in some designs, from about 0.95 to about 1.00; in other designs, from about 1.00 to about 1.05; in other designs, from about 1.05 to about 1.10; in other designs, from about 1.10 to about 1.15; in other designs, from about 1.15 to about 1.20; in other designs, from about 1.20 to about 1.30).

The inventors identified the battery or battery cell compositions with Si-comprising anodes, where higher energy density, higher power density, better cycle life, lower resistance and/or other improved critical battery parameters may be attained. Such improvements are not trivial and are believed to be unknown in the state of the art. Many of such improvements are very unexpected. For example, attaining better cycle life and/or attaining lower cell resistance by the addition of Li supplements in the cathodes of battery cells with Si-comprising anodes would typically be considered counter-intuitive.

In some embodiments, the disclosed Li-ion battery cell comprises both: (i) Si-comprising anode (e.g., an anode comprising suitable Si-comprising anode materials, such as Si—C nanocomposites with suitable properties, among others) and (ii) lithium supplement-comprising cathode (e.g., a cathode comprising suitable primary cathode active materials and suitable amount of suitable Li supplement materials (supplemental cathode active material)).

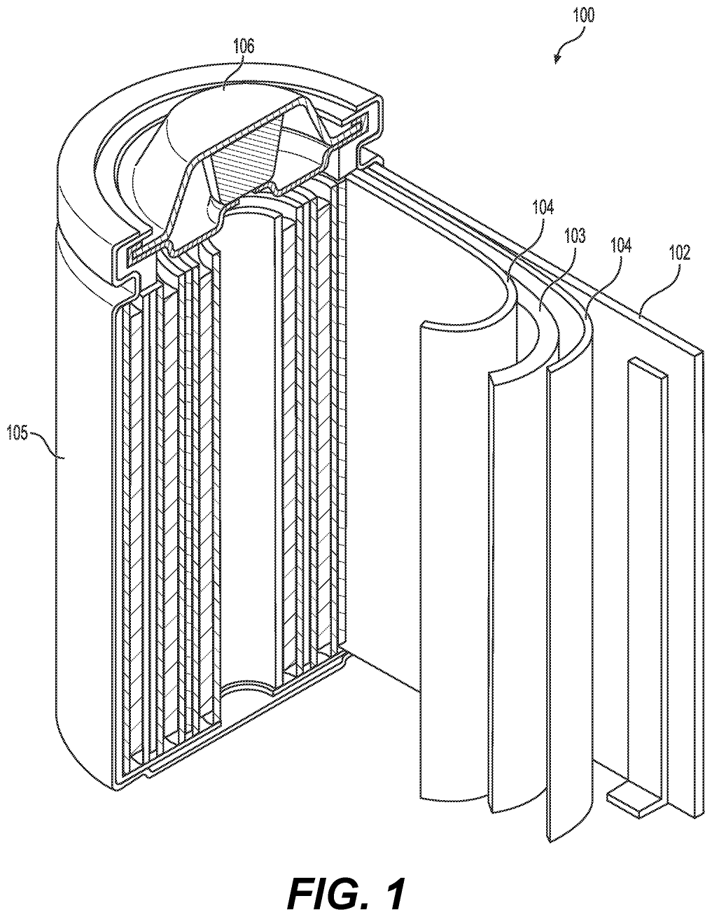

FIG. 1 illustrates an example metal-ion (e.g., Li-ion) battery in which the electrode particles, components, materials, processes, and other techniques described herein, or combinations thereof, may be applied according to various embodiments. A cylindrical battery is shown here for illustration purposes, but other types of arrangements, including prismatic or pouch (laminate-type) batteries, may also be used as desired. The example battery 100 includes a negative electrode (anode electrode or anode) 102, a positive electrode (cathode electrode or cathode) 103, a separator 104 interposed between the anode 102 and the cathode 103, an electrolyte (shown implicitly) impregnating the separator 104, a battery case 105, and a sealing member 106 sealing the battery case 105. The electrolyte ionically couples the anode (negative electrode) and the cathode (positive electrode). The electrolyte is interposed between the anode electrode and the cathode electrode. In some implementations, battery 100 also includes an anode current collector and a cathode current collector. The anode is disposed on and/or in the anode current collector and the cathode is disposed on and/or in the cathode current collector.

In some embodiments of the present disclosure, the Li-ion batteries may benefit from the use of certain electrolyte compositions in battery cell fabrication to attain superior characteristics. In some designs, suitable electrolyte composition may comprise (i) one, two, three or more Li salts with the total concentration in the range from about 0.8M to about 2.0M (in some designs, from about 0.8M to about 1.0M; in other designs, from about 1M to about 1.1M; in other designs, from about 1.1M to about 1.2M; in other designs, from about 1.2M to about 1.3M; in other designs, from about 1.3M to about 1.4M; in other designs, from about 1.4M to about 1.6M; in other designs, from about 1.6M to about 1.7M; in other designs, from about 1.7M to about 1.8M; in other designs, from about 1.8M to about 2.0M); (ii) one, two or more cyclic carbonates (in some designs, fluorinated cyclic carbonates, such as fluoroethylene carbonate (FEC), among others), (iii) zero, one, two, three or more nitrogen-comprising co-solvents or additives (in some designs, at least some of the nitrogen comprising co-solvents may advantageously comprise two or three or more nitrogen atoms per molecules), (iv) zero, one, two, three or more sulfur comprising additives, (v) zero, one, two, three or more phosphorous comprising additives (note that some co-solvents may advantageously comprise both phosphorus and sulfur), (vi) zero, one, two, three or more linear or branched esters as co-solvents, (vii) zero, one, two, or more linear carbonates as co-solvents, (viii) zero, one, two, three or more additional electrolyte co-solvents or additives. In some designs, the volume fraction of linear esters (as a fraction of all co-solvents in the electrolyte) may range from about 20 vol. % to about 85 vol. % (in some designs, from about 20 vol. % to about 40 vol. %; in other designs, from about 40 vol. % to about 60 vol. %; in yet other designs, from about 60 vol. % to about 85 vol. %. In some designs, the volume fraction of branched esters (as a fraction of all co-solvents in the electrolyte) may range from about 10 vol. % to about 80 vol. % (in some designs, from about 10 vol. % to about 30 vol. %; in other designs, from about 30 vol. % to about 60 vol. %; in yet other designs, from about 60 vol. % to about 80 vol. %). In some designs, the volume fraction of cyclic carbonates (as a fraction of all co-solvents in the electrolyte) may range from about 5 vol. % to about 40 vol. % (in some designs, from about 5 vol. % to about 10 vol. %; in other designs, from about 10 vol. % to about 20 vol. %; in yet other designs, from about 20 vol. % to about 40 vol. %). In some designs, the volume fraction of fluorinated cyclic carbonates (e.g., FEC) (as a fraction of all co-solvents in the electrolyte) may range from about 1 vol. % to about 20 vol. % (in some designs, from about 1 vol. % to about 4 vol. %; in other designs, from about 4 vol. % to about 6 vol. %; in other designs, from about 6 vol. % to about 12 vol. %; in yet other designs, from about 12 vol. % to about 20 vol. %). In some designs, the volume fraction of vinylene carbonate (VC) (as a fraction of all co-solvents in the electrolyte) may range from about 0.1 vol. % to about 6 vol. % (in some designs, from about 0.1 vol. % to about 0.5 vol. %; in other designs, from about 0.5 vol. % to about 1 vol. %; in other designs, from about 1 vol. % to about 2 vol. %; in yet other designs, from about 2 vol. % to about 6 vol. %). In some designs, 50 vol. % or more of the co-solvents may advantageously exhibit a melting point below about minus (−) 60° C. (in some designs, below about −70° C.; in other designs, below about −80° C.). In some designs utilizing two or more salts (e.g., two salts or three salts or four salts or five salts, etc.), it may be advantageous for at least one of the salts to comprise LiPF₆ as a main salt. In some designs, the incorporation of such salts may enhance properties (cycle stability, resistance, thermal stability, performance at high or low temperatures, etc.) of the cathode CEI or the anode SEI or provide other performance advantages. In some designs, it may be further advantageous for at least one other salt to also be a salt of Li. Examples of some of such suitable salts include, but are not limited to: LiFSI, LiTFSI, LiBETI and other Li imide salts, Li bis(oxalato)borate (LiBOB), Li difluoro(oxalato)borate (LiDFOB), Li 2-trifluoromethyl-4,5-dicyanoimidazolide (LiTDi), Li 4,5-dicyano-2-(pentafluoroethyl) imidazolide (LiPDi), Li difluorophosphate (LiDFP), Li nitrate (LiNO₃), etc.). In some designs, it may be advantageous for at least one of the salts to comprise LiFSI as a main salt. In yet some other designs, a mixture of LiPF₆, and LiFSI may be advantageously used as a main salt formulation.

In some designs, suitable electrolyte may comprise one or more of the following SEI-building cyclic carbonate additives, such as: fluoroethylene carbonate (FEC), ethylene carbonate (EC), vinylene carbonate (VC), among others.

In some designs, suitable electrolyte may comprise zero, one or more of the following solvent additives or salt additives: adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, 1-(propan-2-yl)-1H-imidazole-4,5-dicarbonitrile, pyridine-2,6-dicarbonitrile, ethylene glycol bis(propionitrile) ether (EGBE), 3-(triethoxysilyl) propionitrile, succinonitrile (SN), benzonitrile, 4-(trifluoromethyl) benzonitrile, 1,2,2,3-propanetetracarbonitrile, triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, lithium difluorophosphate (LFO), lithium tetrafluoroborate (LiBF₄), lithium bis(fluorosulfonyl)imide (LiFSI), lithium bis(trifluoromethanesulfonyl)imide (LiTFSI), lithium fluorosulfate (LiSO₃F), lithium difluoro(oxalato)borate (LiDFOB) and lithium bis(oxalato)borate (LiBOB), 1,3,2-dioxathiolane 2,2-dioxide (DTD), and methylene methanedisulfonate (MMDS).

In some designs, suitable electrolyte may comprise one or more of the following solvents: ethyl propionate, ethyl isobutyrate, ethyl acetate, methyl acetate, propyl propionate, ethyl isovalerate, ethyl trimethylacetate, methyl butyrate, γ-butyrolactone, propylene carbonate, dimethyl carbonate, ethyl methyl carbonate, diethyl carbonate, methyl phenyl carbonate, diphenyl carbonate, hexamethyl acetone, pinacolone, methyl ethyl ketone, diethyl ketone, methyl isopropyl ketone, diisopropyl ketone, ethyl isopropyl ketone, heptane, hexane, octane, cyclohexane, cycloheptane, benzene, toluene, xylene, tert-butylbenzene, fluorobenzenes, fluorotoluenes, fluoroxylenes, fluoroheptanes, fluorooctanes, fluorohexanes, fluoropentanes, benzoyl fluoride, ethyl methyl sulfite, diethyl sulfite, 1,3-propylene sulfite, 1,2-propylene sulfite, sulfolane, dimethyl sulfone, ethyl methyl sulfone, ethyl isopropyl sulfone, dimethyl sulfoxide, tetrahydrothiophene 1-oxide, trimethyl phosphate, triethyl phosphate, triphenyl phosphate, 1,1,2,2-tetrafluoroethyl 2,2,3,3-tetrafluoropropyl ether, perfluorotriethylamine, N,N-dimethylformamide, hexamethylphosphoramide, N-methyl-2-pyrrolidinone, tetramethylurea, N,N′-dimethylpropyleneurea, 1,3-dimethyl-2-imidazolidinone, nitromethane, nitropropane, acetonitrile, propionitrile, butyronitrile, valeronitrile, hexanenitrile, and trimethylacetonitrile.

In some embodiments, an electrolyte may comprise a salt composition and an electrolyte solvent composition, with the salt composition comprising a primary salt. In some implementations, the primary salt may be the sole salt in the salt composition. In some other implementations, there may be secondary salt(s) in addition to the primary salt. In some implementations, the primary salt may be at least about 50 mol. % of the salt composition, and in some other implementations, the primary salt may be at least about 67 mol. % of the salt composition. In some cases, the primary salt may be LiPF₆. Alternatively, other salts such as lithium tetrafluoroborate (LiBF₄), lithium bis(fluorosulfonyl)imide (LiFSI), lithium bis(trifluoromethanesulfonyl)imide (LiTFSI), and lithium fluorosulfate (LiSO₃F) may be suitable for use as the primary salt in some implementations. For example, in some cases, such as high-voltage applications, lithium tetrafluoroborate (LiBF₄) may be suitable as a primary salt. For example, in some cases, such as implementations in which nickel (Ni)-comprising material (e.g., LNO, L₂NO supplement (additive), NCM, NCA, NCMA, etc.) is employed as a cathode active material, lithium bis(fluorosulfonyl)imide (LiFSI), lithium bis(trifluoromethanesulfonyl)imide (LiTFSI), or lithium fluorosulfate (LiSO₃F) may be suitable as a primary salt to limit electrolyte oxidation.

In some implementations, there may be secondary salt(s) in addition to the primary salt. In some designs, the secondary salt(s) may be selected from: lithium bis(fluorosulfonyl)imide (LiFSI), lithium tetrafluoroborate (LiBF₄), lithium difluoro(oxalato)borate (LiDFOB), lithium bis(oxalato)borate (LiBOB), lithium difluorophosphate (LFO), lithium fluorosulfate (LiSO₃F), and lithium bis(trifluoromethanesulfonyl)imide (LiTFSI).

In some implementations, the mole fraction of the salt composition (including the primary salt and any secondary salts), may be in a range of about 5 mol. % to about 15 mol. %. There may be beneficial effects in adding secondary salt(s) when LiPF₆ is employed as a primary salt in an electrolyte. For example, LiFSI may be used as a secondary salt (e.g., at a mole fraction of up to about 7.5 mol. % in the electrolyte), particularly for batteries in which the cell voltage is below about 4.3 V. For example, LiBF₄ may be used as a secondary salt (e.g., at a mole fraction of up to about 7.5 mol. % in the electrolyte), particularly for batteries in which the cell voltage is above about 4.2 V and/or for batteries for high-temperature applications. In this case, LiBF₄ may improve the oxidation stability of the electrolyte, and hence may decrease electrolyte oxidation by, for example, a supplemental cathode active material. For example, a borate salt (e.g., LIDFOB, LiBOB) may be used as a secondary salt (e.g., at a mole fraction of up to about 3.0 mol. % in the electrolyte), particularly for batteries in which the cell voltage is above about 4.2 V and/or for batteries for high-temperature applications. In this case, the borate salt(s) may function as CEI-formers and hence decrease electrolyte oxidation by cathode materials such as the supplemental cathode active material. For example, LFO may be used as a secondary salt (e.g., at a mole fraction of up to about 3.0 mol. % in the electrolyte), particularly for batteries in which the cathode comprises a Ni-based material, such as LNO, L₂NO supplement (additive), NCM, NCA, NCMA, etc. In this case, the LFO may decrease electrolyte oxidation by the Ni-based cathode material. For example, LiSO₃F and/or LiTFSI may be used as a secondary salt (e.g., at a mole fraction of up to about 7.5 mol. % in the electrolyte), particularly for batteries in which the cathode comprises a Ni-based material, such as L₂NO supplement (additive), LNO, NCM, NCA, NCMA, etc. In this case, the LiSO₃F and/or LiTFSI may decrease electrolyte oxidation by the Ni-based cathode material.

In some embodiments, an electrolyte may comprise a salt composition and an electrolyte solvent composition, as described above. Herein, the term “electrolyte solvent composition” is used to refer to an electrolyte composition comprising all solvents (regardless of whether they are considered to be primary solvents or co-solvents), as well as additive compounds. In some implementations, the electrolyte solvent composition may comprise fluoroethylene carbonate (FEC) and/or vinylene carbonate (VC). In implementations in which FEC is present in the electrolyte, a mole fraction of the FEC in the electrolyte may be in a range of about 1 to about 10 mol. %, or higher than about 10 mol. %. In some designs, the mole fraction of the FEC in the electrolyte may be quite high (e.g., about 10-about 20 mol. %, about 20-about 30 mol. %, or about 30 to about 40 mol. %) in batteries in which Si-based active materials, such as Si—C nanocomposites, are employed in the anode. In implementations in which VC is present in the electrolyte, a mole fraction of the VC in the electrolyte may be in a range of about 0.1 to about 3 mol. %.

In some embodiments, an electrolyte may comprise a salt composition and an electrolyte solvent composition, as described above. In some implementations, the electrolyte solvent composition may comprise (1) at least one ester compound and/or (2) at least one linear carbonate compound. In some designs, if at least one ester compound is employed in the electrolyte solvent composition, the ester compound(s) may be selected from propyl propionate (PP), methyl butyrate (MB), ethyl propionate (EP), ethyl isobutyrate (EI), ethyl isovalerate (EIV), methyl acetate (MA), ethyl trimethylacetate (ET), ethyl acetate (EA), and ethyl butyrate (EB). In some designs, if at least one linear carbonate compound is employed in the electrolyte solvent composition, the linear carbonate compound(s) may be selected from dimethyl carbonate (DMC), ethyl methyl carbonate (EMC), and diethyl carbonate (DEC). In some implementations, the mole fraction of the ester compound(s) and/or linear carbonate(s), taken together, may be in a range of about 20 to about 70 mol. %, or higher (e.g., about 70 to about 80 mol. %)

In some implementations, cyclic carbonates other than FEC and VC are not used in the electrolyte solvent composition. In some implementations, propylene carbonate is not used in the electrolyte solvent composition. In some other implementations, the electrolyte solvent composition may comprise, in addition to the ester(s) and/or linear carbonate(s), at least one cyclic carbonate (other than FEC and VC). In some designs, if at least one cyclic carbonate is employed in the electrolyte solvent composition, the cyclic carbonate(s) may be selected from ethylene carbonate (EC) and propylene carbonate (PC). EC, PC, or a mixture of EC and PC may be used. The use of PC may be preferable in some cases, for example in applications in which the cell voltage is greater than about 4.2 V, to alleviate high-temperature outgassing.

In some embodiments, an electrolyte may comprise one or more additives. In some designs, if at least one additive is employed in the electrolyte, the additive(s) may be selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, 1-(propan-2-yl)-1H-imidazole-4,5-dicarbonitrile, pyridine-2,6-dicarbonitrile, ethylene glycol bis(propionitrile) ether (EGBE), 3-(triethoxysilyl) propionitrile, succinonitrile (SN), benzonitrile, 4-(trifluoromethyl) benzonitrile, 1,2,2,3-propanetetracarbonitrile, triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, 1,3,2-Dioxathiolane 2,2-dioxide (DTD), and methylene methanedisulfonate (MMDS). In some implementations, a total amount of the additives is limited to about 10 mol. % or less or about 5 mol. % or less. In some designs, one or more of these additive compounds, when employed in an electrolyte, may be effective in reducing high-temperature outgassing. In particular, in some designs, some or all of these additive compounds (e.g., TIB, TMSB, TMSPI, PS, PES, MMDS, DTD, CA) may be effective as CEI-formers and hence may help to prolong the lifetime of cathode materials. In some designs, one or more of these additive compounds (e.g., DTD) may be effective as a CEI-former in Ni-based cathode materials including LNO, L₂NO supplement (additive), NCA, NCM, NCMA materials.

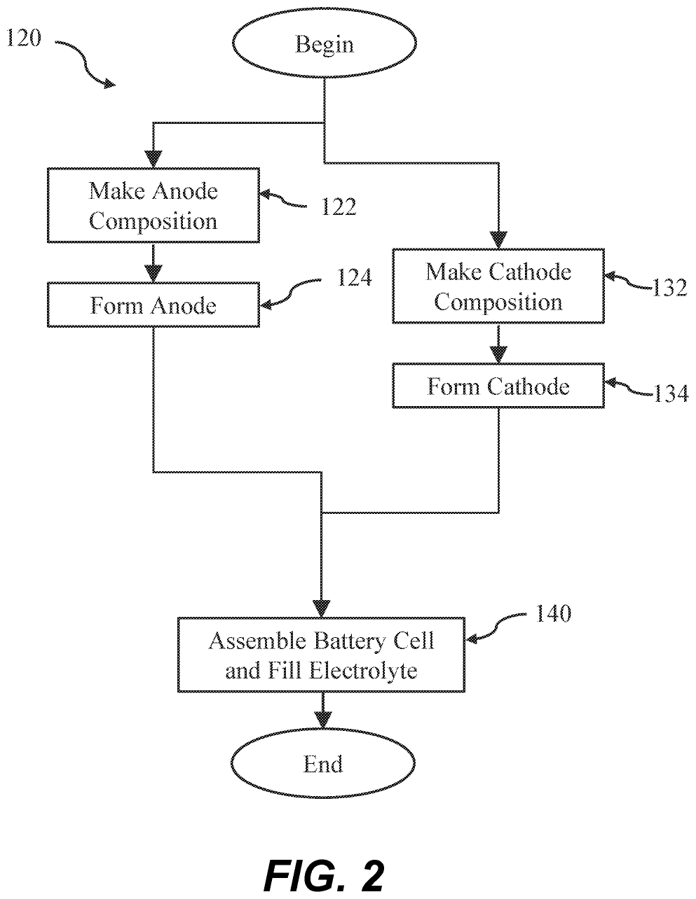

FIG. 2 shows a flow diagram of a process 120 for making a Li-ion battery, such as the example battery 100 of FIG. 1. In the example shown, process 120 includes operations 122, 124, 132, 134, and 140. The flow diagram includes an anode branch (left branch) that includes operations 122 and 124, and a cathode branch (right branch) includes operation 132 and 134. At operation 122, anode particles (e.g., conventional anode particles or core-shell anode particles or composite anode particles, including but not limited to Si-comprising composite particles whereby Si-comprising active material is deposited within pore(s) of a particle core) are made, and at operation 124, an anode is formed. Similarly, at operation 132, suitable cathode particles (e.g., suitable conventional intercalation-type cathode particles or core-shell cathode particles or composite cathode particles, including but not limited to conversion-type cathode material—comprising composite particles whereby conversion-type cathode material active material is deposited within pore(s) of a particle core) are made, and at operation 134, a cathode is formed.

Electrodes utilized in Li-ion batteries are typically produced by (i) formation of a slurry comprising active materials, conductive additives, binder solutions and, in some cases, surfactant or other functional additives; (ii) casting the slurry onto a metal foil (e.g., Cu or Cu-alloy foil for most anodes and Al or Al-alloy foil for most cathodes); and (iii) drying the casted electrodes to completely evaporate the solvent. Note that a metal mesh, metal foam or very rough metal foil (e.g., comprising metal nanowires or metal nanosheets on its surface) may be used as a current collector in some designs (e.g., for higher areal capacity loadings or for achieving faster charge, etc.). Also note that a metal coated thin polymer sheets may also be used as a current collector in some designs (e.g., to achieve improved safety or lower current collector weight, etc.). Also note that a porous metal foil or composite (e.g., nanocomposite) metal foils may be used as a current collector in some designs (e.g., for improved properties, lower weight, etc.).

Operation 124 includes making an anode electrode, with the anode electrode including the anode particles made at operation 122. For example, this operation 124 may include (1) making an anode slurry that includes the anode particles (e.g., from operation 122) and other anode slurry components and (2) casting the anode slurry on an anode current collector (e.g., copper foil or copper-alloy foil current collector). For example, other anode slurry components may include: other electrochemically-active anode active materials (e.g., natural or synthetic graphite, soft carbon or hard carbon), electrically conductive additives (e.g., carbon nanotubes or carbon black or branched carbon or carbon nanofibers or graphite flakes or exfoliated graphite or graphene or graphene oxide or soft graphite or their various combinations, to name a few), binders (e.g., polymer binders), and solvents (e.g., water or a suitable organic solvent).

Operation 134 includes making a cathode electrode, with the cathode electrode including the cathode particles made at operation 132. For example, this operation 134 may include (1) making a cathode slurry that includes the cathode particles (e.g., from operation 132) and other cathode slurry components and (2) casting the cathode slurry on a cathode current collector (e.g., aluminum foil or aluminum-alloy foil current collector). For example, other cathode slurry components may include: other electrochemically-active cathode active materials, electrically conductive additives (e.g., carbon nanotubes or carbon black or branched carbon or carbon nanofibers or graphite flakes or graphene or graphene oxide or soft graphite or their various combinations, to name a few), binders (e.g., polymer binders), and solvents (e.g., water or a suitable organic solvent).

In the foregoing operation 124 (e.g., making anode slurry) or operation 134 (e.g., making cathode slurry), it may be preferable to reduce the occurrence of slurry gelation. In some implementations, gelation of a slurry may occur during cathode slurry preparation. Due to the high concentration of lithium in the desired supplemental (additive) cathode active materials, the compounds in these supplemental cathode active materials may exhibit a tendency to react with water from the atmosphere to form LiOH. In some cases, the high alkalinity of LiOH causes reactions with some polymers (e.g., polyvinylidene fluoride) used as binders in a lithium ion battery cathode, resulting in gelation. In order to neutralize the alkaline LiOH, a small amount of acid can be added directly to the cathode slurry in order to reduce or prevent gelation of the polymer. In some designs, a mass ratio of ˜1:100 of added acid:supplemental cathode active material has been shown to effectively prevent gelation of the slurry at temperatures of up to 60° C. for over 3 hours. In some implementations, the required mass ratio of added acid to supplemental cathode active material may be in a range of about 0.1:100 to about 0.5:100, or in a range of about 0.5:100 to about 1.0:100, or in a range of about 1.0:100 to about 1.5:100. In some designs, solid acids (e.g., solid near room temperatures) such as citric acid, acetic acid, phosphoric acid or others may be used to prevent gelation.

At operation 140, the Li-ion rechargeable battery cell is assembled from at least the anode electrode and the cathode electrode with an electrolyte interposed between the anode electrode and the cathode electrode. The electrolyte provides ionic conduction between the anode and the cathode. The electrolyte ionically couples the anode and the cathode. The electrolyte may comprise a liquid electrolyte or a solid electrolyte (or a mixture of liquid and solid electrolyte) at battery operating temperatures (e.g., in some designs, the solid electrolyte may be molten or semi-molten during melt-infiltration and may subsequently solidify). In some implementations, e.g., implementations in which a liquid electrolyte is used, a separator may be used to maintain a space between the anode and the cathode electrodes.

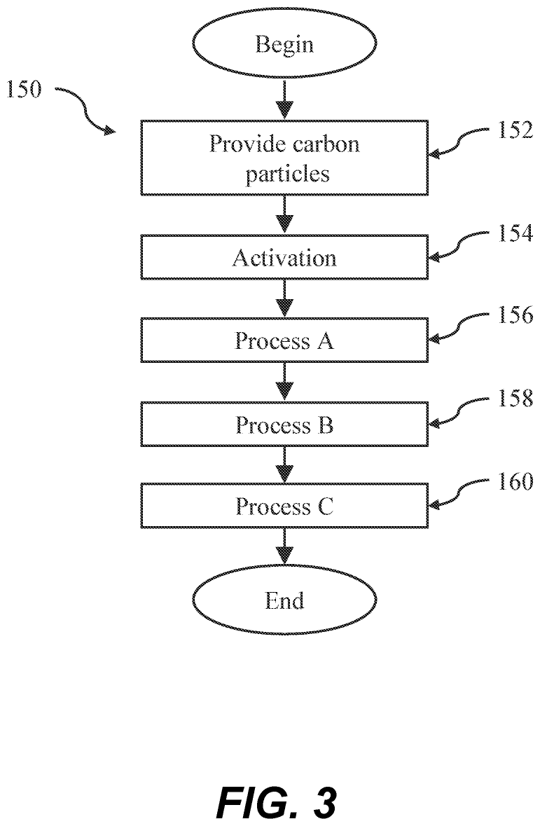

FIG. 3 is a flow diagram of a process 150 of making anode particles and illustrates operation 122 in greater detail. Process 150 includes operations 152, 154, 156, 158, and 160. In some designs, the processes and systems as described herein may be particularly useful when implemented as part of operation 122 and/or operation 132. In some implementations, electrode particles are made using porous carbon or porous carbon-containing particles, with nanostructured or nano-sized active material particles (e.g., with average diameter or linear dimensions in the range from about 1 nm to about 200 nm (in some designs, from about 1 nm to about 10 nm; in other designs, from about 10 nm to about 30 nm; in yet other designs, from about 30 nm to about 100 nm; in yet other designs, from about 100 nm to about 200 nm), as measured using image analysis of electron microscopy (e.g., transmission electron microscopy (TEM), scanning transmission electron microscopy (STEM), scanning electron microscopy (SEM)), X-ray microscopy, X-ray diffraction, neutron scattering and other suitable techniques) being formed in the pores of the porous carbon or porous carbon-containing particles. In the case of anode particles for use in Li-ion batteries, the active material particles may be silicon-comprising particles.

At operation 152, porous carbon particles are provided. In some designs, porous carbon particles may be obtained from pyrolysis or carbonization (e.g., by heat treatment or hydrothermal treatment) of suitable precursor particles, such as organic precursor particles (e.g., polymer particles or biomass-derived particles). In some designs, carbon particles may be obtained from carbon-comprising metalorganic precursor particles or carbon-containing organometallic precursor particles. In some designs, porous carbon particles may be obtained from carbon-comprising inorganic precursor particles (e.g., carbides or oxy-carbides, etc.). In some designs, porous carbon particles may be obtained from various mixtures of two or more of the following: organic precursor(s), metalorganic precursor(s), organometallic precursor(s), carbon-containing inorganic precursor(s), and other carbon particles.

In some designs, inorganic templates (including, but not limited to various oxides or hydroxides or oxyhydroxides of various metals and semi-metals—e.g., Zn, Mg, Si, Al, Ti, Ca, Mg, Sc, etc. and their various combinations) or soft (organic) templates may be used for the formation of porous carbon particles.

In some designs, other known methods may be used for the formation of porous carbon particles.

In some designs, it may be preferable that the porosity of the carbon or carbon-containing particles (e.g., specific surface area and specific pore volume) be quite high before the formation of the nanostructured or nano-sized active material particles therein. In some implementations, it is preferable that the carbon or carbon-containing particles exhibit a Brunauer-Emmett-Teller (BET) specific surface area (SSA) (e.g., obtained from the data of nitrogen sorption-desorption at cryogenic temperatures, such as about 77K) of about 500 m²/g or more, before formation of the active material particles therein. In some implementations, it is preferable that the carbon particles exhibit a BET specific surface area in a range of about 500 m²/g to about 4500 m²/g or about 4800 m²/g (in some designs, from around 500 to about 1000 m²/g; in other designs, from around 1000 to about 2000 m²/g; in other designs, from around 2000 to about 3000 m²/g; in other designs, from around 3000 to about 3800 m²/g; in yet other designs, from around 3800 to about 4800 m²/g), before formation of the active material particles therein. In some implementations, it is preferable that the carbon particles exhibit a total micro- and meso-pore volume (not counting macropores, above about 50 nm) in a range of about 0.5 cc/g to about 5 cc/g (in some designs, from around 0.5 to about 1 cc/g; in other designs, from around 1 to about 2 cc/g; in other designs, from around 2 to about 3.5 cc/g; in other designs, from around 3.5 to about 5 cc/g), before formation (e.g., deposition) of the active material particles therein. In some designs, such high surface areas may be obtained by carrying out physical or chemical activation of carbon or carbon-containing precursor particles, or by rapid annealing of carbon or carbon-containing precursor particles or by using temporary template materials or by other known suitable means. In some cases, the precursor particles themselves may be highly porous (e.g., aerogel particles, among others). Nevertheless, in some designs, it may be preferable to produce or enhance porosity in carbon or carbon precursor particles (e.g., by carrying out activation on the carbon or carbon-containing particles or by leaching out non-carbon components of carbon-containing particles) before formation of the active material particles therein to tune the porosity characteristics. Accordingly, operation 154 includes carrying out a porosity enhancing (e.g., an activation) process on the carbon particles (e.g., from operation 152).

After the activation operation (operation 154), other process operations, such as process A at operation 156, process B at operation 158, and process C at operation 160, are carried out. In the example shown, there are three process operations after porosity enhancing (e.g., an activation) process (operation 154), but in other implementations there may be less than or more than three process operations after activation. For illustration, process 150 is described with respect to the formation of certain electrode (e.g., anode) particles. The concepts of process 150 including porosity enhancing (e.g., an activation) of carbon particles may be applied to other anode particles or with cathode particles that require activation of carbon particles.

In the example illustrated in FIG. 3, nanostructured or nano-sized silicon (Si) or silicon oxide (SiOₓ) or silicon nitride (SiN_{y}) or silicon oxy-nitride (SiOₓN_{y}) or silicon phosphide (SiP_{z}) particles (0<x<2; 0<y<1.3; 0<z<1) or their various combinations, alloys and/or mixtures are formed within the pores (and/or on the surface) of porous carbon or porous carbon-containing particles. For example, process A (operation 156) includes the formation of silicon-based active material particles at least in some of the pores of the porous carbon particles. The formation (e.g., by deposition or infiltration or deposition/infiltration of a Si-comprising precursor with the subsequent conversion to the final Si or Si-based material) of silicon-based active material particles in the porous carbon particles may be accomplished by solution-based or vapor-based deposition processes, in some examples, or by other suitable means. For brevity, the particles upon completion of process A are sometimes referred to as silicon-carbon composite particles (with an understanding that elements other than Si and C may be present within such composite particles in some designs). In some embodiments, such composite particles comprise nano-sized or nanostructured elements (e.g., nano-sized or nanostructured Si, nano-sized or nanostructured C) and may be referred to as nanocomposite particles. In some implementations, the Si or Si-comprising material present in such nanocomposites may be in the form of nanoparticles. In some implementations, the mass-average size of Si or Si-comprising material nanoparticles may range from about 1 nm to about 200 nm (in some designs, from about 1 nm to about 10 nm; in other designs, from about 10 nm to about 30 nm; in yet other designs, from about 30 nm to about 100 nm; in yet other designs, from about 100 nm to about 200 nm), as measured using image analysis of electron microscopy (e.g., transmission electron microscopy (TEM), scanning transmission electron microscopy (STEM), scanning electron microscopy (SEM)), X-ray microscopy, X-ray diffraction, neutron scattering and other suitable techniques.

In the example shown, process B is carried out at operation 158. For example, process B includes the formation of a protective coating on and in the silicon-carbon composite particles (from operation 156). In some designs, the suitable average thickness of the protective coating may range from about 0.2 nm to about 50 nm (in some designs, from about 0.2 nm to about 2 nm; in other designs, from about 2 nm to about 5 nm; in other designs, from about 5 nm to about 10 nm; in yet other designs, from about 10 nm to about 50 nm). In some designs, the true density of the protective coating may range from about 0.8 g/cc to about 4.8 g/cc or about 5.8 g/cc (in some designs, from about 0.8 g/cc to about 1.6 g/cc; in other designs, from about 1.6 g/cc to about 3 g/cc; in other designs, from about 3 g/cc to about 4.5 g/cc; in yet other designs, from about 4.5 g/cc to about 4.8 g/cc or about 5.8 g/cc).

In some designs, the protective coating may comprise or be based on electronically conductive material such as carbon. In some designs, such a carbon coating may be doped (e.g., with B, P, N, O, S and/or other elements). In some designs, the atomic fraction of individual dopants may range from about 0.01 at. % to about 10.01 at. % (in some designs, from about 0.01 at. % to about 0.1 at. %; in other designs, from about 0.1 at. % to about 1 at. %; in other designs, from about 1 at. % to about 5 at. %; in yet other designs, from about 5 at. % to about 10.01 at. %). In some designs, the protective coating may be largely impermeable to electrolyte solvent.

During operation of a Li-ion battery cell (e.g., 100 in FIG. 1), the protective coating may reduce or prevent direct contact between the silicon nanoparticles and an electrolyte solvent composition. In some designs, direct contact between the electrolyte solvent composition and the silicon nanoparticles may undesirably accelerate degradation of the Li-ion battery cell.

In the example shown, process C is carried out at operation 160. For example, process C includes making changes to the particle size distribution (PSD). Process C may include carrying out comminution on the protected silicon-carbon composite particles (from operation 158). Comminution may be carried out when the particle sizes are larger (on average) than a final desired (e.g., for a slurry and electrode processing) particle size distribution. Various processes of carrying out comminution are known in the art. For example, the comminution may be carried out by one or more of: ball milling, jet milling, attrition milling, pin milling, and/or hammer milling. In some implementations, it may be preferable to carry out particle size selection during process operation C. In some cases, process C may include particle size selection in addition to comminution (e.g., particle size selection after comminution). In some cases, process C may include particle size selection without comminution. For example, it may be preferable to retain some of the larger particle sizes and discard the finer particle sizes. The particle size selection may be carried out by any one of suitable processes known to those skilled in the art, such as screening, sieving, and/or aerodynamic size classification.

The foregoing process operation C 160) includes examples, such as comminution and particle size selection, of making changes to a particle size distribution (PSD) of a population of particles. In some cases, it may be preferable to employ additional or alternative processes for changing or adjusting a PSD, such as mixing two or more populations of particles wherein each of the populations has a PSD different from others of the populations. For example, particle populations of different PSDs may be obtained (e.g., obtained from a supplier or made to different PSDs including employing the aforementioned processes of comminution and/or particle size selection under different processing conditions).

The particle size distribution (PSD) that characterizes a particle population may be determined by laser particle size distribution analysis (LPSA), image analysis of electron microscopy images, or other suitable techniques. The particle size distribution (PSD) may be determined by laser particle size distribution analysis (LPSA) on well-dispersed particle suspensions in one example. Note that other types of particle size distribution (e.g., by SEM image analysis) could also be utilized (and may even lead to more precise measurements, in some experiments). While there are diverse processes of measuring PSDs, laser particle size distribution analysis (LPSA) is quite efficient for some applications. Using LPSA, particle size parameters of a population's PSD may be measured, such as: a tenth-percentile volume-weighted particle size parameter (e.g., abbreviated as D₁₀), a fiftieth-percentile volume-weighted particle size parameter (e.g., abbreviated as D₅₀), a ninetieth-percentile volume-weighted particle size parameter (e.g., abbreviated as D₉₀), and a ninety-ninth-percentile volume-weighted particle size parameter (e.g., abbreviated as D₉₉). Additionally, parameters relating to characteristic widths of the PSD may be derived from these particle size parameters, such as D₅₀-D₁₀ (sometimes referred to herein as a left width), D₉₀-D₅₀ (sometimes referred to herein as a right width), and D₉₀-D₁₀ (sometimes referred to herein as a full width). A cumulative volume fraction, defined as a cumulative volume of the composite particles with particle sizes of a threshold particle size or less, divided by a total volume of all of the composite particles, may be estimated by LPSA. In some embodiments, a fiftieth-percentile volume-weighted particle size parameter (D₅₀) of the PSD is in a range of about 2.0 μm to about 16.0 μm, or in a range of about 2.0 to about 4.0 μm, or in a range of about 4.0 to about 6.0 μm, or in a range of about 6.0 to about 8.0 μm or in a range of about 8.0 to about 16.0 μm.

Upon completion of the operations in process 150 (e.g., operations 152, 154, 156, 158, 160), the composite particles may be characterized by a Brunauer-Emmett-Teller (BET) specific surface area (SSA) (e.g., obtained from the data of nitrogen sorption-desorption at cryogenic temperatures, such as about 77K). In some embodiments, the BET-SSA of the composite particles is in a range of about 1 m²/g to about 50 m²/g (in some designs, from about 1 to about 3 m²/g; in other designs, from about 3 m²/g to about 12 m²/g; in yet other designs, from about 12 m²/g to about 18 m²/g; in yet other designs, from about 18 m²/g to about 30 m²/g; in yet other designs, from about 30 m²/g to about 50 m²/g).

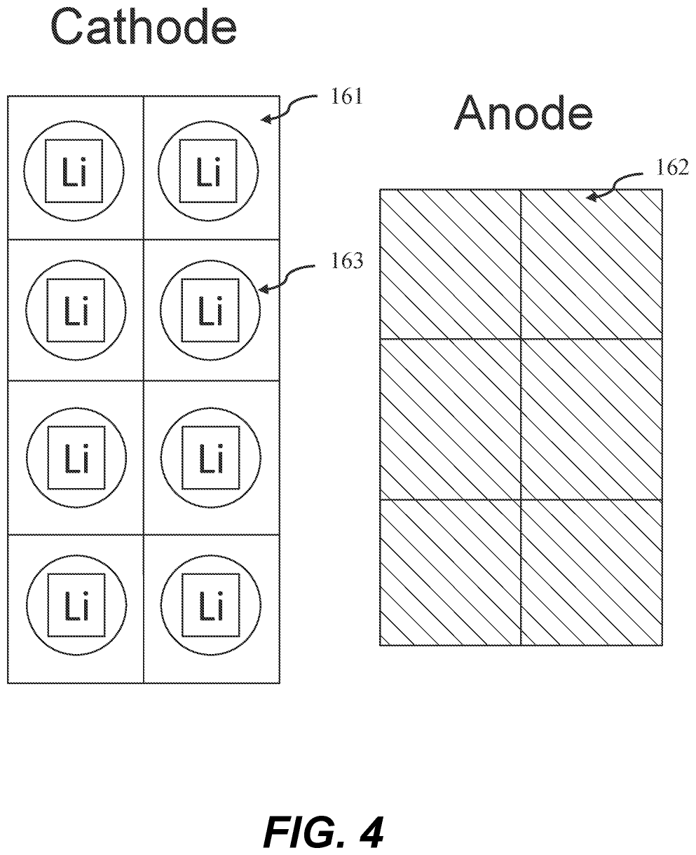

FIG. 4 shows a schematic of a lithium-ion battery highlighting the cathode (161) and anode (162) active materials, where boxes (white on cathode-side and filled with a hatching pattern on anode side) denote sites where lithium atoms can occupy, and circles (163) denote lithium atoms. In this schematic representation, the cathode has 8 sites available for lithium occupancy, which are all filled when the battery is assembled. The anode, denoted by a hatched box, in this schematic has been sized such that the anode sites are equal to the number of lithium atoms in the system minus the loss which occurs on the anode. This sizing allows for the minimal amount of anode to be used, thereby minimizing the volume and mass of the battery, and maximizing the volumetric energy density. It is well understood that the size of the anode, which is typically measured by the mass of anode active materials per unit area or by the capacity of the anode material per unit area, is determined by this relationship. In a real battery, however, the number of anode sites may be designed to be slightly higher than the number of free lithium atoms, in order to avoid the anode potential from reaching values which promote lithium plating, which is a safety hazard. As such, the so-called N/P ratio of higher than 1 may be employed.

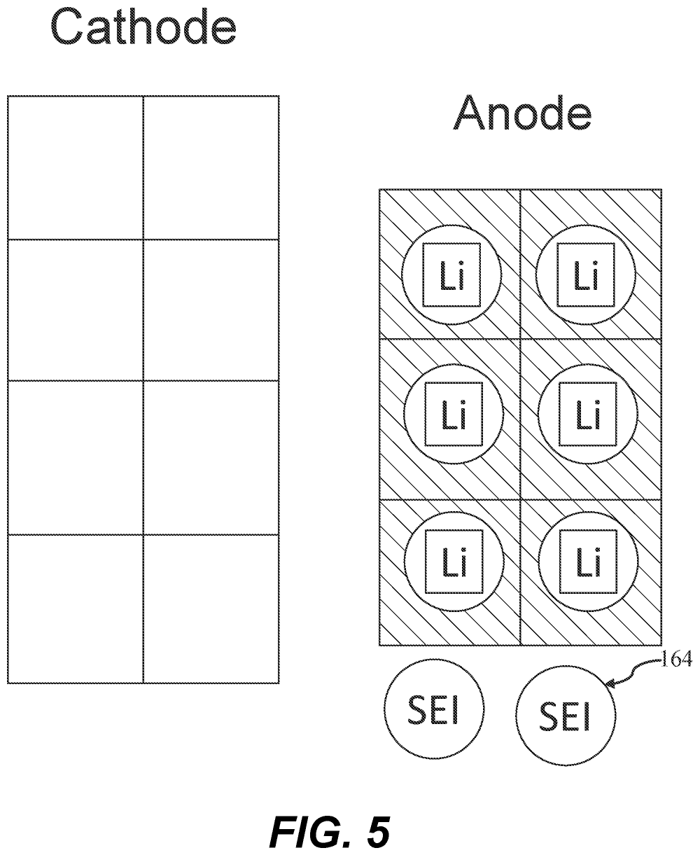

FIG. 5 illustrates how lithium atoms are transferred during the first charge of a lithium-ion battery. Most of the lithium found in the cathode is transferred to the anode sites, while some fraction (in this fictional case, 25%) of lithium atoms are consumed in a chemical reaction which forms a passivating protective layer on the surface of the anode. This protective layer is known as the solid electrolyte interphase (SEI) and lithium atoms in this phase are labeled in FIG. 5 (164).

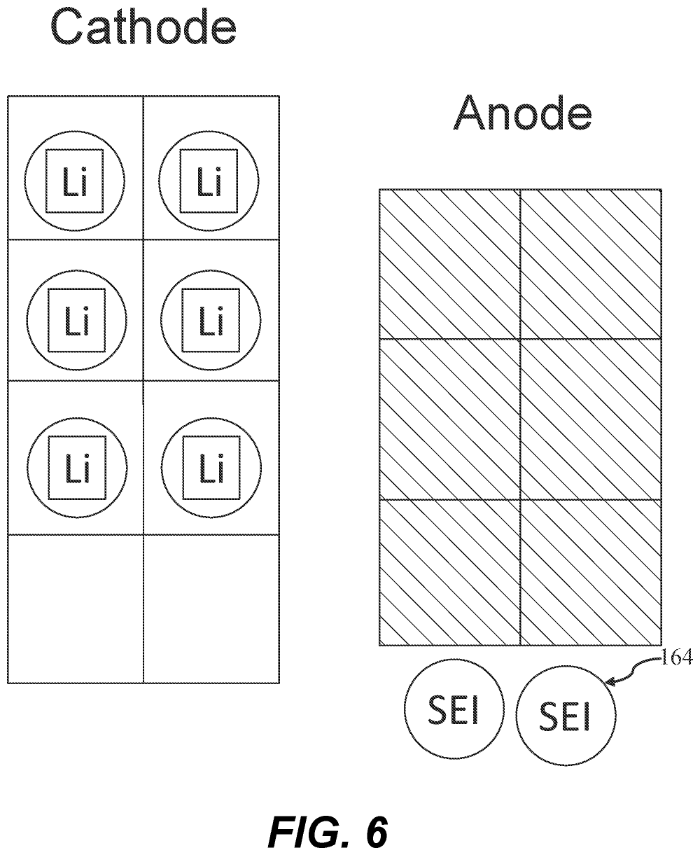

FIG. 6 shows the state of lithium atoms after one complete charge-discharge cycle (also known as the formation cycle, as it “forms” SEI on the anode and cathode solid electrolyte interphase (CEI) on the cathode). Note that sometimes two or more full or particle charge-discharge cycles may be employed for the SEI/CEI formation. After the formation cycle, because of losses to the SEI, the fraction of occupied sites in the cathode is less than 1. Due to the proportional relationship between active material amount and lithium losses (i.e. the losses on the first cycle are a fraction of the total lithium in the system), the occupied cathode sites at the end of discharge will remain smaller than 1, regardless of the mass per unit area (or capacity per unit area) of the cathode. This result will change only if the fractional loss of lithium to SEI formation is smaller, if the cathode loses available lithium sites, or additional lithium inventory is added to the system.

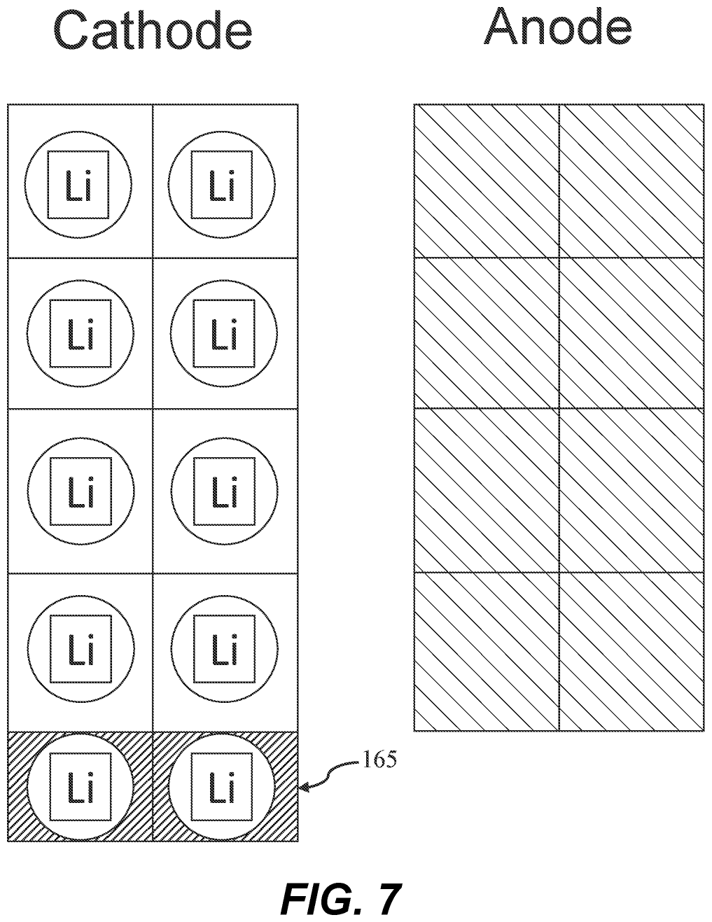

FIGS. 4, 5, and 6 schematically illustrate a battery in which the cathode comprises a primary cathode active material (represented by white boxes) and does not comprise any supplemental cathode active material. FIG. 7 illustrates the same series of charge-discharge steps as shown in FIG. 4 to FIG. 6, except with a supplemental cathode active material (165) added to the system. Herein, the supplemental (additive) cathode active material is sometimes referred to as a cathode lithium supplement. Herein, the primary cathode active material is sometimes referred to as a primary cathode material. In this schematic diagram, the cathode lithium supplement has a higher concentration of lithium than the cathode primary material. Therefore, the volume per unit site is smaller than the primary cathode material. Schematically, this is indicated by smaller boxes, patterned in a heavy hatching, present on the cathode side. In some designs, a higher concentration of lithium is desired in order to reduce or minimize the extra mass and volume contributed by the lithium supplement to the battery. In this schematic diagram, the amount of lithium supplement added to the cathode is designed to increase or maximize the amount of lithium in the primary cathode material at the end of discharge. A critical difference of FIG. 7 compared to FIG. 4 is that the size of the anode has been increased, in order to accommodate the extra lithium added to the system. If the anode size was not increased, the anode would not be able to accommodate the extra lithium, and lithium metal would begin to form on the surface of the anode. Lithium metal plating is a significant safety hazard, so it may be preferable to choose the size of the anode such that the number of lithium ions in the battery system does not exceed the number of available anode sites. This simple schematic illustrates how the energy density improvements with a lithium supplement are related to the per mass or per volume lithium capacity of the anode. If the anode has a low capacity, the (gravimetric or volumetric) size of the anode must increase significantly as more lithium inventory is added to the system, in order to avoid lithium plating. Conversely, if the anode has a high capacity (e.g., as in Si-comprising anodes, such as Si—C nanocomposite-comprising anodes, among others), then the size of the anode will increase less, leading to higher energy density. In this way there is a synergistic effect between an anode with high capacity, and lithium-ion batteries which incorporate the lithium supplement.

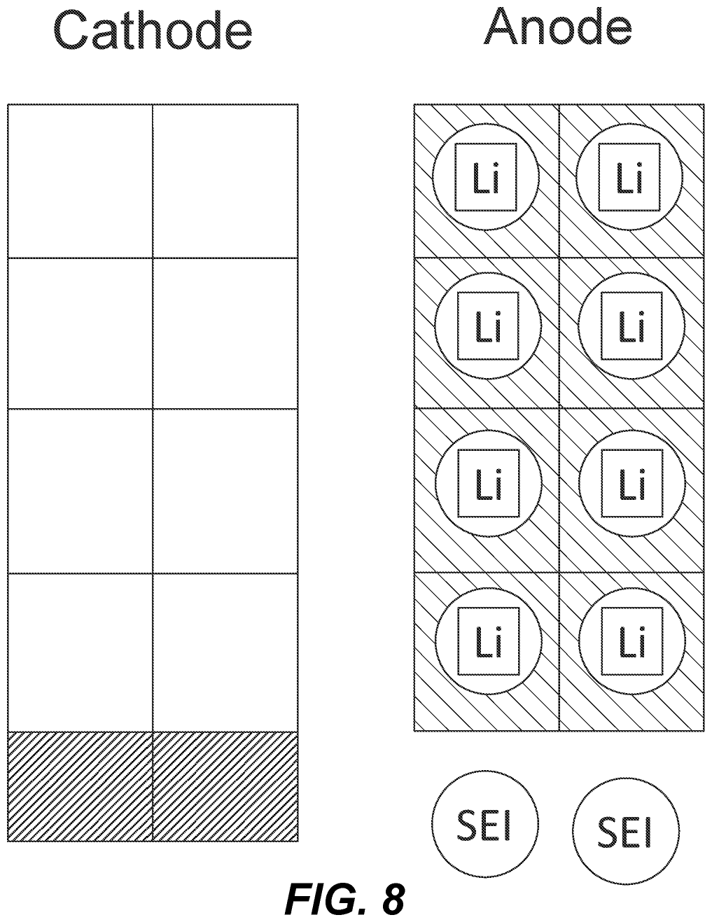

FIG. 8 demonstrates the same lithium motion as FIG. 5, except noting that the total amount of lithium in the system has increased. For simplicity, this schematic displays the same absolute lithium loss to the SEI as previously shown in FIG. 5. In a real lithium-ion battery, the loss of lithium to the SEI may increase slightly, due to the increased surface area of anode, due to the increased mass of anode active material and/or other factors.

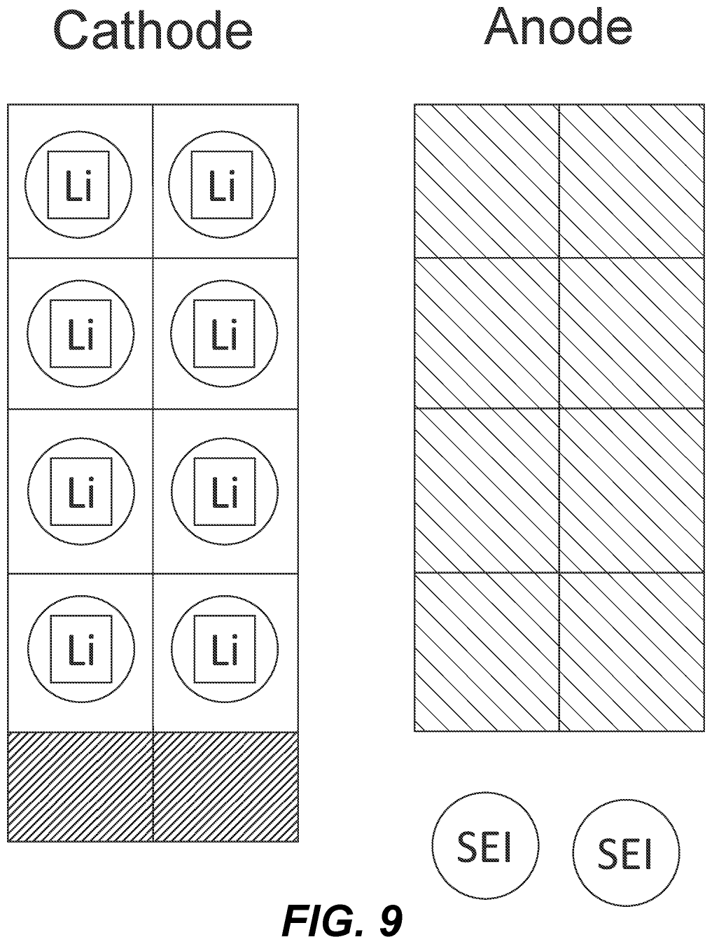

FIG. 9 shows a schematic of a lithium-ion battery containing a lithium supplement after one complete charge-discharge cycle. This diagram highlights the complete filling of sites on the cathode primary active material due to the addition of additional lithium inventory from the suitable lithium supplement. In this simplification, the supplement has no reversible capacity (i.e. no available sites for lithium insertion) after the lithium is initially extracted. When a realistic lithium supplement material (supplemental cathode active material) exhibiting some reversible capacity, is incorporated into a cathode of a battery and the battery undergoes cycling, the lithium supplement material would be present in a partially (or close to fully) delithiated state after the cycling. In a practical system, the suitable cathode supplement may have some reversible capacity with no adverse effect, so long as the lithium chemical potential of the supplement is similar to the chemical potential of the cathode primary material. In this simplified diagram, the cathode has a 100% first-cycle coulombic efficiency (FCE). The first-cycle coulombic efficiency (FCE) of an electrode (e.g., anode, cathode) is defined as the change charge inserted (or extracted) to an electrode divided by the charge extracted (or inserted) from the electrode during a complete electrochemical cycle within given voltage limits. Because the direction of charge flow is opposite for cathodes and anodes, the definition is dependent on the electrode. For cathodes, the FCE is defined as the charge extracted (corresponding to Li insertion into the material) divided by the charge inserted (corresponding to Li removal). For an anode the FCE is defined as the charge inserted (Li removal) divided by charge extracted (Li insertion). FCE is measured for both materials by constructing a so-called half-cell, which is an electrochemical cell consisting of a cathode or anode material of interest as the working electrode and a lithium metal foil which functions as both the counter and reference electrode. Then, charge is either inserted or removed from the material of interest until the cell voltage reaches an appropriate limit. Then, the process is reversed until a second voltage limit is reached, and the charge passed in both steps is used to calculate the FCE, as described above. Cathodes with less than 100% FCE would have some lithium sites which become inaccessible after the lithium is first extracted. In other words, the lithium cannot be re-inserted into the material once removed. For overall energy density improvement, the lithium supplement should not add lithium in excess of the number of sites available in the cathode primary material. In order to attain a volumetric energy density (VED) performance improvement, the FCE of the anode is preferably less than the FCE of the primary cathode active material.

In some designs, cathode primary active materials may preferably comprise one or more of the following metals (in addition to Li): Fe, Ni, Mn, and Co.

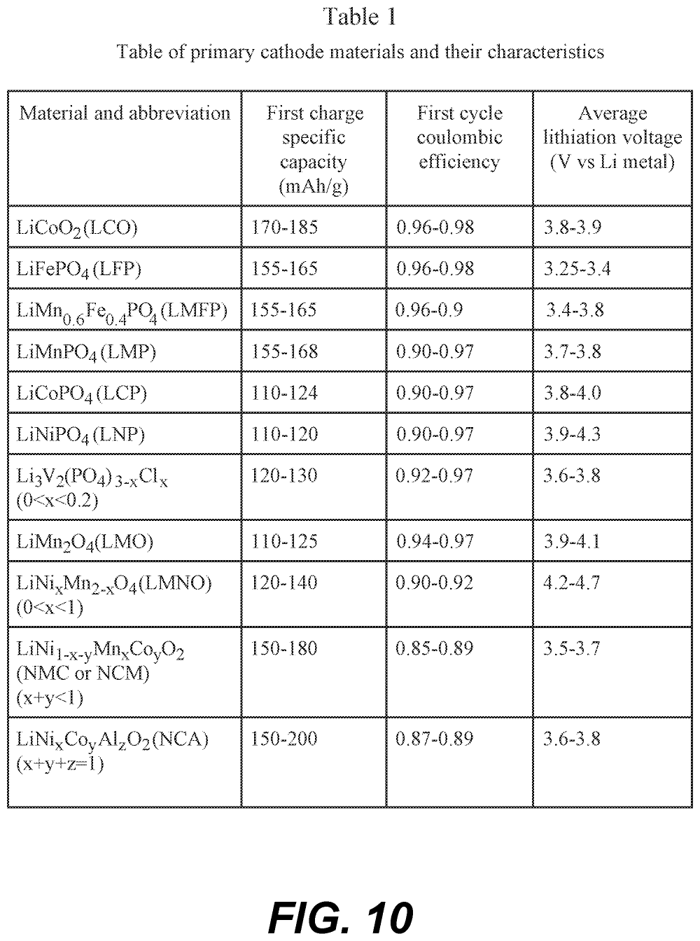

FIG. 10 presents Table 1 of illustrative examples of primary cathode active materials which are commonly used in lithium-ion batteries, and typical values of some of their relevant parameters (first-charge specific capacity, first-cycle coulombic efficiency, and average de-lithiation voltage). As described above, primary cathode active materials with a higher FCE may provide a larger relative improvement in Si-comprising Li-ion batteries in conjunction with a lithium supplement compared to cathodes comprising primary cathode active materials with lower FCE. In some implementations, primary cathode active materials exhibiting FCE values of at least about 85% are preferred. In some implementations, primary cathode active materials exhibiting FCE values of at least about 90% are preferred. In some implementations, primary cathode active materials exhibiting FCE values of at least about 95% are preferred. In some implementations, the primary cathode active material is selected from: lithium cobalt oxide (LCO), lithium iron phosphate (LFP), lithium manganese iron phosphate (LMFP), lithium manganese oxide (LMO), lithium nickel manganese oxide (LMNO) in the form of a high-voltage spinel (e.g., with an operating voltage of about 4.7 V), lithium nickel cobalt manganese aluminum oxide (NCMA), lithium nickel cobalt manganese oxide (NCM), and lithium nickel aluminum oxide (NCA).

In some designs, suitable supplemental cathode additive materials may preferably comprise one or more of the following metals (in addition to Li): Ni, Fe, and V. In some designs, suitable supplemental cathode additive materials may preferably comprise oxygen (O), nitrogen (N) and/or sulfur (S). In some designs, suitable supplemental cathode additive materials may comprise carbon (C).

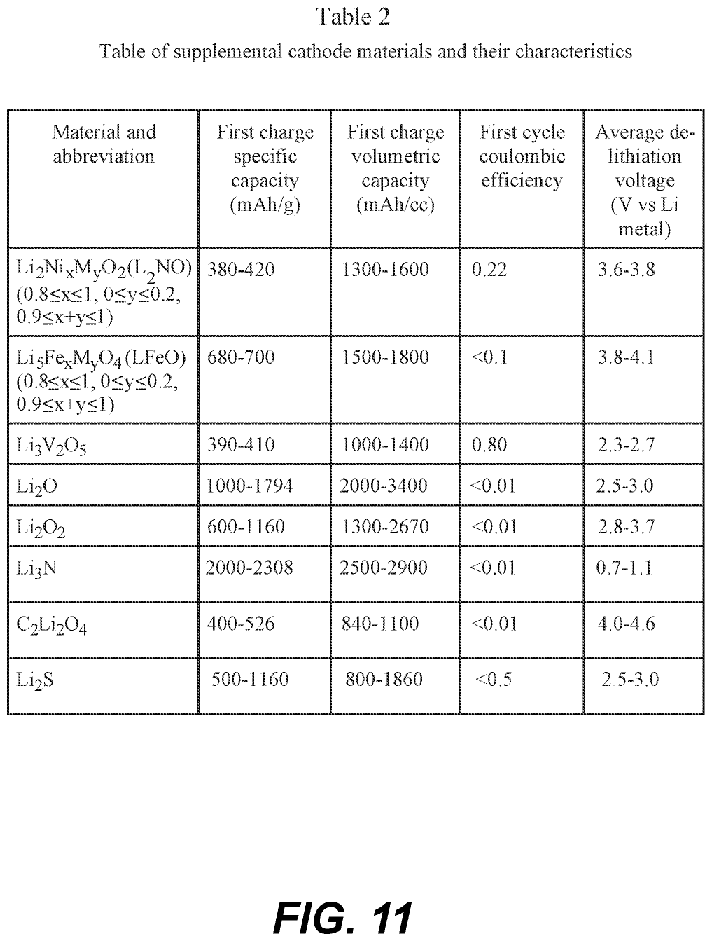

FIG. 11 presents Table 2 with illustrative examples of suitable supplemental cathode additive materials and some of their relevant properties. As described, the use of cathode supplements with higher gravimetric and volumetric capacities may be advantageous, as they will limit the mass and volume of supplemental material in the battery. Table 2 shows materials with first-charge specific capacity values ranging between about 380 mAh/g and about 2308 mAh/g. For use as a supplemental cathode active material, the first-charge specific capacity is preferably at least about 350 mAh/g. In some implementations, the first-charge specific capacity is preferably at least about 450 mAh/g. In some other implementations, the first-charge specific capacity is preferably at least about 550 mAh/g. In yet other implementations, the first-charge specific capacity is preferably at least about 650 mAh/g. In yet other implementations, the first-charge specific capacity is preferably at least about 750 mAh/g. The supplemental cathode active materials listed in Table 2 exhibit first-cycle coulombic efficiency (FCE) values that are quite low, such as less than about 30%. In some implementations, the FCE values of supplemental cathode active materials are preferably at most about 30%; in some other implementations, preferably at most about 20%; in yet other implementations, preferably at most about 10%; and in yet other implementations, preferably at most about 5%.

In particular, the example compounds Li₂Ni₁₋ₓMₓO₂, Li₂NiO_{2-y}F_{y}, and Li₂Ni₁₋ₓMₓO_{2-y}F_{y} (collectively referred to as L₂NO) (where x may preferably be in a range of about 0 to about 0.5, and y may preferably be in a range of about 0 to about 0.5) are attractive options for use as a cathode supplemental material due to their high capacities and stability to both ambient air and suitable cathode slurry solvents. In some implementations, x may be in a range from about 0 to about 0.4; in some other implementations, x may be in a range from about 0 to about 0.3; in yet some other implementations, x may be in a range from about 0 to about 0.2; in yet some other implementations, x may be in a range from about 0 to about 0.15; in yet some other implementations, x may be in a range from about 0 to about 0.1. In some implementations, y may be in a range from about 0.0 to about 0.4; in some other implementations, y may be in a range from about 0.0 to about 0.3; in yet some other implementations, y may be in a range from about 0.0 to about 0.2; in yet some other implementations, y may be in a range from about 0.0 to about 0.1. Here M represents a metal dopant (or mixed metal dopant) comprising, but not limited to, one or more of the following elements: copper (Cu), iron (Fe), magnesium (Mg), manganese (Mn), zinc (Zn), and cobalt (Co). In some designs, M may (e.g., additionally) comprise one or more of the following or other elements: niobium (Nb), molybdenum (Mo), aluminum (Al), titanium (Ti), tantalum (Ta), silicon (Si), antimony (Sb), tungsten (W), zirconium (Zr), among others. In some designs, these additional elements (e.g., Nb, Mo, Al, Ti, Ta, Si, Sb, W, Zr, etc.) may comprise about 0.001-2.00 at. % (e.g., about 0.001-0.05 at. % or about 0.05-0.1 at. % or about 0.1-0.25 at. % or about 0.25-0.5 at. % or about 0.5-1 at. % or about 1-2 at. %) relative to the at. % of Ni in the suitable cathode supplement. In some designs, up to about 2-20 at. % of Li in L₂NO may be substituted by one or more of the following elements: sodium (Na), magnesium (Mg). It may be particularly preferable to select an L₂NO composition, where little or no non-Li atoms (e.g., about 0-5 at. %, relative to all Li substitute atoms) are extracted during the first charge when used in a battery cell.

In particular, the example compound Li₅FeO₄ and its doped variants (collectively referred to as LFeO) are attractive options for use as a cathode supplemental material due to their high capacities and the abundance of the transition metal Fe. Here M represents a metal dopant (or mixed metal dopant) including, but not limited to one, two or more of the following elements: Mo, Al, Ni, V, Mn, Nb, and Co. Li₅FeO₄ crystallizes in an orthorhombic structure where Li¹⁺ (ionic radius of about 0.59 Å) and Fe³⁺ (ionic radius of about 0.48 Å) occupy tetrahedral positions. Potentially suitable dopants for Fe³⁺ in the tetrahedral sites include Mo³⁺ with an ionic radius of about 0.69 Å and Al³⁺ with ionic radius of about 0.39 Å. Other possible dopants may include Ni³⁺, V³⁺, Mn³⁺, Nb³⁺, and Co³⁺, although these cations prefer octahedral coordination in oxide lattices. A partial substitutions of these ions (e.g., the metal dopant M is one or more of Mo³⁺, Al³⁺, Ni³⁺, V³⁺, Mn³⁺, Nb³⁺, or Co³⁺) for Fe³⁺ may result in the formation of phases with compositions of Li₅Fe₁₋ₓMₓO₄, where x may be in a range from about 0 to about 0.5 (e.g., in a range from about 0 to about 0.1, in a range from about 0.1 to about 0.2, in a range from about 0.2 to about 0.3, in a range from about 0.3 to about 0.4, in a range from about 0.4 to about 0.5). The O²⁻ anion with an ionic radius of 1.40 Å can be partially replaced with F¹⁻ with an ionic radius of 1.33 Å. The partial substitution of F¹⁻ for O²⁻ may result in the formation of phases with compositions of Li₅FeO_{4-y}F_{y}, where y may be in a range from about 0 to about 0.5 (e.g., in a range from about 0 to about 0.1, in a range from about 0.1 to about 0.2, in a range from about 0.2 to about 0.3, in a range from about 0.3 to about 0.4, in a range from about 0.4 to about 0.5). Carrying out a combined partial substitutions of Fe³⁺ and O²⁻ may result in phases with compositions of Li₅Fe₁₋ₓMₓO_{4-y}F_{y}, where x may be in a range from about 0 to about 0.5 (e.g., in a range from about 0 to about 0.1, in a range from about 0 to about 0.2, in a range from about 0 to about 0.3, in a range from about 0 to about 0.4), and y may be in a range from about 0 to about 0.5 (e.g., in a range from about 0 to about 0.1, in a range from about 0 to about 0.2, in a range from about 0 to about 0.3, in a range from about 0 to about 0.4, in a range from about 0.4 to about 0.5). Such doped compositions (Li₅Fe₁₋ₓMₓO₄, Li₅FeO_{4-y}F_{y}, Li₅Fe₁₋ₓMₓO_{4-y}F_{y}) may exhibit better stability (e.g., stability in air) and better electrochemical performance than undoped LFCO as a supplemental cathode active material. In some designs, up to about 2-20 at. % of Li in LFeO may be substituted by one or more of the following elements: sodium (Na), magnesium (Mg). It may be particularly preferable to select an LFeO composition, where little or no non-Li atoms (e.g., about 0-5 at. %) are extracted during the first charge when used in a battery cell.

In some embodiments, the supplemental cathode material has a fiftieth-percentile volume-weighted particle size parameter (D₅₀) of the PSD is in a range of about 0.3 μm to about 20.0 μm (e.g., in a range of about 0.3 to about 1.0 μm, or in a range of about 1.0 to about 3.0 μm, or in a range of about 3.0 to about 4.0 μm or in a range of about 4.0 to about 5.0 μm or in a range of about 5.0 to about 8.0 μm or in a range of about 8.0 to about 12.0 μm or in a range of about 12.0 to about 20.0 μm). Too small particles may contribute to excessive side reactions, while too large particles may lead to undesirable cathode capacity and density nonuniformities. The ideal particle size may depend on the cathode chemistry, capacity, thickness, porosity, fraction of lithium supplement additives, their properties and battery cell applications (charging or discharging rate).

In some designs, the application of some of the metal dopants to L₂NO and other supplements may enhance cathode and cell performance, reduce gassing, improve stability of the lithium supplement materials and provide other benefits. In some designs, the application of suitable protective surface coatings (e.g., protective surface coating comprising metal oxide, semimetal oxide, oxynitride, carbon, and/or polymer) to L₂NO (and other supplemental cathode active materials) may enhance cathode and cell performance, reduce gassing, improve stability of the lithium supplement materials during candling and provide other benefits. In some designs, the thickness of such suitable protective surface coatings may range from about 0.2 nm to about 50 nm (in some designs, from about 0.2 nm to about 2 nm; in other designs, from about 2 nm to about 5 nm; in other designs, from about 5 nm to about 10 nm; in yet other designs, from about 10 nm to about 50 nm).

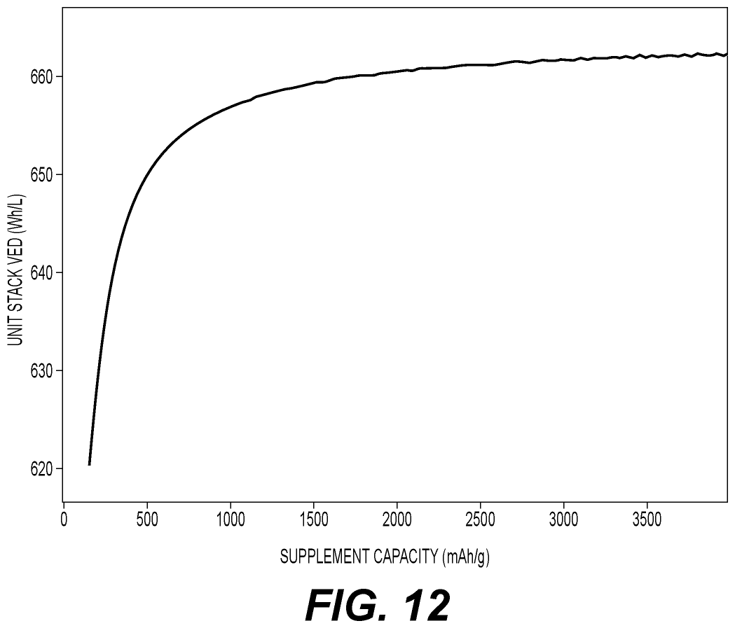

Note that the experimental data described with respect to FIGS. 12-19 of this disclosure utilizes an un-doped and un-coated composition of Li₂NiO₂. These experimental results are indicative of the performance of other material compositions because of the detailed understanding the inventors have gained from a combination of modeling and experiments. Any material which possesses favorable material properties such as high gravimetric and volumetric capacity, will show similar performance as the experimental results shown here. Previous research has discovered many such compounds, as shown in FIG. 11, which are all considered favorable for use as a cathode supplemental material.

FIG. 12 presents modeling data on the Volumetric Energy Density (VED) at the unit stack level for a simulated battery with an illustrative LFP-based cathode, an illustrative blended anode comprising 80 wt. % (relative to all active materials) illustrative Si—C nanocomposite active material blended with 20 wt. % of an illustrative graphite active material, and suitable lithium supplement material mixed with the cathode. In this simulation, the supplement capacity was varied to examine its effect on VED. In these calculations, the VED is calculated by first calculating the energy per unit area of the battery, and then dividing the energy per unit area by the sum of the illustrative anode, cathode, separator, and current collector thicknesses. The thickness of the anode current collector foil, cathode current collector foil, and separator are 10 microns, 15 microns, and 15 microns respectively. Because in a real lithium-ion battery, the anode and cathode electrodes are coated on both sides of a single current collector (so-called double-sided coatings), the thicknesses of the current collectors used in the unit stack VED calculation are divided by 2. The total mass per area of the cathode electrode, including primary cathode material, inactive materials (such as binder and electronically conductive additives), and supplemental cathode material was held constant at 23.5 mg/cm². The cathode electrode density (which also includes both active and inactive components) was set to 2.7 g/cc. The active materials wt. % fraction (which includes mass of primary and supplemental cathode materials) is set to 96 wt. % for LFP type-cathodes. The cell potential used to calculate the energy per unit area is determined by a linear average of the anode active component potentials (with respect to a lithium metal reference). The anode potential for a 80 wt. % Si—C nanocomposite and 20 wt. % graphite is 0.34 V. The cathode potential is fixed at 3.3 V for LFP-type cathodes, regardless of the amount of lithium supplement added. The final average cell voltage is calculated by subtracting the average anode potential from the average cathode potential. The areal capacity is calculated by multiplying the areal capacity of the cathode electrode on first charge (which includes capacity from both primary and supplemental cathode materials) with the minimum FCE of the anode or cathode. This areal capacity calculation is a simplified model of the performance in a real lithium-ion battery, but should be accurate within about 1 to 5%. The FCE of the LFP primary cathode material was set to 97.6%, the anode FCE for 80 wt. % example Si—C nanocomposite was calculated to be 88.9%. The density of the example anode was calculated to be 0.812 g/cc (the density in the fully lithiated state). The active materials wt. % fraction (which includes mass of primary and supplemental cathode materials) in the example anode was set to 89.6 wt. %. In addition, the anode blend (mixture) has a calculated first charge specific capacity of 1398 mAh/g and volumetric capacity of 1135 mAh/cc. The so-called N/P ratio was set to 1.1 for all LFP-type cathode calculations.

For every value of supplement capacity explored, the mass fraction of supplement in the cathode was varied until an optimum VED was found. Then, a different value of supplement capacity was selected and the optimization process repeated. The optimized VED is then reported in FIG. 12. In addition to supplement mass fraction optimization, the calculations take into account the increase in anode mass (i.e. increased anode thickness) as the amount of supplement is added to the system. As is clear from the calculations depicted in FIG. 12, there are steep diminishing returns to VED performance after a supplement capacity above around 1000 mAh/g (assuming the supplement density is the same as the cathode coating, a value of 2.7 g/cc, in these calculations). Furthermore, as the supplement capacity increases, the lithium concentration in the supplement also typically increases. For oxide-based supplements, an increase in lithium concentration may make the supplement material more reactive to other components of the battery, including during manufacturing. As such, in some designs, it may be advantageous to utilize metal oxide supplement with a specific initial delithiation capacity at or below around 1000 mAh/g (in some designs, in the range from about 350 to about 450 mAh/g; in other designs, from about 450 to about 700 mAh/g; in yet other designs, from about 700 to about 1000 mAh/g).

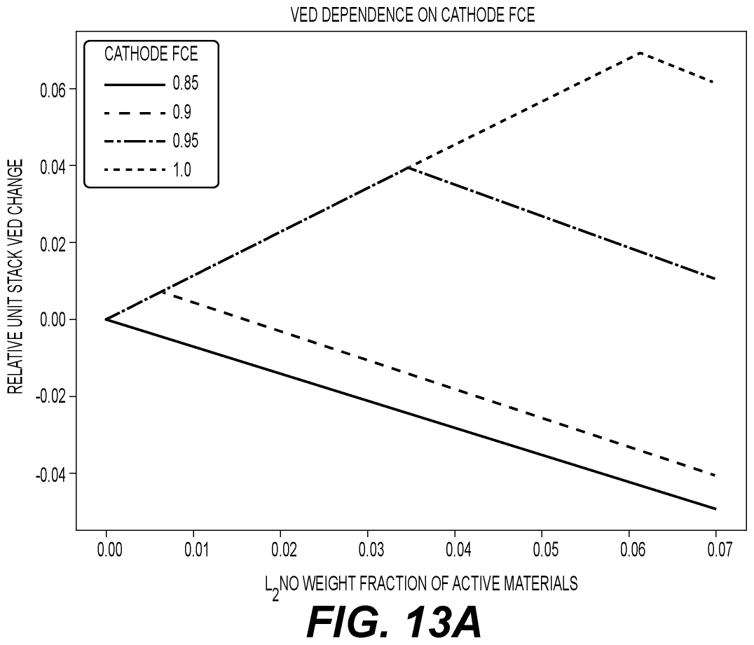

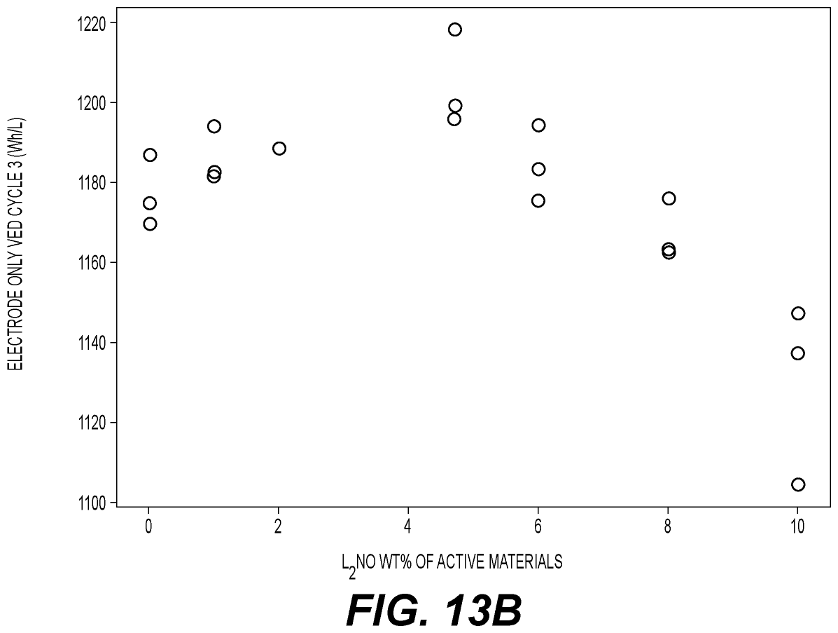

FIG. 13A provides illustrative analysis to show the relationship between the cathode FCE, the L₂NO supplement mass fraction (relative to active materials) in the cathode, and the unit stack VED. In this representation, the unit stack VED is expressed relative to the case with zero added cathode supplement. These illustrative results are computed for a cathode primary active material with a similar gravimetric capacity as LFP of 157 mAh/g, total cathode electrode density of 2.7 g/cc, total mass loading of 23.5 mg/cm², but with a variable FCE. The supplemental cathode active material has a capacity of 400 mAh/g, a FCE of 22%, and a density of 2.7 g/cc. The illustrative anode composition is a silicon-carbon composite blended with 20 wt. % graphite, having first charge specific capacity of 1398 mAh/g and volumetric capacity of 1135 mAh/cc. The N/P ratio is set to 1.1. The anode FCE of this illustrative composition is 88.9%. From this plot, it can be seen that as the supplement wt. % is increased in the cathode, the change in VED is dependent on both the cathode FCE and the supplement wt. %. For cathodes with FCE equal to or below the FCE of the anode, the addition of lithium supplement (not only L₂NO, but also others) into the cathode has a detrimental effect, due to the limited cathode sites to accept the additional lithium added to the system. Similarly, for anodes with higher FCE the addition of lithium supplement (not only L₂NO, but also others) may result in lower gains or be detrimental. Furthermore, the supplement wt. % which provides the greatest gain in VED occurs at the point where the added capacity from the supplement matches the available sites in the cathode. Mathematically, this is equivalent to when the effective FCE of the combined supplement-cathode primary material mixture is equal to the FCE of the anode. This model is a good representation of what occurs in a real lithium-ion battery, but small differences between the simple model and true experimental results may occur due to differences in cell voltage limits which define the amount of lithium in the cathode and anode at the end of the formation cycle as well as cell design specifics (e.g., N/P ratio, cathode and anode properties, inactive properties, etc.).

FIG. 13B shows experimental results of the dependence of the volumetric energy density (VED) measured at cycle 3 on the mass of L₂NO, a cathode supplement material, divided by a mass of the cathode active materials (sum of LCO, a cathode primary active material, and L₂NO). In the results shown, the VED is calculated based on a volume of the cathode and anode electrodes only (as compared to unit stack VED computed in modeling) to compensate for variable mass loading of the cathode in these experiments, which would skew the results of a unit stack VED calculation in favor of thicker electrodes. The experimental results of FIG. 13B provides experimental support for the modeling results presented in FIG. 13A, namely that improvements in VED (relative to the case of 0 wt. % supplemental cathode active material) may be realized at relatively low mass fractions (e.g., between about 2 wt. % and about 5 wt. % or between about 2 wt. % and 6 wt. %).

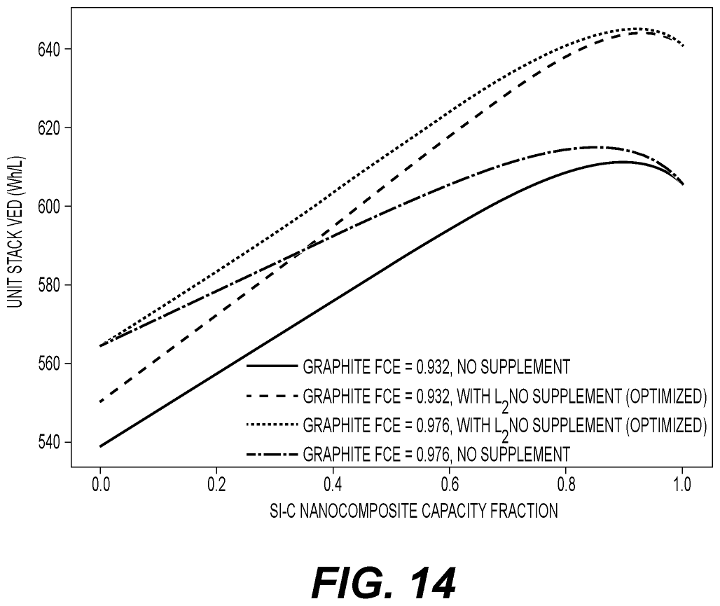

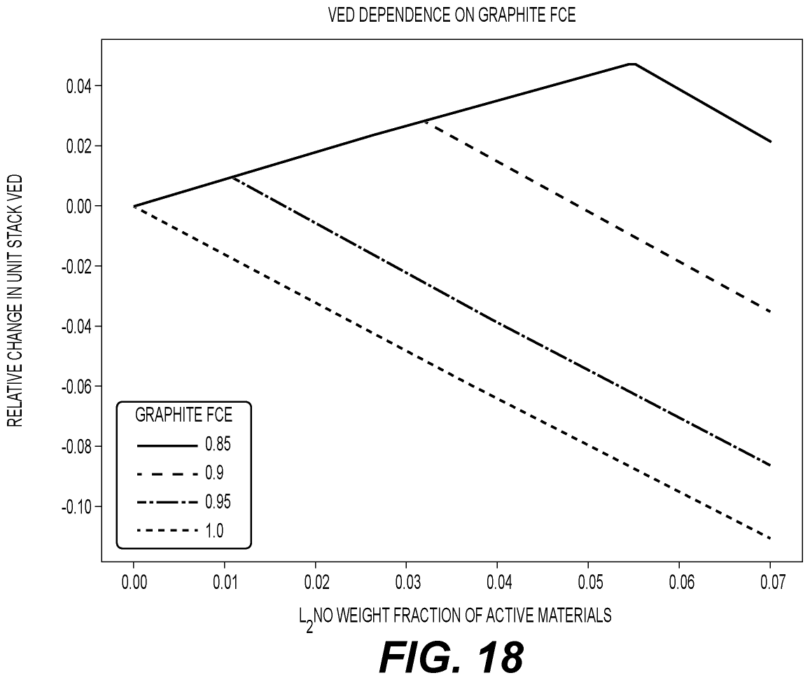

FIG. 14 shows the estimated relationship between VED and illustrative anode composition for LFP-type illustrative cathodes. As stated previously, the anode capacity significantly affects the performance of the L₂NO lithium supplement in terms of VED. Each point on the horizontal axis represents an anode with the stated capacity fraction of illustrative Si—C nanocomposite material, with the remaining capacity fraction being composed of graphite, having a FCE of 93.2% or 97.6%. The FCE of pure Si—C nanocomposite is set to 88.7%. The density of pure Si—C nanocomposite is set as 0.732 g/cc (the total electrode density in the fully lithiated state). The density of the pure graphite is set as 1.443 g/cc (the total electrode density in the fully lithiated state). The first lithiation specific capacities of pure graphite and pure Si—C nanocomposite are 370 mAh/g and 1656 mAh/g respectively. The electrode potentials of the pure Si—C nanocomposite and pure graphite are set to 0.4 V and 0.1 V (vs. Li metal reference), respectively. The properties of the anode mixture, such as potential, electrode density, FCE, and gravimetric capacity are carefully calculated. The active materials wt. % fraction (which includes mass of graphite and silicon-carbon nanocomposite) in the anode was set to 89.6 wt. % for all mixtures. Given these properties, the energy density may be calculated for a battery which either includes an L₂NO lithium supplement in the cathode electrode, or does not. In the case where a lithium supplement is added to the cathode, the amount of cathode supplemental material is optimized to obtain the maximum energy density. From these calculations, the inventors found that for every composition of anode, the VED is higher when incorporating the suitable cathode lithium supplement (such as L₂NO and others). In addition, the inventors found that the relative increase in VED for the supplement case, as compared to the non-supplement case, is greater for higher capacity % of Si—C composite material. The general trend is true for Si—C composites with different properties (e.g., different capacity, density, FCE, etc.) or for other types of Si-comprising anode materials. FIG. 14 also shows how the cathode supplement performs in a graphite-Si—C nanocomposite mixture where the graphite has different values of FCE (0.932 and 0.976). For graphite with high FCE (0.976), the supplement provides no VED benefit if no Si—C nanocomposite is added in the mixture. Further examination of this effect is found in FIG. 18. Another feature observed in FIG. 14 is the notable peak in energy density as Si—C capacity fraction (%) is increased. At silicon-carbon nanocomposite capacity fraction values of circa 0.9 (e.g., in a range of 0.85 to 0.95), a peak in energy density is typically observed for LFP cathodes. This is due to a number of factors, with one important factor being that the cell potential and the FCE of the anode decrease with increasing Si—C composite capacity fraction (%), which decreases the energy stored in the cell. In addition, the thickness of the anode decreases as blend percentage (Si—C composite capacity fraction) increases, which will tend to increase the VED, since the thickness of the anode is included in the denominator of the VED calculation. However, since the VED calculation includes a sum of terms in the denominator (the sum being the total stack thickness, including the anode, cathode, and other components), for sufficiently high Si—C capacity fractions, the thickness of the anode becomes significantly smaller than the sum of the thickness of the other cell components, which results in the VED of the cell decreasing at high Si—C capacity fractions. As state-of-the-art commercial LFP-based Li-ion batteries do not utilize Si in the anodes (or do not utilize a high fraction of Si in the anodes or high fraction of Si-comprising active materials in the anode or high fraction of Si—C nanocomposite active materials in the anode), there is typically no or limited motivation to utilize lithium supplement in cell designs employing an LFP-based cathode.

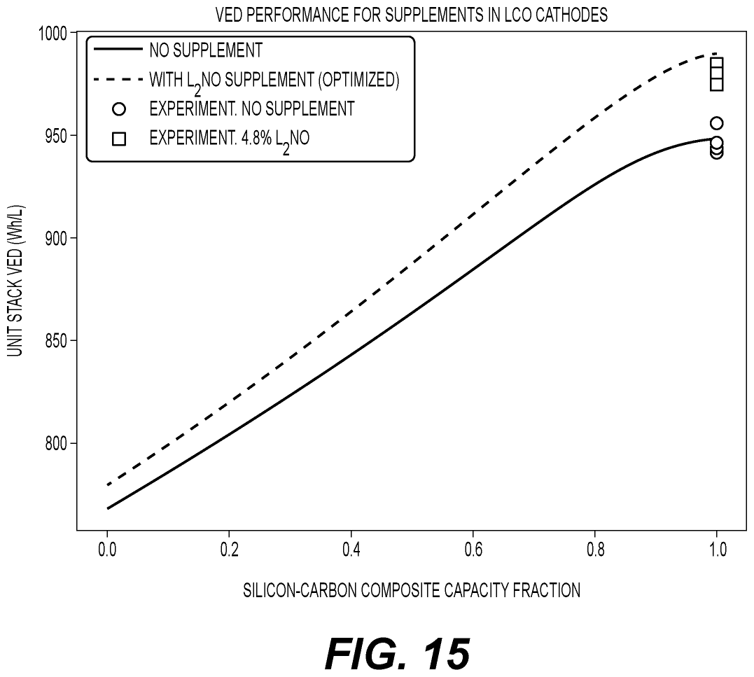

FIG. 15 displays a similar analysis as in FIG. 14, except for using LCO-type cathode properties instead of LFP. In this calculation, the N/P ratio is set to 1.14. The cathode primary material FCE is 97.3%. The cathode comprises electrode active material at a weight (mass) fraction of 93 wt. %. The cathode primary material first charge specific capacity is set to 185 mAh/g. The cathode electrode density is set to 4.0 g/cc. The supplemental cathode material has a capacity of 400 mAh/g, an FCE of 22%, and a density of 4.0 g/cc. The cathode electrode potential is set to 3.95 V (vs. Li metal reference). The properties of the anode mixture are the same as in the LFP-type calculations above. In general, the trends are similar to those in FIG. 14, but the energy density benefits associated with the lithium supplement are less pronounced than in the LFP-type cathode case. This is because for LFP-type cathode primary materials, the anode thickness contributes a relatively smaller fraction of the overall thickness of the battery including the battery's other components. Therefore, as more supplement is added, the resulting thickness increases to the anode have a smaller detrimental impact on the overall energy density of the battery. This is not the case for LCO-type cathodes. In the case of LCO-type cathodes, the anode thickness is a relatively larger fraction of the battery thickness, due to the fact that the LCO-type cathode is thinner than the case of LFP-type batteries, given that both batteries have a similar areal capacity.

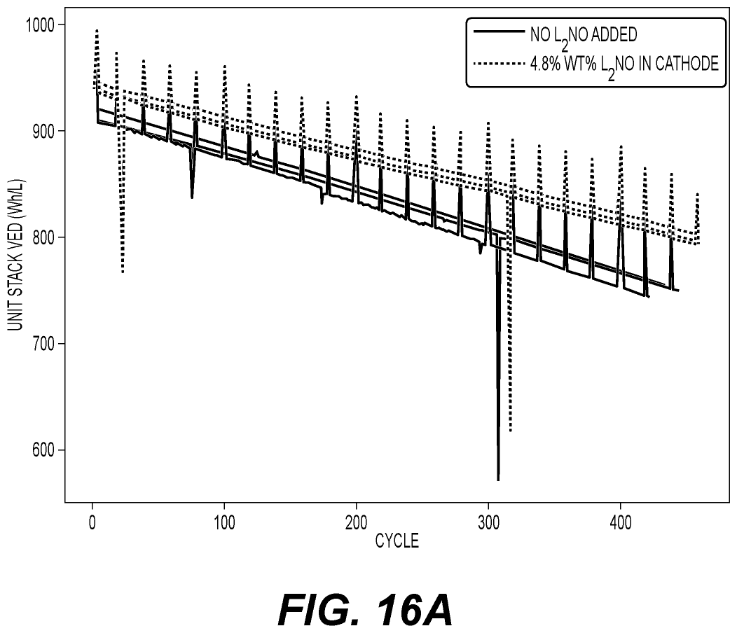

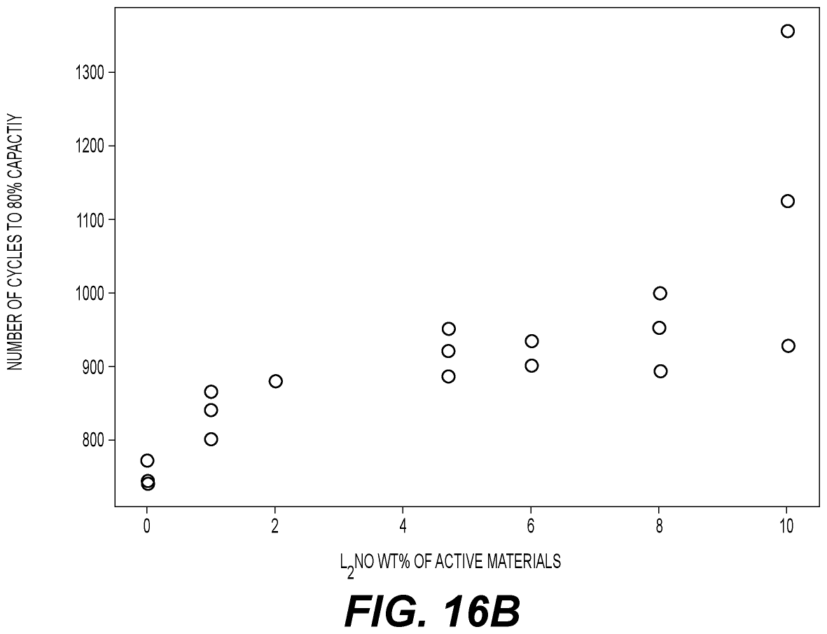

FIG. 16A displays illustrative experimental data to validate the illustrative modeling data. Experimental data was collected by constructing a set of single unit stack batteries, consisting of an anode, anode current collector, cathode, cathode current collector, separator, electrolyte, and case. The anode active materials are composed of 100 wt. % Si—C nanocomposite anode material. The anode is fabricated via blade casting onto a copper current collector. The cathode active materials consist of a blend of 95.2 wt. % LCO and 4.8 wt. % L₂NO. The cathode is fabricated by blade casting onto an aluminum current collector. The separator consists of a polyester-ceramic separator. The electrolyte solvent composition (including all co-solvents and additives) consists of a mixture of 57.8 vol. % ethyl isobutyrate, 12 vol. % fluoroethylene carbonate, 10 vol. % ethylene carbonate, 10 vol. % diethyl carbonate, 5.5 vol. % propylene carbonate, 3 vol. % vinylene carbonate, 0.7 vol. % 3-{[1,3-bis(2-cyanoethoxy)propan-2-yl]oxy}propanenitrile, 0.5 vol. % adiponitrile, and 0.5 vol. % 1,3,6 hexanetricarbonitrile. 1.1 M LiPF₆ and 0.1 M LiBF₄ salts were added to provide lithium-ion conductivity. Batteries are assembled by creating an anode-separator-cathode stack, placing it in an aluminum pouch coated with a polymer, and then filling the pouch with electrolyte inside of an argon filled glove-box to prevent reaction of the electrolyte with water in the atmosphere.

FIG. 16A shows that there is a statistically significant improvement in VED for batteries with LCO-type cathodes, Si—C nanocomposite anodes and L₂NO lithium supplement blended into the cathode, with good agreement with modeling. Unbroken lines denote data for replicate batteries which do not contain a blended supplement in the cathode. Dotted lines denote data on replicate batteries which contain 4.8 wt. % (as a fraction of cathode active material, i.e., sum of LCO and L₂NO) of L₂NO. The slopes of the respective curves indicate that the energy stored as a function of cycle number decreases faster for cells without L₂NO in the cathode, indicating improved cycle life for cells containing L₂NO.

FIG. 16A shows experimental results for the same set of single unit stack batteries as in FIG. 15, highlighting the changes in energy density over the lifetime of the battery. Batteries containing the L₂NO supplement are plotted as dashed lines. Each trace is a replicate battery within the test or control group. As is clear from the illustrated experiments, there is a statistically significant change in both the energy density and the decay in energy density over the lifetime of the batteries. Further, the inventors also unexpectedly discovered that lithium supplement additionally (i) improves Li-ion battery cycle life and (ii) reduces cell polarization. Both of such improvements are highly beneficial for cell performance and, in some designs, may be attained for other lithium supplement(s). So, for batteries with tested L₂NO supplement, both energy density and decay of energy density are found to be improved. Electrochemical testing of these batteries was conducted in a temperature controlled chamber, using constant current cycling procedures to charge and discharge the battery at different rates. Note that the long-term changes to energy density are driven mainly by undesirable chemical reactions between the anode and electrolyte, while the abrupt changes are due to variations in charging and discharging rate as part of the testing protocol.

FIG. 16B shows a graphical plot of the cycle life, expressed as the number of cycles to reach 80% of cycling-start gravimetric charge capacity (N80), of lithium-ion battery test cells in which the cathodes are blended cathodes comprising LCO, a primary cathode active material, and L₂NO, a supplemental cathode active material. The graphical plot shows a dependence of N80 on the mass fraction for the mass fractions of L₂NO in respective Li-ion battery test cells. The mass fraction is expressed as the mass of the L₂NO divided by the mass of the cathode active materials (sum of the LCO and the L₂NO). In the examples shown, L₂NO mass fractions in a range of about 0 to 10 wt. % are considered. In this range, there is a trend toward an increase in N80 for increasing L₂NO mass fractions. N80 values in excess of 1300 cycles have been observed for L₂NO mass fractions of 10 wt. %, in contrast to N80 values in a range of 700 to 800 cycles for Li-ion battery test cells with no L₂NO additive.

In some designs, the use of supplemental cathode active material may reduce the highest anode potential (PAmax) to which the Si-comprising anode (e.g., Si—C nanocomposite anode or blended anode) may be exposed during a deep discharge (e.g., to about 2% state-of-charge, SOC) in a Li-ion battery cell. In some designs, it may be advantageous (e.g., for improving cycle stability or calendar life of Li-ion batteries comprising such anodes) to provide sufficient amount of supplemental cathode to reduce this highest potential (Pmax) to about 0.6-1.3 V vs. Li/Li⁺, (e.g., to about 0.6-0.7 V vs. Li/Li⁺ or, in other designs, to about 0.7-0.8 V vs. Li/Li⁺ or, in other designs, to about 0.8-0.9 V vs. Li/Li⁺ or, in other designs, to about 0.9-1.0 V vs. Li/Li⁺ or, in other designs, to about 1.0-1.1 V vs. Li/Li⁺ or, in other designs, to about 1.1-1.2 V vs. Li/Li⁺ or, in other designs, to about 1.2-1.3 V vs. Li/Li⁺), as measured using a three-electrode electrochemical cell or another suitable experimental measurement technique. Interestingly, in some designs, the lower anode Pmax value may provide more improvements in cycle stability or calendar life of the Li-ion battery cells. It is plausible that decreases in PAmax may improve anode SEI electrochemical and/or chemical and/or structural stability. The reduction of PAmax may advantageously reduce contraction (volume changes) of Si-comprising particles in the anode (e.g., Si—C nanocomposite particles) during Li-ion battery cycling, which may enable improved SEI stability and/or improved structural stability of the anode and/or reduced resistance growth and/or reduced long-term swelling (gradual thickness increase) in the anode and/or reduced consumption of SEI-building electrolyte additives during the Li-ion battery operation. Note that the PAmax value is determined by multiple factors in addition to the type and amount of cathode supplement (e.g., L₂NO, among others), including the type and composition of the primary cathode material(s) (including its irreversible Li losses during first cycle, among other factors), the type and composition of the Si-comprising anode material (including its irreversible Li losses during first cycle, among other factors), the voltage range each Li-ion battery cell is exposed to during charge and discharge, cell operation conditions, among other factors. Also note that an excessive amount of cathode supplement may provide other limitations, such as reduced energy density. As such, a proper balance needs to be found for each application and the desired cell performance characteristics.

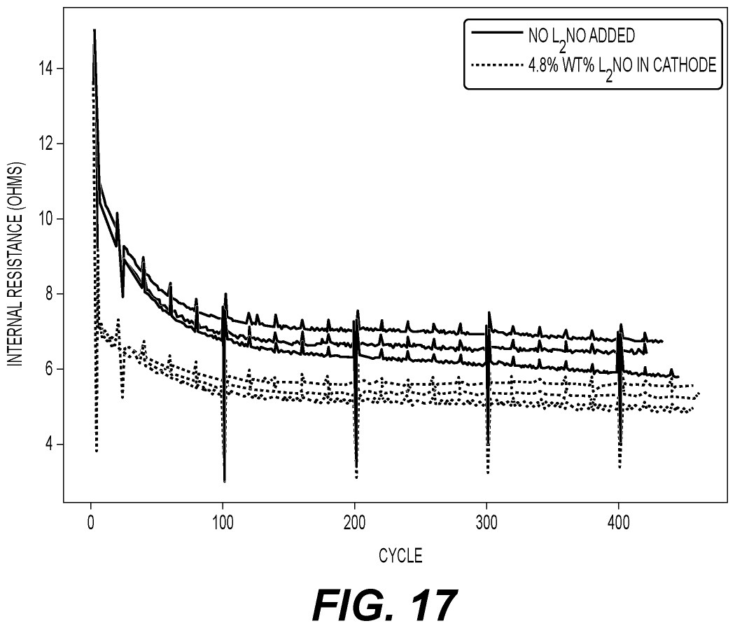

FIG. 17 shows experimental results of the dependence of the internal resistance on cycle number for (1) single-layer pouch cells with LCO and about 4.8 wt. % (as fraction of the cathode actives) additive lithium nickel oxide (L₂NO) as the cathode, and 100 wt. % (as fraction of anode actives) of Si—C nanocomposite as the anode, and (2) single-layer pouch cells with LCO (no additive lithium nickel oxide (L₂NO)) as the cathode, and 100 wt. % (as fraction of anode actives) of Si—C nanocomposite as the anode. Results highlight the unexpected improvement in internal resistance as a function of cycle number, with L₂NO-containing cells having a lower resistance (higher performance).

FIG. 17 highlights an additional advantage of the suitable cathode lithium supplement(s), which is improvement in rate performance. One method of assessing rate performance in a battery is by measuring the so-called internal resistance. The internal resistance is measured by applying small pulses of current to a battery and recording the instantaneous change in cell voltage. FIG. 17 shows that illustrative cells which contain a lithium supplement (in this example, L₂NO) in the cathode have a significantly lower internal resistance than the cells without lithium supplement (e.g., without L₂NO). This is especially true at the beginning of the battery test. Over time, the non-L₂NO containing illustrative cells were found to have a decrease in resistance, but the non-L₂NO containing cells still do not decrease below the cells with a lithium supplement (e.g., L₂NO). The lower internal resistance of the lithium supplement (e.g., L₂NO) containing batteries, for example, results in less energy dissipation via heat as the battery is charged or discharged, allowing the battery to be charged or discharged in a shorter time, and also leading to higher charge-discharge energy efficiency. As such, it may be advantageous to utilize cathode lithium supplement (e.g., L₂NO) in cells even with FCE of the cathodes matching or approaching those of the anodes.

In some designs, it may be advantageous to utilize lithium metal oxide-base cathode lithium supplement (e.g., L₂NO, among others) in Li-ion battery cells with Si-comprising anodes. In some designs, it may be advantageous for the weight (mass) fraction of the cathode lithium supplement (e.g., L₂NO, among others) to be in the range from about 0.5 wt. % to about 10 wt. % relative to the weight (mass) of all active cathode materials (in some designs, from about 0.5 wt. % to about 3 wt. %; in other designs, from about 3 wt. % to about 6 wt. %; in yet other designs, from about 6 wt. % to about 10 wt. %). In some designs, the cathode lithium supplement (e.g., L₂NO, among others), may advantageously contribute to a range of about 1% to about 18% of the first cycle charge (delithiation) cathode capacity (in some designs, from about 1 to about 6%; in other designs, from about 6 to about 12%; in yet other designs, from about 12 to about 18%).

FIG. 18 illustrates the cases (in the modeling examples shown, graphite-based anodes) in which a cathode lithium supplement does not add additional benefit to the battery. For cases where the anode FCE is high (in FIG. 18, anode FCE values of 85%, 90%, 95%, and 100% are shown for illustration), the addition of lithium supplement may have minimal, or even detrimental effect on the VED of a battery (in the example shown, the battery contains an LFP-type cathode and graphite anode, with no Si—C nanocomposite). FIG. 18 shows that for graphite-type anodes with FCE above 95%, the VED gain to the battery is less than 2%. Even in cases for graphite with very low FCE of 85%, the VED gain is only slightly higher than 4%, which is significantly smaller than the 6% change for a LFP-type cathode with Si—C nanocomposite, as shown in FIG. 13A.

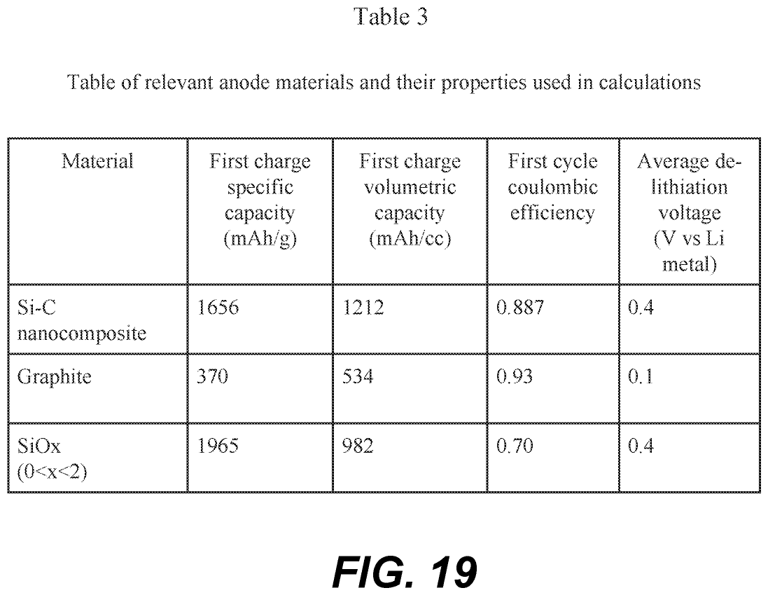

FIG. 19 shows Table 3 summarizing the parameters (first-charge specific capacity, first-charge volumetric capacity, first-cycle coulombic efficiency, and average de-lithiation voltage) of respective anode materials (Si—C nanocomposite, graphite, and SiOₓ, where 0<x<2) used in the above calculations. In particular, there is a large distinction in performance between Si—C nanocomposite materials and SiOₓ-based anode materials. Herein, SiOₓ refers to oxidized silicon, in which x may be 0<x<2 (e.g., in some cases, x may be in a range of 0.5 to 1.5). Given the low density and first cycle efficiency of SiOₓ, the overall effect on VED performance is very limited, and often results in decreased VED at high wt. fractions. In addition, SiOₓ materials suffer from low cycle life compared to Si—C nanocomposite materials. Accordingly, in some implementations of silicon-based anodes, the anode may be substantially free of oxidized silicon.

Li₂NiO₂ crystallizes in an orthorhombic crystal structure (space group: Immm) with a=3.743 Å, b=2.779 Å, and c=9.026 Å, where Ni²⁺ occupies a square planar coordination. Because of the similar ionic radii between Ni²⁺ (ionic radius of Ni²⁺ (IV) is 0.55 Å) and Cu²⁺ (ionic radius of Cu²⁺ (IV) is 0.57 Å), chemical substitutions to form solid-solutions of the formula Li₂Ni₁₋ₓCuₓO₂ (x<1.0) have been reported to improve the electrochemical performance of Li₂NiO₂ (the ionic radius of O²⁻ (VI) is 1.40 Å). Fluorine (F) doping is a known technique that has been shown to improve the stability and electrochemical performance of a range of Li-ion battery cathode materials (the ionic radius of F⁻ (VI) is 1.33 Å, compared to the ionic radius of O²⁻ (VI)). Magnesium doping is also a known technique (the ionic radius of Mg²⁺ (IV) is 0.57 Å, compared to the ionic radius of Ni²⁺ (IV)). Accordingly, the inventors hypothesized that (1) F doping, (2) Cu doping, (3) Cu and F co-doping, (3) Mg doping, or (4) Mg and F co-doping, of Li₂NiO₂ may yield beneficial effects. These dopants were selected based on valence, ionic radii and coordination considerations.

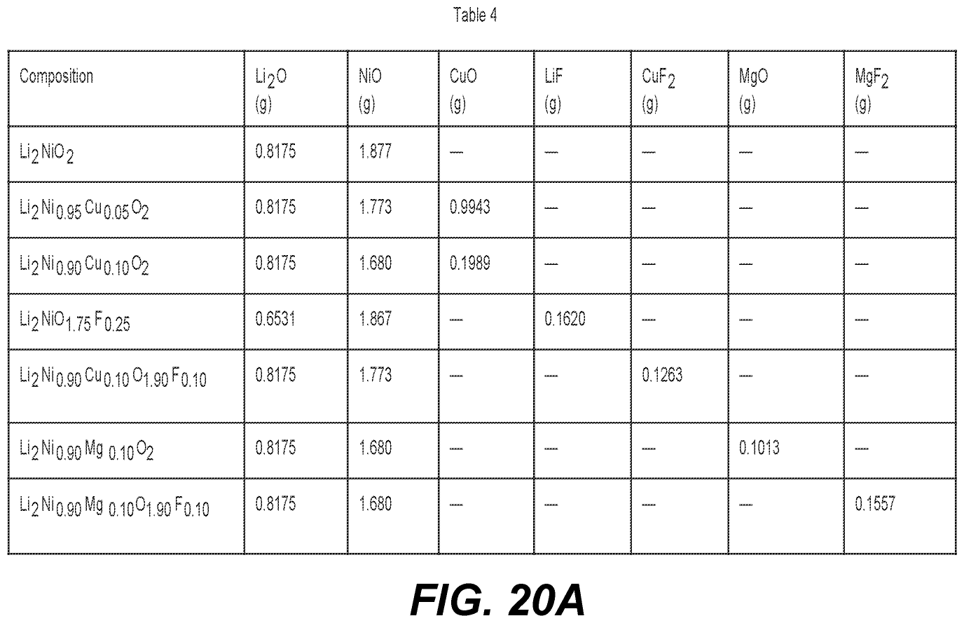

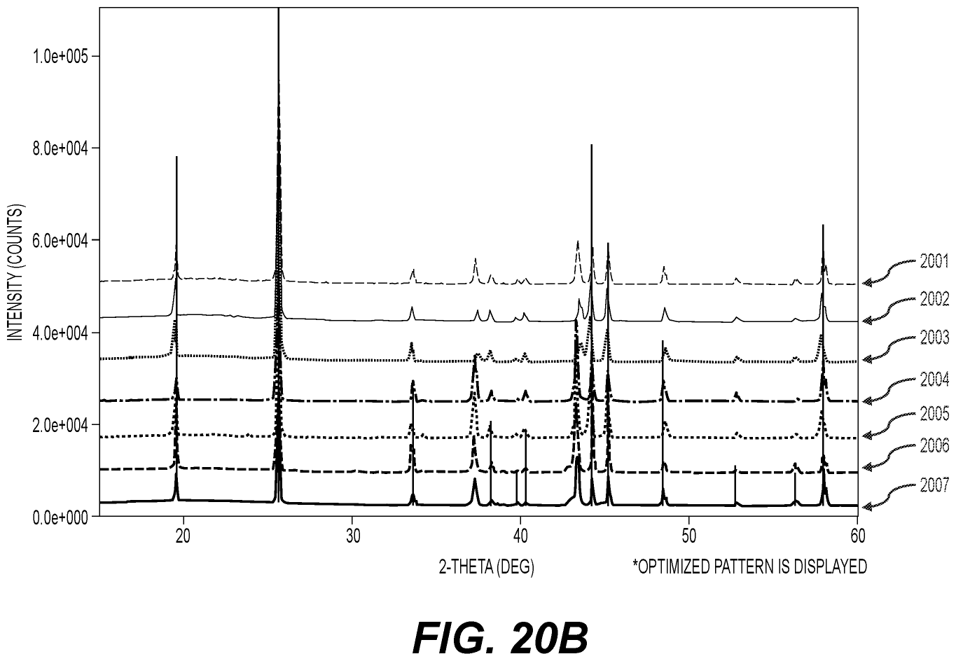

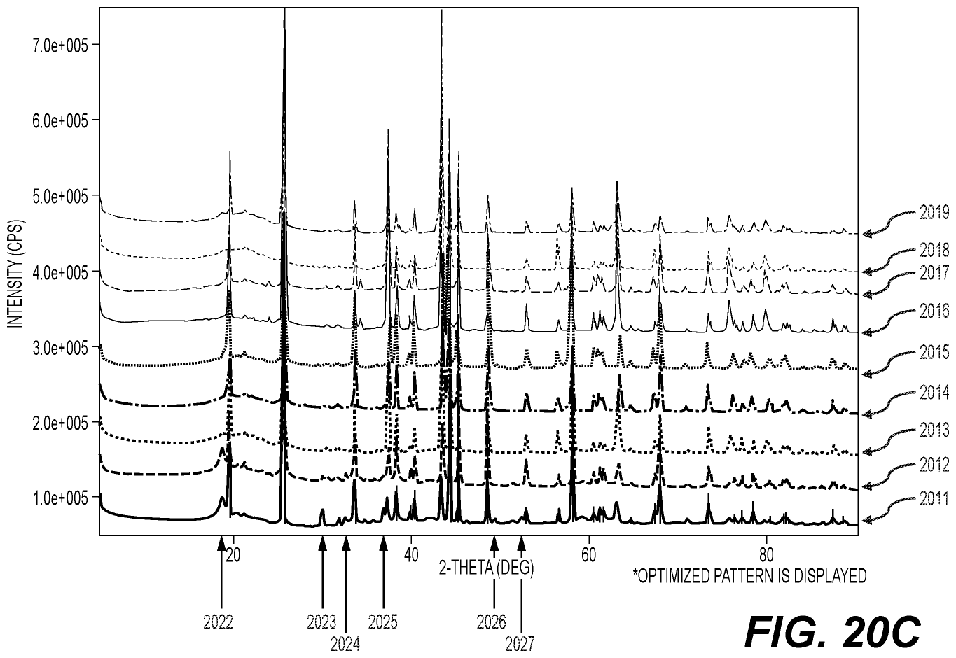

The process for synthesizing the L₂NO variants (doped and undoped) is as follows. FIG. 20A shows Table 4 summarizing the approximate compositions of the L₂NO variants (doped and undoped) that were synthesized and the amounts of starting materials for the respective L₂NO variants. Many published methods used commercially available Li₂O and NiO (green) (NiO is referred to as being “green” when the NiO is stoichiometric NiO (molar ratio of Ni:O is equal to 1:1)) for the synthesis of Li₂NiO₂ at temperatures up to 750° C. in the N₂ atmosphere. An example of a publication that describes such a process is M. G. Kim and J. Cho, “Air stable Al₂O₃-coated Li₂NiO₂ cathode additive as a surplus current consumer in a Li-ion cell,” J. Mater. Chem., 2008, 18, 5880-5887. Repeated attempts to synthesize Li₂NiO₂ following the reported methods were not successful. The starting materials for our successful synthesis of Li₂NiO₂ were commercial Li₂O pre-treated at 1000° C. in moisture free air atmosphere to eliminate any Li₂CO₃ impurities and a freshly in-house synthesized NiO (black) (NiO is referred to as being “black” when the NiO is non-stoichiometric (molar ratio of Ni:O is not equal to 1:1)), which are found to be critically important for the successful synthesis of Li₂NiO₂ and its doped variants. The black NiO was synthesized by decomposing commercial nickel acetate, nickel nitrate, or nickel hydroxide at 500° C. in air. Respective black NiO samples obtained from nickel acetate, nickel nitrate, and nickel hydroxide were employed in synthesizing L₂NO samples. The black NiO that was obtained from nickel hydroxide was employed in synthesizing L₂NO samples that underwent electrochemical testing. Li₂O at 9 wt. % in excess of the stoichiometric amount (the 9 wt. % excess amount of Li₂O was used to compensate for the loss of Li-during synthesis) and stoichiometric amounts of the other starting materials as appropriate for the respective variants (NiO, LiF, CuO, CuF₂, MgO and MgF₂) (the amounts used are reported in Table 4) were mixed thoroughly in an agate and mortar for an hour. The mixture was then transferred to high-density alumina crucibles, covered with Ni foils and transferred to a tube furnace. Then, the tube was evacuated to a pressure of <0.1 Torr and backfilled with nitrogen gas to a pressure of 75 Torr. This process was then repeated two more times. Then, the tube was backfilled with nitrogen to a pressure of 600 Torr and nitrogen was flowed continuously at 1 Standard Liter per Minute (SLM) for the duration of the heat treatment. The samples were heated to 500° C. at a ramp rate of 10-12° C./min, held at 500° C. for 3 h, heated to 650° C. at a ramp rate of 10-12° C./min, held at 650° C. for 11 h, and cooled down to room temperature.

FIGS. 20B and 20C show x-ray diffraction (XRD) plots of respective L₂NO materials. X-ray diffraction was conducted using a Rigaku SmartLab x-ray diffractometer with 3 kW power output and a copper Kα X-ray tube. FIG. 20B shows the XRD plots of (1) L₂NO materials soon after synthesis, for L₂NO materials synthesized as detailed herein, and (2) L₂NO materials soon after receipt (stored with minimal ambient air exposure), for commercially available L₂NO materials. FIG. 20C shows the XRD plots of the respective L₂NO materials after about three months of storage in an evacuated desiccator at room temperature, after a controlled exposure of the samples to (1) ambient air heated to 125° C., for 1 h, and (2) ambient conditions, for 12 h ((2) is after (1)). For ease of viewing, the plots are vertically displaced relative to each other. FIG. 20B shows x-ray diffraction (XRD) plots (2001 through 2007) of respective L₂NO materials, synthesized as described herein. Plot 2001 is an XRD plot of a sample of Li₂NiO₂ material, with no dopants. Plot 2002 is an XRD plot of a sample of Li₂NiO₂ material that has been doped with CuO, at 5 mol. % of Cu doping (approximate composition Li₂Ni_{0.95}Cu_{0.05}O₂). Plot 2003 is an XRD plot of a sample of Li₂NiO₂ material that has been doped with CuO, at 10 mol. % of Cu doping (approximate composition Li₂Ni_{0.90}Cu_{0.10}O₂). Plot 2004 is an XRD plot of a sample of Li₂NiO₂ material that has been doped with LiF, at 25 mol. % of F doping (approximate composition Li₂NiO_{1.75}F_{0.25}). Plot 2005 is an XRD plot of a sample of Li₂NiO₂ material that has been doped with CuF₂, at 10 mol. % of Cu and F doping (approximate composition Li₂Ni_{0.90}Cu_{0.10}O_{1.90}F_{0.10}). Plot 2006 is an XRD plot of a sample of Li₂NiO₂ material that has been doped with MgO, at 10 mol. % of Mg doping (approximate composition Li₂Ni_{0.90}Mg_{0.10}O₂). Plot 2007 is an XRD plot of a sample of Li₂NiO₂ material that has been doped with MgF₂, at 10 mol. % of Mg and F doping (approximate composition Li₂Ni_{0.90}Mg_{0.10}O_{1.90}F_{0.10}). A commonly accepted interpretation of the XRD plots is that sets of peaks correspond to different crystalline compounds, which can be identified by referencing standard peak sets from a database. The lack of XRD peaks associated with the input dopant materials such as CuO, LiF, CuF₂, MgO, MgF₂, indicates that the dopant materials have likely been incorporated into the crystal structure of the majority compound (Li₂NiO₂ in this case). Only small impurity peaks attributed to NiO are observed at 2θ values of approximately 38 and 44 degrees, which are observed in doped and undoped samples, and in doped samples, regardless of the doping material.

FIG. 20C shows x-ray diffraction (XRD) plots (2011 through 2019) of respective L₂NO materials, after about three months of storage in an evacuated desiccator at room temperature, after a controlled exposure of the samples to (1) ambient air heated to 125° C., for 1 h, and (2) ambient conditions, for 12 h ((2) is after (1)). Plots 2011 and 2012 are XRD plots of samples of commercially available L₂NO (Li₂NiO₂) materials. Plots 2013 through 2019 are XRD plots of L₂NO materials synthesized as detailed herein, measured after undergoing the three-month storage. Plot 2013 is an XRD plot of a sample of Li₂NiO₂ material, with no dopants. Plot 2014 is an XRD plot of a sample of Li₂NiO₂ material that has been doped with CuO, at 5 mol. % of Cu doping (approximate composition Li₂Ni_{0.95}Cu_{0.05}O₂). Plot 2015 is an XRD plot of a sample of Li₂NiO₂ material that has been doped with CuO, at 10 mol. % of Cu doping (approximate composition Li₂Ni_{0.90}Cu_{0.10}O₂). Plot 2016 is an XRD plot of a sample of Li₂NiO₂ material that has been doped with LiF, at 25 mol. % of F doping (approximate composition Li₂NiO_{1.75}F_{0.25}). Plot 2017 is an XRD plot of a sample of Li₂NiO₂ material that has been doped with CuF₂, at 10 mol. % of Cu and F doping (approximate composition Li₂Ni_{0.90}Cu_{0.10}O_{1.90}F_{0.10}). Plot 2018 is an XRD plot of a sample of Li₂NiO₂ material that has been doped with MgO, at 10 mol. % of Mg doping (approximate composition Li₂Ni_{0.90}Mg_{0.10}O₂). Plot 2019 is an XRD plot of a sample of Li₂NiO₂ material that has been doped with MgF₂, at 10 mol. % of Mg and F doping (approximate composition Li₂Ni_{0.90}Mg_{0.10}O_{1.90}F_{0.10}). For case of viewing, the plots are vertically displaced relative to each other. After the three-month storage, the commercially available L₂NO (Li₂NiO₂) samples (plots 2011 and 2012) exhibit additional peaks as indicated by arrows 2022 (2θ of about 18.6 degrees), 2023 (2θ of about 30.1 degrees), 2024 (2θ of about 31.7 degrees), 2025 (2θ of about 36.9 degrees), 2026 (2θ of about 46.3 degrees), and 2027 (2θ of about 52.5 degrees). These additional peaks were not present in the XRD plots before storage. These additional peaks are attributable to impurity formation during the storage period. Except for the peak at 2θ of about 18.6 degrees, these additional peaks can be assigned to Li(OH).H₂O or Li₂CO₃. The inventors have been unable to identify the origin of the peak at 2θ of about 18.6 degrees. In some designs, it is highly desirable to prevent the growth of LiOH, Li(OH).H₂O, and Li₂CO₃, as the presence of these species indicates reactions with ambient moisture and carbon dioxide upon air exposure. Materials which exhibit smaller ratios of peak heights between impurity compounds (Li₂CO₃) and the majority compound (Li₂NiO₂) should qualitatively have smaller amounts of impurities and have a lower tendency to react with ambient moisture and carbon dioxide.

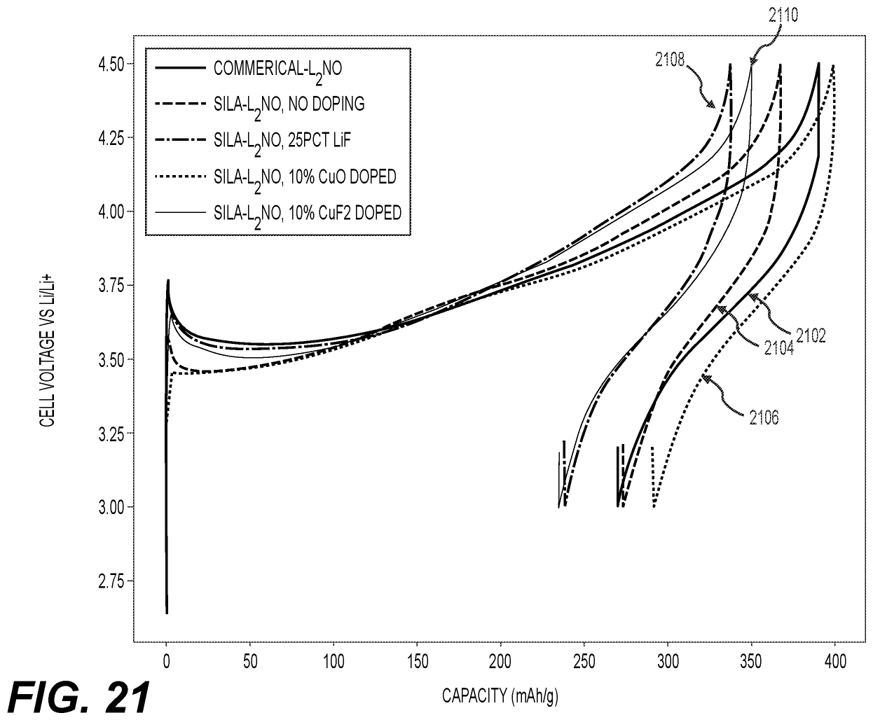

FIG. 21 shows half-cell cycling data plots (2102, 2104, 2106, 2108, and 2110) of respective L₂NO materials. Each plot shows the dependence of the voltage (measured in volts relative to Li metal (vs. Li/Li⁺)) on the charge capacity (expressed in mAh/g of cathode active material). Plot 2102 is a half-cell cycling plot of a sample of commercially available L₂NO (Li₂NiO₂) material. Plots 2104, 2106, 2108, and 2110 are half-cell cycling plots of L₂NO materials synthesized in this work as detailed herein. Plot 2104 is a half-cell cycling plot of a sample of Li₂NiO₂ material, with no dopants. Plot 2106 is a half-cell cycling plot of a sample of Li₂NiO₂ material that has been doped with CuO (approximate composition Li₂Ni_{0.90}Cu_{0.10}O₂). Plot 2108 is a half-cell cycling plot of a sample of Li₂NiO₂ material that has been doped with LiF (approximate composition Li₂NiO_{1.75}F_{0.25}). Plot 2110 is a half-cell cycling plot of a sample of Li₂NiO₂ material that has been doped with CuF₂ (approximate composition Li₂Ni_{0.90}Cu_{0.10}O_{1.90}F_{0.10}). In these tests, a coin-type electrochemical cell (battery) is constructed with a lithium metal anode as the negative electrode, and the material of interest is contained in the positive electrode, where the positive electrode consists of the active material, PVDF binder, and an aluminum foil current collector. The high first cycle capacity of the various materials indicate that any of these materials would show improved VED and/or cycle life improvements similar to experimental full cell results. An example of this can be seen in FIG. 14 which shows the modeled relationship between first cycle specific capacity of a supplement material and the unit stack VED.

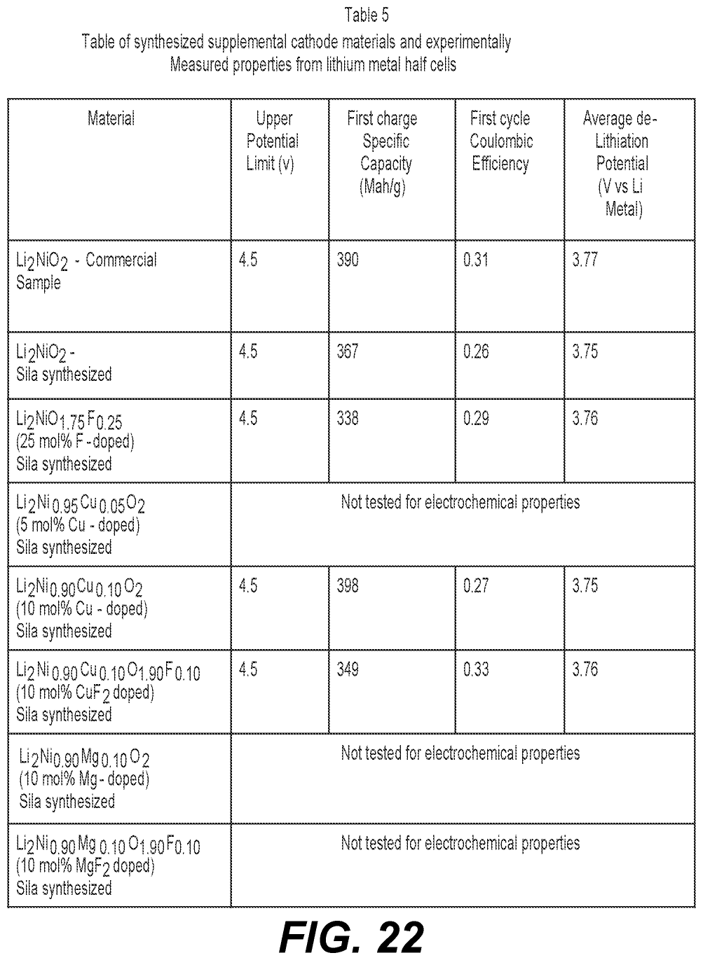

FIG. 22 shows Table 5 summarizing the experimentally measured properties of Li-metal half cells in which the cathode comprises: (1) commercially available L₂NO (Li₂NiO₂) material, (2) Li₂NiO₂ material, with no dopants, (3) Li₂NiO₂ material that has been doped with LiF (approximate composition Li₂NiO_{1.75}F_{0.25}), (4) Li₂NiO₂ material that has been doped with CuO (approximate composition Li₂Ni_{0.90}Cu_{0.10}O₂), and (5) Li₂NiO₂ material that has been doped with CuF₂ (approximate composition Li₂Ni_{0.90}Cu_{0.10}O_{1.90}F_{0.10}). Except for the commercial sample of Li₂NiO₂, the samples were synthesized in-house according to the processes described herein. Samples including the following were synthesized: Li₂NiO₂ (undoped), Li₂NiO₂ with 25 mol. % of F doping (approximate composition Li₂NiO_{1.75}F_{0.25}), Li₂NiO₂ with 5 mol. % Cu doping (approximate composition Li₂Ni_{0.95}Cu_{0.05}O₂), Li₂NiO₂ with 10 mol. % Cu doping (approximate composition Li₂Ni_{0.90}Cu_{0.10}O₂), Li₂NiO₂ with 10 mol. % of CuF₂ doping (approximate composition Li₂Ni_{0.90}Cu_{0.10}O_{1.90}F_{0.10}), Li₂NiO₂ with 10 mol. % Mg doping (approximate composition Li₂Ni_{0.90}Mg_{0.10}O₂), and Li₂NiO₂ with 10 mol. % MgF₂ doping (approximate composition Li₂Ni_{0.90}Mg_{0.10}O_{1.90}F_{0.10}). The experimental results of FIG. 21 and Table 5 (FIG. 22) demonstrates that the electrochemical performance of the L₂NO materials modified with the respective dopants and doping levels is similar to the un-doped material, and all the explored compositions would be attractive candidates for a supplemental cathode material, in light of the modeling work discussed in FIGS. 12, 13A, 14, and 15. Since some data suggests that doped compounds may be more stable to air exposure compared to undoped compounds, the electrochemical results further support the doped compounds as attractive candidates for improved lithium supplement materials.

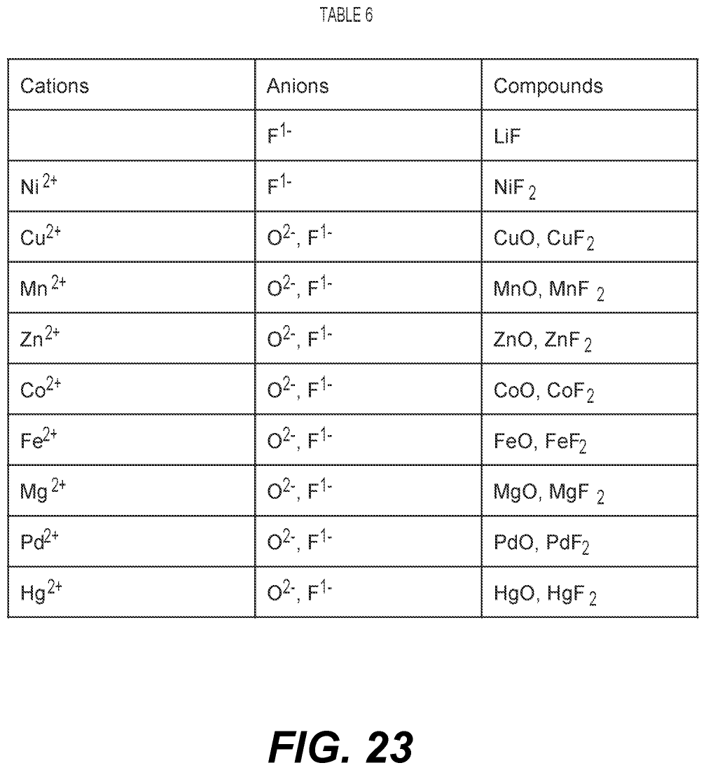

FIG. 23 shows Table 6 summarizing selected cation and anion dopants that may be employed to dope Li₂NiO₂ material, and the selected compounds from which such dopants may be obtained. Some of the listed cation dopants have been demonstrated (e.g., Cu²⁺, Mg²⁺). Based on consideration of the ionic radii (e.g., is the ionic radius of the dopant ion close enough to the ionic radius of the respective ion being substituted, close to the ionic radius of Ni²⁺ (0.55 Å) for cations, close to the ionic radius of O²⁻ (1.40 Å) for anions, ionic radius of F¹⁻ is 1.33 Å) and coordination chemistry (Ni²⁺ is IV-fold coordination, O²⁻ and F¹⁻ are VI-fold coordination), additional cation dopants may include: Mn²⁺, Zn²⁺, Co²⁺, Fe²⁺, Pd²⁺, and Hg²⁺. Example dopant compounds may include such cations and O²⁻ or F¹⁻ as the anions. Example dopant compounds include LiF, NiF₂, CuO, CuF₂, MnO, MnF₂, ZnO, ZnF₂, CoO, CoF₂, FeO, FeF₂, MgO, MgF₂, PdO, PdF₂, HgO, and HgF₂.

One of the main surface impurities encountered in Li₂NiO₂ material is Li₂CO₃. The air stability of Li₂NiO₂ material can be improved by forming a protective layer of LiF. Li₂CO₃ can be readily converted to LiF by exposure to gaseous nitrogen trifluoride (NF₃), or through wet-chemical processes using dilute hydrofluoric acid (HF) or trifluoro acetic acid (TFA). If needed, the LiF layer may subsequently be crystallized by thermal processing (annealing). Depending on the estimation of the mass of Li₂CO₃ at the surface, the concentration of HF or TFA in the solutions can be adjusted to fully convert the Li₂CO₃ to LiF. The wet-chemical processes involve stirring Li₂NiO₂ powder in a solution of HF or TFA solutions for a predetermined period, followed by filtering out the solids, and annealing it without any washing. The annealing step can be between about 250-500° C. in an inert atmosphere such as flowing nitrogen or argon. A crystalline LiF protective layer is formed on the surface of Li₂NiO₂ particles. Such an approach can improve the stability of Li₂NiO₂.

Battery cell modules or battery cell packs may advantageously comprise cells with electrode and/or electrolyte compositions provided in this disclosure. Such cell modules or packs may offer improved performance characteristics, simplified designs, better safety features or lower cost.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered Clauses:

Clause 1. A Li-ion battery, comprising: an anode current collector; a cathode current collector; an anode disposed on or in the anode current collector, the anode comprising silicon and carbon; a cathode disposed on or in the cathode current collector, the cathode comprising (1) a primary cathode active material and (2) a supplemental cathode active material; and an electrolyte ionically coupling the anode and the cathode, wherein: a mass fraction of the silicon element (Si) in the anode is in a range of about 10 wt. % to about 60 wt. %; a mass ratio of the primary cathode active material to the supplemental cathode active material is in a range of about 15:1 to about 50:1; a first-cycle coulombic efficiency of the primary cathode active material is at least about 85%; a first-charge specific capacity of the supplemental cathode active material is at least about 350 mAh/g; and a first-cycle coulombic efficiency of the anode is less than the first-cycle coulombic efficiency of the primary cathode active material.

Clause 2. The Li-ion battery of clause 1, wherein: the first-charge specific capacity of the supplemental cathode active material is at least about 450 mAh/g.

Clause 3. The Li-ion battery of clause 2, wherein: the first-charge specific capacity of the supplemental cathode active material is at least about 750 mAh/g.

Clause 4. The Li-ion battery of any of clauses 1 to 3, wherein: the supplemental cathode active material comprises Li, and additionally comprises one or more of the following: Fe, Ni, and V.

Clause 5. The Li-ion battery of clause 4, wherein: the supplemental cathode active material comprises a lithium nickel oxide represented by Li₂NiₓM_{y}O₂; x is between 0.9 and 1; y is between 0 and 0.1; x+y is between 0.9 and 1.1; and M represents an element or a mixture of two or more elements, the element or at least one of the two or more elements being selected from the following: iron (Fe), magnesium (Mg), calcium (Ca), vanadium (V), strontium (Sr), barium (Ba), manganese (Mn), zinc (Zn), tungsten (W), niobium (Nb), silicon (Si), cobalt (Co), and aluminum (Al).

Clause 6. The Li-ion battery of any of clauses 1 to 5, wherein: the supplemental cathode active material comprises one or more of the following elements: oxygen (O), nitrogen (N), sulfur (S), and carbon (C).

Clause 7. The Li-ion battery of any of clauses 1 to 6, further comprising: a supplemental cathode active material particle comprising the supplemental cathode active material, wherein the supplemental cathode active material particle comprises a protective surface coating with an average thickness from about 0.2 nm to about 50 nm.

Clause 8. The Li-ion battery of clause 7, wherein the protective surface coating comprises one or more of the following compositions: (i) metal oxide, (ii) semimetal oxide, (iii) oxynitride, (iv) carbon, and (v) polymer.

Clause 9. The Li-ion battery of any of clauses 1 to 8, wherein: the primary cathode active material is selected from: lithium cobalt oxide (LCO), lithium iron phosphate (LFP), lithium manganese iron phosphate (LMFP), lithium manganese oxide (LMO), lithium nickel manganese oxide (LMNO), lithium nickel cobalt manganese aluminum oxide (NCMA), lithium nickel cobalt manganese oxide (NCM), and lithium nickel aluminum oxide (NCA).

Clause 10. The Li-ion battery of clause 9, wherein: the primary cathode active material comprises the LMNO in a high-voltage spinel form.

Clause 11. The Li-ion battery of any of clauses 1 to 10, wherein: the first-cycle coulombic efficiency of the supplemental cathode active material is at most about 30%.

Clause 12. The Li-ion battery of any of clauses 1 to 11, wherein: the first-cycle coulombic efficiency of the primary cathode active material is at least about 90%.

Clause 13. The Li-ion battery of clause 12, wherein: the first-cycle coulombic efficiency of the primary cathode active material is at least about 95%.

Clause 14. The Li-ion battery of any of clauses 1 to 13, wherein: the mass fraction of the silicon in the anode is in a range of about 25 wt. % to about 50 wt. %.

Clause 15. The Li-ion battery of any of clauses 1 to 14, wherein: the anode comprises Si—C nanocomposite particles.

Clause 16. The Li-ion battery of any of clause 15, wherein: the Si—C nanocomposite particles exhibit lithiation capacity in the range from about 1600 mAh/g to about 3000 mAh/g.

Clause 17. The Li-ion battery of clause 16, wherein: the Si—C nanocomposite

particles contribute from about 20% to about 100% of a total capacity of the anode.

Clause 18. The Li-ion battery of any of clauses 1 to 17, wherein: the anode is substantially free of oxidized silicon.

Clause 19. The Li-ion battery of any of clauses 1 to 18, wherein: an areal capacity loading of the cathode ranges from about 2 mAh/cm² to about 12 mAh/cm².

Clause 20. The Li-ion battery of any of clauses 1 to 19, wherein: the anode comprises one or more of the following: natural graphite, synthetic graphite, soft carbon, and hard carbon.

Clause 21. The Li-ion battery of any of clauses 1 to 20, wherein: the first-cycle coulombic efficiency of the anode is at least about 80%.

Clause 22. The Li-ion battery of clause 21, wherein: the first-cycle coulombic efficiency of the anode is at least about 85%.

Clause 23. The Li-ion battery of any of clauses 1 to 22, wherein: the electrolyte comprises a salt composition and an electrolyte solvent composition, the salt composition comprising a primary salt and the electrolyte solvent composition comprising fluoroethylene carbonate (FEC) and vinylene carbonate (VC), the primary salt being at least about 50 mol. % of the salt composition; and the primary salt is selected from: LiPF₆, lithium tetrafluoroborate (LiBF₄), lithium bis(fluorosulfonyl)imide (LiFSI), lithium bis(trifluoromethanesulfonyl)imide (LiTFSI), and lithium fluorosulfate (LiSO₃F).

Clause 24. The Li-ion battery of clause 23, wherein: the salt composition additionally comprises a secondary salt, the secondary salt being selected from: lithium bis(fluorosulfonyl)imide (LiFSI), lithium tetrafluoroborate (LiBF₄), lithium difluoro(oxalato)borate (LiDFOB), lithium bis(oxalato)borate (LiBOB), lithium difluorophosphate (LFO), lithium fluorosulfate (LiSO₃F), and lithium bis(trifluoromethanesulfonyl)imide (LiTFSI).

Clause 25. The Li-ion battery of any of clauses 23 to 24, wherein: the electrolyte solvent composition additionally comprises (1) at least one ester compound and/or (2) at least one linear carbonate compound; the at least one ester compound is selected from propyl propionate (PP), methyl butyrate (MB), ethyl propionate (EP), ethyl isobutyrate (EI), ethyl isovalerate (EIV), methyl acetate (MA), ethyl trimethylacetate (ET), ethyl acetate (EA), and ethyl butyrate (EB); and the at least one linear carbonate compound is selected from dimethyl carbonate (DMC), ethyl methyl carbonate (EMC), and diethyl carbonate (DEC).

Clause 26. The Li-ion battery of clause 25, wherein: the electrolyte solvent composition additionally comprises at least one cyclic carbonate compound; and the at least one cyclic carbonate compound is selected from ethylene carbonate (EC), fluoroethylene carbonate (FEC), difluoroethylene carbonate (dFEC), vinylene carbonate (VC) and propylene carbonate (PC).

Clause 27. The Li-ion battery of any of clauses 23 to 26, wherein: the electrolyte additionally comprises one or more additives selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, 1-(propan-2-yl)-1H-imidazole-4,5-dicarbonitrile, pyridine-2,6-dicarbonitrile, ethylene glycol bis(propionitrile) ether (EGBE), 3-(triethoxysilyl) propionitrile, succinonitrile (SN), benzonitrile, 4-(trifluoromethyl) benzonitrile, 1,2,2,3-propanetetracarbonitrile, triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, 1,3,2-Dioxathiolane 2,2-dioxide (DTD), and methylene methanedisulfonate (MMDS).

Additional implementation examples are described in the following numbered Additional Additional Clauses:

Additional Clause 1. A Li-ion battery, comprising: an anode current collector; a cathode current collector; an anode disposed on and/or in the anode current collector, the anode comprising silicon and carbon; a cathode disposed on and/or in the cathode current collector, the cathode comprising (1) a primary cathode active material and (2) a supplemental cathode active material; and an electrolyte ionically coupling the anode and the cathode, wherein: a mass fraction of the silicon in the anode is in a range of about 10 wt. % to about 60 wt. %; a mass ratio of the primary cathode active material to the supplemental cathode active material is in a range of about 15:1 to about 50:1; a first-cycle coulombic efficiency of the primary cathode active material is at least about 85%; a first-charge specific capacity of the supplemental cathode active material is at least about 350 mAh/g; and a first-cycle coulombic efficiency of the anode is less than the first-cycle coulombic efficiency of the primary cathode active material.

Additional Clause 2. The Li-ion battery of Additional Additional Clause 1, wherein: the first-charge specific capacity of the supplemental cathode active material is at least about 450 mAh/g.

Additional Clause 3. The Li-ion battery of Additional Additional Clause 2, wherein: the first-charge specific capacity of the supplemental cathode active material is at least about 750 mAh/g.

Additional Clause 4. The Li-ion battery of any of Additional Additional Clauses 1 to 3, wherein: the supplemental cathode active material comprises Li and one or more of the following: Fe, Ni, and V.

Additional Clause 5. The Li-ion battery of Additional Additional Clause 4, wherein: the supplemental cathode active material comprises a lithium nickel oxide represented by Li₂Ni₁₋ₓMₓO_{2-y}F_{y}; x is between 0 and 0.5; y is between 0 and 0.5; and M represents an element or a mixture of two or more elements, the element or at least one of the two or more elements being selected from the following: copper (Cu), iron (Fe), magnesium (Mg), manganese (Mn), zinc (Zn), and cobalt (Co).

Additional Clause 6. The Li-ion battery of any of Additional Additional Clauses 1 to 5, wherein: the supplemental cathode active material comprises one or more of the following elements: oxygen (O), nitrogen (N), sulfur (S), and carbon (C).

Additional Clause 7. The Li-ion battery of any of Additional Additional Clauses 1 to 6, further comprising: a supplemental cathode active material particle comprising the supplemental cathode active material, wherein the supplemental cathode active material particle comprises a protective surface coating with an average thickness from about 0.2 nm to about 50 nm.

Additional Clause 8. The Li-ion battery of Additional Additional Clause 7, wherein the protective surface coating comprises one or more of the following compositions: (i) metal oxide, (ii) semimetal oxide, (iii) oxynitride, (iv) carbon, and (v) polymer.

Additional Clause 9. The Li-ion battery of any of Additional Additional Clauses 1 to 8, wherein: the primary cathode active material is selected from: lithium cobalt oxide (LCO), lithium iron phosphate (LFP), lithium manganese iron phosphate (LMFP), lithium manganese oxide (LMO), lithium nickel manganese oxide (LMNO), lithium nickel cobalt manganese aluminum oxide (NCMA), lithium nickel cobalt manganese oxide (NCM), and lithium nickel aluminum oxide (NCA).

Additional Clause 10. The Li-ion battery of Additional Additional Clause 9, wherein: the primary cathode active material comprises the LMNO in a spinel form.

Additional Clause 11. The Li-ion battery of any of Additional Additional Clauses 1 to 10, wherein: a first-cycle coulombic efficiency of the supplemental cathode active material is at most about 30%.

Additional Clause 12. The Li-ion battery of any of Additional Additional Clauses 1 to 11, wherein: the first-cycle coulombic efficiency of the primary cathode active material is at least about 90%.

Additional Clause 13. The Li-ion battery of Additional Additional Clause 12, wherein: the first-cycle coulombic efficiency of the primary cathode active material is at least about 95%.

Additional Clause 14. The Li-ion battery of any of Additional Additional Clauses 1 to 13, wherein: the mass fraction of the silicon in the anode is in a range of about 25 wt. % to about 50 wt. %.

Additional Clause 15. The Li-ion battery of any of Additional Additional Clauses 1 to 14, wherein: the anode comprises Si—C nanocomposite particles.

Additional Clause 16. The Li-ion battery of Additional Additional Clause 15, wherein: the Si—C nanocomposite particles contribute from about 20% to about 100% of a total capacity of the anode.

Additional Clause 17. The Li-ion battery of any of Additional Additional Clauses 1 to 16, wherein: the anode is substantially free of oxidized silicon.

Additional Clause 18. The Li-ion battery of any of Additional Additional Clauses 1 to 17, wherein: an areal capacity loading of the cathode ranges from about 2 mAh/cm² to about 12 mAh/cm².

Additional Clause 19. The Li-ion battery of any of Additional Additional Clauses 1 to 18, wherein: the anode comprises one or more of the following: natural graphite, synthetic graphite, soft carbon, and hard carbon.

Additional Clause 20. The Li-ion battery of any of Additional Additional Clauses 1 to 19, wherein: the first-cycle coulombic efficiency of the anode is at least about 80%.

Additional Clause 21. The Li-ion battery of Additional Additional Clause 20, wherein: the first-cycle coulombic efficiency of the anode is at least about 85%.

Additional Clause 22. The Li-ion battery of any of Additional Additional Clauses 1 to 21, wherein: the electrolyte comprises a salt composition and an electrolyte solvent composition, the salt composition comprising a primary salt and the electrolyte solvent composition comprising fluoroethylene carbonate (FEC) and vinylene carbonate (VC), the primary salt being at least about 50 mol. % of the salt composition; and the primary salt is selected from: LiPF₆, lithium tetrafluoroborate (LiBF₄), lithium bis(fluorosulfonyl)imide (LiFSI), lithium bis(trifluoromethanesulfonyl)imide (LiTFSI), and lithium fluorosulfate (LiSO₃F).

Additional Clause 23. The Li-ion battery of Additional Additional Clause 22, wherein: the salt composition additionally comprises a secondary salt, the secondary salt being selected from: lithium bis(fluorosulfonyl)imide (LiFSI), lithium tetrafluoroborate (LiBF₄), lithium difluoro(oxalato)borate (LiDFOB), lithium bis(oxalato)borate (LiBOB), lithium difluorophosphate (LFO), lithium fluorosulfate (LiSO₃F), and lithium bis(trifluoromethanesulfonyl)imide (LiTFSI).

Additional Clause 24. The Li-ion battery of any of Additional Additional Clauses 22 to 23, wherein: the electrolyte solvent composition additionally comprises (1) at least one ester compound and/or (2) at least one linear carbonate compound; the at least one ester compound is selected from propyl propionate (PP), methyl butyrate (MB), ethyl propionate (EP), ethyl isobutyrate (EI), ethyl isovalerate (EIV), methyl acetate (MA), ethyl trimethylacetate (ET), ethyl acetate (EA), and ethyl butyrate (EB); and the at least one linear carbonate compound is selected from dimethyl carbonate (DMC), ethyl methyl carbonate (EMC), and diethyl carbonate (DEC).

Additional Clause 25. The Li-ion battery of Additional Additional Clause 24, wherein: the electrolyte solvent composition additionally comprises at least one cyclic carbonate compound; and the at least one cyclic carbonate compound is selected from ethylene carbonate (EC) and propylene carbonate (PC).

Additional Clause 26. The Li-ion battery of any of Additional Additional Clauses 22 to 25, wherein: the electrolyte additionally comprises one or more additives selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, 1-(propan-2-yl)-1H-imidazole-4,5-dicarbonitrile, pyridine-2,6-dicarbonitrile, ethylene glycol bis(propionitrile) ether (EGBE), 3-(triethoxysilyl) propionitrile, succinonitrile (SN), benzonitrile, 4-(trifluoromethyl) benzonitrile, 1,2,2,3-propanetetracarbonitrile, triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, 1,3,2-Dioxathiolane 2,2-dioxide (DTD), and methylene methanedisulfonate (MMDS).

1. A Li-ion battery, comprising:
an anode current collector;
a cathode current collector;
an anode disposed on and/or in the anode current collector, the anode comprising silicon and carbon;
a cathode disposed on and/or in the cathode current collector, the cathode comprising (1) a primary cathode active material and (2) a supplemental cathode active material; and
an electrolyte ionically coupling the anode and the cathode,
wherein:
a mass fraction of the silicon in the anode is in a range of about 10 wt. % to about 60 wt. %;
a mass ratio of the primary cathode active material to the supplemental cathode active material is in a range of about 15:1 to about 50:1;
a first-cycle coulombic efficiency of the primary cathode active material is at least about 85%;
a first-charge specific capacity of the supplemental cathode active material is at least about 350 mAh/g; and
a first-cycle coulombic efficiency of the anode is less than the first-cycle coulombic efficiency of the primary cathode active material.

2. The Li-ion battery of claim 1, wherein:
the first-charge specific capacity of the supplemental cathode active material is at least about 450 mAh/g.

3. The Li-ion battery of claim 2, wherein:
the first-charge specific capacity of the supplemental cathode active material is at least about 750 mAh/g.

4. The Li-ion battery of claim 1, wherein:
the supplemental cathode active material comprises Li and one or more of the following: Fe, Ni, and V.

5. The Li-ion battery of claim 4, wherein:
the supplemental cathode active material comprises a lithium nickel oxide represented by Li₂Ni₁₋ₓMₓO_{2-y}F_{y};
x is between 0 and 0.5;
y is between 0 and 0.5; and
M represents an element or a mixture of two or more elements, the element or at least one of the two or more elements being selected from the following: copper (Cu), iron (Fe), magnesium (Mg), manganese (Mn), zinc (Zn), and cobalt (Co).

6. The Li-ion battery of claim 1, wherein:
the supplemental cathode active material comprises one or more of the following elements: oxygen (O), nitrogen (N), sulfur (S), and carbon (C).

7. The Li-ion battery of claim 1, further comprising:
a supplemental cathode active material particle comprising the supplemental cathode active material,
wherein the supplemental cathode active material particle comprises a protective surface coating with an average thickness from about 0.2 nm to about 50 nm.

8. The Li-ion battery of claim 7, wherein the protective surface coating comprises one or more of the following compositions: (i) metal oxide, (ii) semimetal oxide, (iii) oxynitride, (iv) carbon, and (v) polymer.

9. The Li-ion battery of claim 1, wherein:
the primary cathode active material is selected from: lithium cobalt oxide (LCO), lithium iron phosphate (LFP), lithium manganese iron phosphate (LMFP), lithium manganese oxide (LMO), lithium nickel manganese oxide (LMNO), lithium nickel cobalt manganese aluminum oxide (NCMA), lithium nickel cobalt manganese oxide (NCM), and lithium nickel aluminum oxide (NCA).

10. The Li-ion battery of claim 9, wherein:
the primary cathode active material comprises the LMNO in a spinel form.

11. The Li-ion battery of claim 1, wherein:
a first-cycle coulombic efficiency of the supplemental cathode active material is at most about 30%.

12. The Li-ion battery of claim 1, wherein:
the first-cycle coulombic efficiency of the primary cathode active material is at least about 90%.

13. The Li-ion battery of claim 12, wherein:
the first-cycle coulombic efficiency of the primary cathode active material is at least about 95%.

14. The Li-ion battery of claim 1, wherein:
the mass fraction of the silicon in the anode is in a range of about 25 wt. % to about 50 wt. %.

15. The Li-ion battery of claim 1, wherein:
the anode comprises Si—C nanocomposite particles.

16. The Li-ion battery of claim 15, wherein:
the Si—C nanocomposite particles contribute from about 20% to about 100% of a total capacity of the anode.

17. The Li-ion battery of claim 1, wherein:
the anode is substantially free of oxidized silicon.

18. The Li-ion battery of claim 1, wherein:
an areal capacity loading of the cathode ranges from about 2 mAh/cm² to about 12 mAh/cm².

19. The Li-ion battery of claim 1, wherein:
the anode comprises one or more of the following: natural graphite, synthetic graphite, soft carbon, and hard carbon.

20. The Li-ion battery of claim 1, wherein:
the first-cycle coulombic efficiency of the anode is at least about 80%.

21. The Li-ion battery of claim 20, wherein:
the first-cycle coulombic efficiency of the anode is at least about 85%.

22. The Li-ion battery of claim 1, wherein:
the electrolyte comprises a salt composition and an electrolyte solvent composition, the salt composition comprising a primary salt and the electrolyte solvent composition comprising fluoroethylene carbonate (FEC) and vinylene carbonate (VC), the primary salt being at least about 50 mol. % of the salt composition; and
the primary salt is selected from: LiPF₆, lithium tetrafluoroborate (LiBF₄), lithium bis(fluorosulfonyl)imide (LiFSI), lithium bis(trifluoromethanesulfonyl)imide (LiTFSI), and lithium fluorosulfate (LiSO₃F).

23. The Li-ion battery of claim 22, wherein:
the salt composition additionally comprises a secondary salt, the secondary salt being selected from: lithium bis(fluorosulfonyl)imide (LiFSI), lithium tetrafluoroborate (LiBF₄), lithium difluoro(oxalato)borate (LiDFOB), lithium bis(oxalato)borate (LiBOB), lithium difluorophosphate (LFO), lithium fluorosulfate (LiSO₃F), and lithium bis(trifluoromethanesulfonyl)imide (LiTFSI).

24. The Li-ion battery of claim 22, wherein:
the electrolyte solvent composition additionally comprises (1) at least one ester compound and/or (2) at least one linear carbonate compound;
the at least one ester compound is selected from propyl propionate (PP), methyl butyrate (MB), ethyl propionate (EP), ethyl isobutyrate (EI), ethyl isovalerate (EIV), methyl acetate (MA), ethyl trimethylacetate (ET), ethyl acetate (EA), and ethyl butyrate (EB); and
the at least one linear carbonate compound is selected from dimethyl carbonate (DMC), ethyl methyl carbonate (EMC), and diethyl carbonate (DEC).

25. The Li-ion battery of claim 24, wherein:
the electrolyte solvent composition additionally comprises at least one cyclic carbonate compound; and
the at least one cyclic carbonate compound is selected from ethylene carbonate (EC) and propylene carbonate (PC).

26. The Li-ion battery of claim 22, wherein:
the electrolyte additionally comprises one or more additives selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, 1-(propan-2-yl)-1H-imidazole-4,5-dicarbonitrile, pyridine-2,6-dicarbonitrile, ethylene glycol bis(propionitrile) ether (EGBE), 3-(triethoxysilyl) propionitrile, succinonitrile (SN), benzonitrile, 4-(trifluoromethyl) benzonitrile, 1,2,2,3-propanetetracarbonitrile, triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, 1,3,2-Dioxathiolane 2,2-dioxide (DTD), and methylene methanedisulfonate (MMDS).
